(19) United States
(12) Patent Application Publication
(10) Pub. No.: US 2025/0346325 A1
(43) Pub. Date: Nov. 13, 2025

(54) SYSTEMS AND METHODS OF ADJUSTABLE SUSPENSIONS FOR OFF-ROAD RECREATIONAL VEHICLES

(71) Applicant: Polaris Industries Inc., Medina, MN (US)

(72) Inventors: Michael A. Hedlund, Roseau, MN (US); Trevor F. Rhodes, Wyoming, MN (US); Jonathon P. Graus, Wyoming, MN (US); Kyle W. Olson, Wyoming, MN (US); Justin T. Anderson, Wyoming, MN (US)

(21) Appl. No.: 19/278,096

(22) Filed: Jul. 23, 2025

Related U.S. Application Data
(63) Continuation of application No. 17/325,062, filed on May 19, 2021, now Pat. No. 12,397,878.
(60) Provisional application No. 63/027,833, filed on May 20, 2020.

(51) Int. Cl. B62M 27/02; B60G 17/015

(52) U.S. Cl. CPC B62M 27/02; B60G 17/015; B60G 2300/322; B60G 2500/10; B60G 2600/02; B62M 2027/025; B62M 2027/026; B62M 2027/028

(57) ABSTRACT

A damping control system is provided for an off-road recreational vehicles having a suspension located between a ground engaging member and a vehicle frame and including at least one adjustable shock absorber having an adjustable damping characteristic based on an input from a sensor.

### RELATED APPLICATION

The present application is related to U.S. Provisional Application No. 63/027,833, filed May 20, 2021, titled SYSTEMS AND METHODS OF ADJUSTABLE SUSPENSIONS FOR OFF-ROAD RECREATIONAL VEHICLES, the entire disclosure of which is expressly incorporated by reference herein.

### BACKGROUND AND SUMMARY OF THE DISCLOSURE

The present disclosure relates to improved suspension for off-road recreational vehicles and, in particular, to systems and methods of damping control for shock absorbers of off-road recreational vehicles.

Currently some off-road vehicles include adjustable shock absorbers. These adjustments include spring preload, high and low speed compression damping and/or rebound damping. In order to make these adjustments, the vehicle is stopped and the operator makes an adjustment at each shock absorber location on the vehicle. A tool is often required for the adjustment. Some off-road vehicles also include adjustable electric shocks along with sensors for active ride control systems. Exemplary systems are disclosed in U.S. Pat. No. 9,010,768 and US Published Patent Application No. 2016/0059660, both assigned to the present assignee and the entire disclosures of each expressly incorporated by reference herein.

In an exemplary embodiment of the present disclosure, a snowmobile for propelled movement relative to the ground is provided. The snowmobile comprising a plurality of ground engaging members including an endless track positioned along a centerline vertical longitudinal plane of the snowmobile have having a lateral width, a left front ski positioned on a left side of the centerline vertical longitudinal plane of the snowmobile, and a right front ski positioned on a right side of the centerline vertical longitudinal plane of the snowmobile; a frame supported by the plurality of ground engaging members; a steering system supported by the frame and operatively coupled to the left front ski and the right front ski to control a direction of travel of the snowmobile; a left ski suspension operatively coupling the left front ski to the frame; a right ski suspension operatively coupling the right front ski to the frame; a track suspension operatively coupling the endless track to the frame, the track suspension including a first adjustable shock absorber, the first adjustable shock absorber having at least one adjustable damping characteristic, the first adjustable shock absorber being laterally positioned within the lateral width of the endless track; a plurality of sensors supported by the ground engaging members; and at least one electronic controller operatively coupled to the first adjustable shock absorber, the at least one electronic controller based on inputs from the plurality of sensors alters at least one damping characteristic of the first adjustable shock absorber.

In an example thereof, the first adjustable shock absorber of the first suspension is positioned within an interior bounded by the endless track.

In another example thereof, the track suspension further comprises a second adjustable shock absorber having at least one adjustable damping characteristic, the second adjustable shock absorber being laterally positioned within the lateral width of the endless track, the first adjustable shock absorber is a front track adjustable shock absorber and the second adjustable shock absorber is a rear track adjustable shock absorber. In a variation thereof, the second adjustable shock absorber of the track suspension is positioned within the interior bounded by the endless track. In another variation thereof, the second adjustable shock absorber of the track suspension is positioned outside of the interior bounded by the endless track. In a further variation thereof, the second adjustable shock absorber of the track suspension is positioned above the endless track. In a refinement thereof, the front track adjustable shock absorber is positioned forward of the rear track adjustable shock absorber.

In a further example thereof, the at least one electronic controller alters the at least one damping characteristic of the first adjustable shock absorber while the snowmobile is moving relative to the ground. In a variation thereof, the at least one electronic controller alters a compression damping characteristic of the first adjustable shock absorber. In another variation thereof, the at least one electronic controller alters a rebound damping characteristic of the first adjustable shock absorber. In a further variation thereof, the at least one electronic controller alters both a compression damping characteristic of the first adjustable shock absorber and a rebound damping characteristic of the first adjustable shock absorber.

In still another example thereof, the snowmobile further comprises a third adjustable shock absorber and a fourth adjustable shock absorber, the third adjustable shock absorber is part of the left ski suspension operatively coupling the left front ski to the frame and the fourth adjustable shock absorber is part of the right ski suspension operatively coupling the right front ski to the frame.

In still a further example, a first damping characteristic of the first adjustable shock absorber is adjusted by the at least one electronic controller based on a longitudinal acceleration of the snowmobile. In a variation thereof, a first damping characteristic of the first adjustable shock absorber and a first damping characteristic of the second adjustable shock absorber are adjusted by the at least one electronic controller based on a longitudinal acceleration of the snowmobile. In another variation thereof, a first damping characteristic of the first adjustable shock absorber, a first damping characteristic of the second adjustable shock absorber, a first damping characteristic of the third adjustable shock absorber, and a first damping characteristic of the fourth adjustable shock absorber are adjusted by the at least one electronic controller based on a longitudinal acceleration of the snowmobile. In a further variation thereof, the longitudinal acceleration of the snowmobile is measured by the plurality of sensors. In still a further variation thereof, the longitudinal acceleration of the snowmobile is estimated by the at least one electronic controller. In yet another variation thereof, the longitudinal acceleration of the snowmobile is predicted by the at least one electronic controller.

In yet another example thereof, a first damping characteristic of the first adjustable shock absorber is adjusted by the at least one electronic controller based on a vehicle pitch motion of the snowmobile. In a variation thereof, a first damping characteristic of the first adjustable shock absorber and a first damping characteristic of the second adjustable shock absorber are adjusted by the at least one electronic controller based on a vehicle pitch motion of the snowmobile. In another variation thereof, a first damping characteristic of the first adjustable shock absorber, a first damping characteristic of the second adjustable shock absorber, a first damping characteristic of the third adjustable shock absorber, and a first damping characteristic of the fourth adjustable shock absorber are adjusted by the at least one electronic controller based on a predicted vehicle pitch motion of the snowmobile. In still another variation thereof, the at least one electronic controller determines the snowmobile is predicted to travel at a generally constant longitudinal acceleration, the at least one electronic controller alters a rebound damping characteristic for the third adjustable shock absorber and alters a rebound damping characteristic for the fourth adjustable shock absorber. In yet another variation thereof, the at least one electronic controller determines the snowmobile is predicted to travel at a generally constant longitudinal acceleration, the at least one electronic controller increases a rebound damping characteristic for the third adjustable shock absorber and increases a rebound damping characteristic for the fourth adjustable shock absorber. In yet still another variation thereof, the at least one electronic controller determines the snowmobile is predicted to travel at a generally constant longitudinal acceleration, the at least one electronic controller alters a compression damping characteristic for the third adjustable shock absorber and alters a compression damping for the fourth adjustable shock absorber. In still yet a further variation thereof, the at least one electronic controller determines the snowmobile is predicted to travel at a generally constant longitudinal acceleration, the at least one electronic controller decreases a compression damping characteristic for the third adjustable shock absorber and decreases a compression damping for the fourth adjustable shock absorber. In still another variation thereof, the at least one electronic controller determines the predicted vehicle pitch motion indicates a rearward pitch of the snowmobile and alters a compression damping characteristic of the first adjustable shock absorber. In yet another variation, the at least one electronic controller determines the predicted vehicle pitch motion indicates a rearward pitch of the snowmobile and increases a compression damping characteristic of the first adjustable shock absorber. In still yet another variation, the at least one electronic controller determines the predicted vehicle pitch motion indicates a rearward pitch of the snowmobile and alters a compression damping characteristic of the second adjustable shock absorber. In a further still variation thereof, the at least one electronic controller determines the predicted vehicle pitch motion indicates a rearward pitch of the snowmobile and increases a compression damping characteristic of the second adjustable shock absorber. In a yet further still variation thereof, the at least one electronic controller determines the predicted vehicle pitch motion indicates a rearward pitch of the snowmobile and alters a rebound damping characteristic of the second adjustable shock absorber. In another still variation thereof, the at least one electronic controller determines the predicted vehicle pitch motion indicates a rearward pitch of the snowmobile and increases a rebound damping characteristic of the second adjustable shock absorber. In a further variation thereof, the at least one electronic controller determines the predicted vehicle pitch motion indicates a rearward pitch of the snowmobile, the at least one electronic controller increases a rebound damping characteristic for the third adjustable shock absorber, increases a rebound damping characteristic for the fourth adjustable shock absorber, alters the compression damping characteristic of the first adjustable shock absorber, and increases the compression damping characteristic of the second adjustable shock absorber. In still another variation, the at least one electronic controller determines the predicted vehicle pitch motion indicates a rearward pitch of the snowmobile based on an indication of a throttle increase. In yet still another variation, the at least one electronic controller determines the predicted vehicle pitch motion indicates a rearward pitch of the snowmobile based on an indication of an engine torque increase. In a further still variation, the at least one electronic controller determines the predicted vehicle pitch motion indicates a rearward pitch of the snowmobile based on an indication of an increased vehicle acceleration. In a further yet still variation thereof, the at least one electronic controller determines the snowmobile is predicted to travel at a generally constant longitudinal deceleration, the at least one electronic controller increases a compression damping characteristic for the third adjustable shock absorber and increases a compression damping characteristic for the fourth adjustable shock absorber.

In yet a further example, thereof, the at least one electronic controller determines the snowmobile is predicted to travel at a generally constant longitudinal deceleration, the at least one electronic controller increases a rebound damping characteristic for the first adjustable shock absorber.

In still another example thereof, the at least one electronic controller determines the snowmobile is predicted to travel at a generally constant longitudinal deceleration, the at least one electronic controller alters a compression damping for the first adjustable shock absorber. In a variation thereof, the at least one electronic controller determines the snowmobile is predicted to travel at a generally constant longitudinal deceleration, the at least one electronic controller increases a rebound damping characteristic of the second adjustable shock absorber.

In another variation thereof, the at least one electronic controller determines the snowmobile is predicted to travel at a generally constant longitudinal deceleration, the at least one electronic controller alters a compression damping of the second adjustable shock absorber. In still a further variation thereof, the at least one electronic controller determines the predicted vehicle pitch motion indicates a forward pitch of the snowmobile and alters a rebound damping characteristic of the first adjustable shock absorber. In yet still a further variation thereof, the at least one electronic controller determines the predicted vehicle pitch motion indicates a forward pitch of the snowmobile and increases a damping characteristic of the first adjustable shock absorber. In a further yet variation thereof, the at least one electronic controller determines the predicted vehicle pitch motion indicates a forward pitch of the snowmobile and alters a rebound damping characteristic of the second adjustable shock absorber. In a still further variation thereof, the at least one electronic controller determines the predicted vehicle pitch motion indicates a forward pitch of the snowmobile and increases a rebound damping characteristic of the second adjustable shock absorber. In a yet still further variation thereof, the at least one electronic controller determines the predicted vehicle pitch motion indicates a forward pitch of the snowmobile and alters a compression damping characteristic of the second adjustable shock absorber. In a further still variation thereof, the at least one electronic controller determines the predicted vehicle pitch motion indicates a forward pitch of the snowmobile, the at least one electronic controller increases a compression damping characteristic for the third adjustable shock absorber, increases a compression damping characteristic for the fourth adjustable shock absorber, alters a rebound damping characteristic of the first adjustable shock absorber, and alters a rebound damping characteristic of the second adjustable shock absorber. In yet a further still variation thereof, the at least one electronic controller determines the predicted vehicle pitch motion indicates a forward pitch of the snowmobile, the at least one electronic controller increases a compression damping characteristic for the third adjustable shock absorber, increases a compression damping characteristic for the fourth adjustable shock absorber, increases a rebound damping characteristic of the first adjustable shock absorber, and increases a rebound damping characteristic of the second adjustable shock absorber. In another variation thereof, the at least one electronic controller determines the predicted vehicle pitch motion indicates a forward pitch of the snowmobile based on an indication of a throttle decrease. In a further variation thereof, the at least one electronic controller determines the predicted vehicle pitch motion indicates a forward pitch of the snowmobile based on an indication of an application of the brake. In yet another variation thereof, the at least one electronic controller determines the predicted vehicle pitch motion indicates a forward pitch of the snowmobile based on an indication of a decreased vehicle acceleration.

In still another example thereof, at least one of a first damping characteristic of the first adjustable shock absorber, a first damping characteristic of the second adjustable shock absorber, a first damping characteristic of the third adjustable shock absorber, and a first damping characteristic of the fourth adjustable shock absorber are adjusted by the at least one electronic controller based on a turning of the snowmobile. In yet a further variation thereof, the at least one of the first damping characteristic of the first adjustable shock, the first damping characteristic of the second adjustable shock, the first damping characteristic of the third adjustable shock, and the first damping characteristic of the fourth adjustable shock are adjusted by the at least one electronic controller based on the turning of the snowmobile corresponding to a corner entry. In still another variation thereof, the at least one of the first damping characteristic of the first adjustable shock, the first damping characteristic of the second adjustable shock, the first damping characteristic of the third adjustable shock, and the first damping characteristic of the fourth adjustable shock are adjusted by the at least one electronic controller based on the turning of the snowmobile corresponding to a time subsequent to a corner entry. In a further still variation, the at least one electronic controller determines the snowmobile is making a left turn, the at least one electronic controller increases a compression damping characteristic for the fourth adjustable shock absorber. In another variation thereof, the at least one electronic controller determines the snowmobile is making the left turn, the at least one electronic controller decreases a compression damping characteristic of the fourth adjustable shock absorber. In a further variation thereof, the at least one electronic controller determines the snowmobile is making the left turn, the at least one electronic controller increases a rebound damping characteristic of the fourth adjustable shock absorber. In still another variation thereof, the at least one electronic controller determines the snowmobile is making the left turn, the at least one electronic controller decreases a compression damping characteristic of the first adjustable shock absorber. In yet still another variation thereof, the at least one electronic controller determines the snowmobile is making the left turn, the at least one electronic controller increases a rebound damping characteristic of the first adjustable shock absorber. In another variation thereof, the at least one electronic controller determines the snowmobile is making a right turn, the at least one electronic controller increases a compression damping characteristic for the third adjustable shock absorber. In a further variation thereof, the at least one electronic controller determines the snowmobile is making the right turn, the at least one electronic controller decreases a compression damping characteristic of the fourth adjustable shock absorber. In another variation thereof, the at least one electronic controller determines the snowmobile is making the right turn, the at least one electronic controller increases a rebound damping characteristic of the fourth adjustable shock absorber. In a yet still further variation thereof, the at least one electronic controller determines the snowmobile is making the right turn, the at least one electronic controller decreases a compression damping characteristic of the first adjustable shock absorber. In a further variation thereof, the at least one electronic controller determines the snowmobile is making the right turn, the at least one electronic controller increases a rebound damping characteristic of the first adjustable shock absorber.

In still a further example thereof, the at least one electronic controller adjusts a first damping characteristic of the first adjustable shock absorber to promote a lifting of the skis of the snowmobile. In a variation thereof, a compression damping characteristic of the first adjustable shock absorber is altered to promote a lifting of the skies of the snowmobile. In another variation thereof, the compression damping characteristic of the first adjustable shock absorber is decreased to promote a lifting of the skies of the snowmobile. In a further variation thereof, the compression damping characteristic of the first adjustable shock absorber is increased to promote a lifting of the skies of the snowmobile. In still another variation thereof, the at least one electronic controller adjusts a first damping characteristic of the first adjustable shock absorber and a first damping characteristic of the second adjustable shock absorber to promote a lifting of the skis of the snowmobile. In a further variation thereof, a compression damping characteristic of the second adjustable shock absorber is altered to promote the lifting of the skies of the snowmobile and to cause a wheelie. In a further still variation thereof, the compression damping characteristic of the second adjustable shock absorber is decreased to promote the lifting of the skies of the snowmobile and to cause the wheelie. In another variation thereof, a rebound damping characteristic of the second adjustable shock absorber is altered to promote the lifting of the skies of the snowmobile and to prevent a wheelie. In yet another variation thereof, the rebound damping characteristic of the second adjustable shock absorber is increased to promote the lifting of the skies of the snowmobile and to prevent the wheelie. In a further variation thereof, the at least one electronic controller adjusts a first damping characteristic of the first adjustable shock absorber, a first damping characteristic of the second adjustable shock absorber, a first damping characteristic of the third adjustable shock absorber, and a first damping characteristic of the fourth adjustable shock absorber to promote a lifting of the skis of the snowmobile. In a yet a further variation, a compression damping characteristic of the second adjustable shock absorber is altered to promote the lifting of the skies of the snowmobile and to cause a wheelie. In a further yet variation, the compression damping characteristic of the second adjustable shock absorber is decreased to promote the lifting of the skies of the snowmobile and to cause the wheelie. In a further still variation, a rebound damping characteristic of the third adjustable shock absorber is altered and a rebound damping characteristic of the fourth adjustable shock absorber is altered to promote the lifting of the skies of the snowmobile and to cause the wheelie. In another variation, the rebound damping characteristic of the third adjustable shock absorber is decreased and the rebound damping characteristic of the fourth adjustable shock absorber is decreased to promote the lifting of the skies of the snowmobile and to cause the wheelie. In yet a further variation, a rebound damping characteristic of the second adjustable shock absorber is altered to promote the lifting of the skies of the snowmobile and to prevent a wheelie. In still a variation, the rebound damping characteristic of the second adjustable shock absorber is increased to promote the lifting of the skies of the snowmobile and to prevent the wheelie. In yet still a further variation, a rebound damping characteristic of the third adjustable shock absorber is altered and a rebound damping characteristic of the fourth adjustable shock absorber is altered to promote the lifting of the skies of the snowmobile and to prevent the wheelie. In further still variation, the rebound damping characteristic of the third adjustable shock absorber is increased and the rebound damping characteristic of the fourth adjustable shock absorber is increased to promote the lifting of the skies of the snowmobile and to prevent the wheelie. In yet another variation, the damping characteristic of the first adjustable shock absorber is adjusted for a first condition and thereafter allowed to further adjust based on the plurality of sensors. In yet a further variation, the damping characteristic of the first adjustable shock absorber and the damping characteristic of the second adjustable shock absorber are adjusted for a first condition and thereafter allowed to further adjust based on the plurality of sensors. In a further still variation, the damping characteristic of the first adjustable shock absorber, the damping characteristic of the second adjustable shock absorber, the damping characteristic of the third adjustable shock absorber, and the damping characteristic of the fourth adjustable shock absorber are adjusted for a first condition and thereafter allowed to further adjust based on the plurality of sensors. In a still further variation, the damping characteristic of the first adjustable shock absorber and the damping characteristic of the second adjustable shock absorber are adjusted for a first condition and thereafter allowed to further adjust based on the plurality of sensors and the damping characteristic of the third adjustable shock absorber and the damping characteristic of the fourth adjustable shock absorber are adjusted for a second condition and thereafter allowed to further adjust based on the plurality of sensors. In a further variation, the first condition is a duration of a timer. In a still further variation, the second condition is a duration of a second timer.

In yet another example, the at least one electronic controller adjusts a first damping characteristic of the first adjustable shock absorber in response to the snowmobile being airborne. In a variation thereof, the adjustment of the first damping characteristic of the first adjustable shock absorber is dependent on a length of time that the snowmobile has been airborne. In another variation thereof, the at least one electronic controller increases a compression damping characteristic of the first adjustable shock absorber in response to the snowmobile being airborne. In still a further variation, the at least one electronic controller continues to hold the increased compression damping characteristic of the first adjustable shock absorber for a first period of time after the snowmobile has landed. In a further still variation, the at least one electronic controller alters a rebound damping characteristic of the first adjustable shock absorber in response to the snowmobile being airborne. In yet another variation, the adjustment of the rebound damping characteristic of the first adjustable shock absorber is dependent on a length of time that the snowmobile has been airborne. In yet a further variation, the at least one electronic controller increases the rebound damping characteristic of the first adjustable shock absorber for a first post landing period of time after the snowmobile has landed. In a further variation, the at least one electronic controller adjusts a first damping characteristic of the first adjustable shock absorber and a first damping characteristic of the second adjustable shock absorber in response to the snowmobile being airborne. In another variation, the adjustment of the first damping characteristic of the first adjustable shock absorber and the first damping characteristic of the second adjustable shock absorber is dependent on a length of time that the snowmobile has been airborne. In a further variation, the at least one electronic controller increases a compression damping characteristic of the first adjustable shock absorber and increases a compression damping characteristic of the second adjustable shock absorber in response to the snowmobile being airborne. In yet a further variation, the at least one electronic controller continues to hold the increased compression damping characteristic of the first adjustable shock absorber and the increased compression damping characteristic of the second adjustable shock absorber for a first period of time after the snowmobile has landed. In yet a further variation, the at least one electronic controller alters a rebound damping characteristic of the first adjustable shock absorber and alters a rebound damping characteristic of the second adjustable shock absorber in response to the snowmobile being airborne. In another variation, the adjustment of the rebound damping characteristic of the first adjustable shock absorber and the adjustment of the rebound damping characteristic of the second adjustable shock absorber is dependent on a length of time that the snowmobile has been airborne. In a further variation, the at least one electronic controller increases the rebound damping characteristic of the first adjustable shock absorber and increases the rebound damping characteristic of the second adjustable shock absorber for a first post landing period of time after the snowmobile has landed. In yet another variation, the at least one electronic controller adjusts a first damping characteristic of the third adjustable shock absorber, a first damping characteristic of the fourth adjustable shock absorber, a first damping characteristic of the first adjustable shock absorber, and a first damping characteristic of the second adjustable shock absorber in response to the snowmobile being airborne. In yet another variation, the adjustment of at least one of the first damping characteristic of the third adjustable shock absorber, the first damping characteristic of the fourth adjustable shock absorber, the first damping characteristic of the first adjustable shock absorber, and the first damping characteristic of the second adjustable shock absorber is dependent on a length of time that the snowmobile has been airborne. In still another variation, the at least one electronic controller increases a compression damping characteristic of the third adjustable shock absorber, increases a compression damping characteristic of the fourth adjustable shock absorber, increases a compression damping characteristic of the first adjustable shock absorber, and increases a compression damping characteristic of the second adjustable shock absorber in response to the snowmobile being airborne. In yet still another embodiment, the at least one electronic controller continues to hold the increased compression damping characteristic of the third adjustable shock absorber, the increased compression damping characteristic of the fourth adjustable shock absorber, the increased compression damping characteristic of the first adjustable shock absorber, and the increased compression damping characteristic of the second adjustable shock absorber for a first period of time after the snowmobile has landed. In a further variation, the at least one electronic controller alters a rebound damping characteristic of the third adjustable shock absorber, alters a rebound damping characteristic of the fourth adjustable shock absorber, alters a rebound damping characteristic of the first adjustable shock absorber, and alters a rebound damping characteristic of the second adjustable shock absorber in response to the snowmobile being airborne. In a further still variation, the adjustment of the rebound damping characteristic of the third adjustable shock absorber and the adjustment of the rebound damping of the fourth adjustable shock absorber is adjusted in a first configuration in response to the snowmobile being airborne for less than a first time duration and in a second configuration in response to the snowmobile being airborne for longer than the first time duration. In a further still variation, the at least one electronic controller increases the rebound damping characteristic of the third adjustable shock absorber and increases the rebound damping characteristic of the fourth adjustable shock for a first post landing period of time after the snowmobile has landed in the second configuration. In yet another variation, the at least one electronic controller one of maintains or alters the rebound damping characteristic of the third adjustable shock absorber and one of maintains or alters the rebound damping characteristic of the fourth adjustable shock absorber for a first post landing period of time after the snowmobile has landed in the first configuration. In another variation, the adjustment of the rebound damping characteristic of the first adjustable shock absorber and the adjustment of the rebound damping characteristic of the second adjustable shock absorber is dependent on a length of time that the snowmobile has been airborne. In yet another variation, the at least one electronic controller increases the rebound damping characteristic of the third adjustable shock absorber, increases the rebound damping characteristic of the fourth adjustable shock absorber, increases the rebound damping characteristic of the first adjustable shock absorber, and increases the rebound damping characteristic of the second adjustable shock absorber for a first post landing period of time after the snowmobile has landed.

In still another example, the snowmobile further comprises a driver actuatable suspension adjust input, wherein the at least one electronic controller adjusts a damping characteristic of the first adjustable shock absorber in response to a first actuation of the driver actuatable suspension input. In a variation thereof, the at least one electronic controller increases the compression damping of the first adjustable shock absorber in response to the first actuation of the driver actuatable suspension input. In another variation thereof, the driver actuatable suspension adjust input is supported by the steering system. In a further variation thereof, the driver actuatable suspension adjust input is positioned on a left hand portion of a handlebar of the steering system. In a further still variation thereof, the driver actuatable suspension adjust input is moveable along a longitudinal axis of the left hand portion of the handlebar of the steering system. In still another variation thereof, a first actuation characteristic of the driver actuatable suspension adjust input results in a first type of damping characteristic of the first adjustable shock absorber and a second actuation characteristic of the driver actuatable suspension adjust input results in a second type of damping characteristic of the first adjustable shock absorber. In a further still variation thereof, the first actuation characteristic is a single depress of a first time duration. In yet a further variation thereof, the second actuation characteristic is a single depress of a second time duration longer than the first time duration. In still another variation thereof, the second actuation characteristic is a plurality of depresses within a first time period.

In a further example thereof, the snowmobile further comprises at least one mode input supported by the snowmobile, the at least one electronic controller selecting at least one damping characteristic of the first adjustable shock absorber based on a mode selected with the at least one mode input. In a variation thereof, an operator may select a first mode from a plurality of available modes with the at least one mode input.

In still a further example thereof, the plurality of sensors include an internal measurement unit. In a variation thereof, the internal measurement unit is located between a spindle of the left ski and a rear end of a fuel tank supported by the plurality of ground engaging members. In another variation thereof, the internal measurement unit is located laterally within the lateral width of the endless track. In still another variation, the internal measurement unit is located laterally within the lateral width of an engine of the snowmobile. In yet another variation, the internal measurement unit is located between an engine and a rear end of a fuel tank both supported by the plurality of ground engaging members. In a further variation, the internal measurement unit is supported by a tunnel covering the endless track. In yet another variation, the internal measurement unit is located vertically in line with a steering post of the steering system. In yet a further variation thereof, the frame includes an over-structure positioned above an engine of the snowmobile and supporting a steering post of the steering system, wherein the internal measurement unit is located within an interior of the over-structure. In still a further variation, the internal measurement unit is mounted to a first portion of the snowmobile and is vibration isolated from the first portion of the snowmobile to reduce engine vibration. In yet still another variation thereof, the internal measurement unit is integrated into the at least one electronic controller. In a further still variation thereof, the internal measurement unit is spaced apart from the at least one electronic controller.

In another exemplary embodiment of the present disclosure, a method of controlling ride characteristics of a snowmobile is provided. The method comprising the steps of monitoring with at least one electronic controller a plurality of sensors supported by the snowmobile while the snowmobile is moving; and adjusting with the at least one electronic controller at least one damping characteristic of an adjustable shock absorber while the vehicle is moving, the adjustable shock absorber being apart of a suspension of an endless track of the snowmobile.

In an example thereof, the method further comprises the step of maintaining the at least one damping characteristic of the adjustable shock absorber when the vehicle is stationary.

In another example thereof, the method further comprises the step of discontinuing adjusting with the at least one electronic controller the at least one damping characteristic of the adjustable shock absorber when the vehicle is stationary.

In still another example thereof, the step of adjusting with the at least one electronic controller the at least one damping characteristic of the adjustable shock absorber which is apart of the suspension of the endless track of the snowmobile while the vehicle is moving, includes the step of adjusting the at least one damping characteristic based on a longitudinal acceleration of the snowmobile. In a variation thereof, the longitudinal acceleration of the snowmobile is measured by at least one sensor. In another variation thereof, the longitudinal acceleration of the snowmobile is estimated by the at least one electronic controller. In still another variation thereof, the longitudinal acceleration of the snowmobile is predicted by the at least one electronic controller.

In still another example thereof, the method further comprising the steps of determining the longitudinal acceleration of the snowmobile indicates an acceleration of the snowmobile; and changing a rebound damping characteristic of the adjustable shock absorber. In yet still another variation, the method further comprises the steps of determining the longitudinal acceleration of the snowmobile indicates an acceleration of the snowmobile; and changing a compression damping characteristic of the adjustable shock absorber.

In another example, the step of adjusting with the at least one electronic controller the at least one damping characteristic of the adjustable shock absorber which is apart of the suspension of the endless track of the snowmobile while the vehicle is moving, includes the step of adjusting the at least one damping characteristic based on a predicted pitch motion of the snowmobile. In a variation thereof, the method further comprising the steps of determining the predicted longitudinal pitch motion of the snowmobile indicates a rearward pitch of the snowmobile; and increasing a compression damping characteristic of the adjustable shock absorber. In another variation thereof, the method further comprising the steps of determining the predicted longitudinal pitch motion of the snowmobile indicates a forward pitch of the snowmobile; and changing a rebound damping characteristic of the adjustable shock absorber. In still another variation thereof, the method further comprising the steps of: determining the predicted pitch motion of the snowmobile indicates a forward pitch of the snowmobile; and changing a compression damping characteristic of the adjustable shock absorber.

In a further example thereof, wherein the step of adjusting with the at least one electronic controller the at least one damping characteristic of the adjustable shock absorber which is apart of the suspension of the endless track of the snowmobile while the vehicle is moving, includes the step of adjusting the at least one damping characteristic based on a turning of the snowmobile. In a variation thereof, the step of adjusting the at least one damping characteristic based on the turning of the snowmobile includes the step of altering a compression damping characteristic of the adjustable shock absorber. In another variation thereof, the step of adjusting the at least one damping characteristic based on the turning of the snowmobile includes the step of decreasing a compression damping characteristic of the adjustable shock absorber. In a further variation thereof, the step of adjusting the at least one damping characteristic based on the turning of the snowmobile includes the step of altering a rebound damping characteristic of the adjustable shock absorber. In yet another variation thereof, the step of adjusting the at least one damping characteristic based on the turning of the snowmobile includes the step of increasing a rebound damping characteristic of the adjustable shock absorber. In yet a further variation thereof, the step of adjusting the at least one damping characteristic based on the turning of the snowmobile includes the steps of decreasing a compression damping characteristic of the adjustable shock absorber and increasing a rebound damping characteristic of the adjustable shock absorber.

In still another example thereof, the step of adjusting with the at least one electronic controller the at least one damping characteristic of the adjustable shock absorber which is apart of the suspension of the endless track of the snowmobile while the vehicle is moving, includes the step of adjusting the at least one damping characteristic based on a braking of the snowmobile. In a variation thereof, the step of adjusting the at least one damping characteristic based on the braking of the snowmobile includes the step of altering a compression damping characteristic of the adjustable shock absorber. In another variation thereof, the step of adjusting the at least one damping characteristic based on the braking of the snowmobile includes the step of decreasing a compression damping characteristic of the adjustable shock absorber. In a further variation thereof, the step of adjusting the at least one damping characteristic based on the braking of the snowmobile includes the step of altering a rebound damping characteristic of the adjustable shock absorber. In still a further variation thereof, the step of adjusting the at least one damping characteristic based on the braking of the snowmobile includes the step of increasing a rebound damping characteristic of the adjustable shock absorber. In yet still a further variation, the step of adjusting the at least one damping characteristic based on the braking of the snowmobile includes the steps of decreasing a compression damping characteristic of the adjustable shock absorber and increasing a rebound damping characteristic of the adjustable shock absorber.

In a still further example, the step of adjusting with the at least one electronic controller the at least one damping characteristic of the adjustable shock absorber which is apart of the suspension of the endless track of the snowmobile while the vehicle is moving, includes the step of adjusting the at least one damping characteristic to promote a lifting of the skis of the snowmobile. In a variation thereof, the step of adjusting the at least one damping characteristic to promote the lifting of the skis of the snowmobile includes the steps of decreasing a compression damping characteristic of the adjustable shock absorber. In another variation thereof, the step of adjusting the at least one damping characteristic to promote the lifting of the skis of the snowmobile includes the steps of increasing a rebound damping characteristic of a second adjustable shock absorber associated with the suspension of the endless track.

In a further example thereof, the step of adjusting with the at least one electronic controller the at least one damping characteristic of the adjustable shock absorber which is apart of the suspension of the endless track of the snowmobile while the vehicle is moving, includes the step of adjusting the at least one damping characteristic based on the snowmobile being airborne. In a variation thereof, the step of adjusting the at least one damping characteristic based on the snowmobile being airborne includes the steps of increasing a compression damping characteristic of the adjustable shock absorber. In another variation thereof, a magnitude of the increase of the compression damping characteristic of the adjustable shock absorber is dependent on a length of time that the snowmobile has been airborne. In a further variation thereof, the method further comprises the step of continuing to hold the increased compression damping characteristic of the adjustable shock absorber for a first period of time after the snowmobile has landed. In still a further variation thereof, the step of adjusting the at least one damping characteristic based on the snowmobile being airborne further includes the step of decreasing a rebound damping characteristic of the adjustable shock absorber. In still another variation thereof, the method further comprising the step of increasing the rebound damping characteristic of the adjustable shock absorber for a second period of time after the snowmobile has landed. In a further still variation, the step of adjusting the at least one damping characteristic based on the snowmobile being airborne includes the step of decreasing a rebound damping characteristic of the adjustable shock absorber. In yet a further still variation, the method further comprising the step of increasing the rebound damping characteristic of the adjustable shock absorber for a second period of time after the snowmobile has landed.

In a still further exemplary embodiment of the present disclosure, a method of controlling a damping characteristic of at least one adjustable shock absorber of a vehicle being operated by a driver is provided. The method comprising receiving with an electronic controller a plurality of inputs from a plurality of sensors supported by the vehicle; predictively determining a longitudinal acceleration of the vehicle; and adjusting the damping characteristic of the at least one adjustable shock absorber of the vehicle based on the predicted longitudinal acceleration of the vehicle.

In an example thereof, the method further comprising the steps of predictively determining a longitudinal pitch motion of the vehicle; and adjusting the damping characteristic of the at least one adjustable shock absorber of the vehicle based on the predicted longitudinal pitch motion of the vehicle.

In another example thereof, the predicted longitudinal acceleration is determined by the steps of: determining a predicted power for a prime mover of the snowmobile; determining an output power of the drivetrain based on the determined predicted power, the drivetrain including a CVT; determining a forward moving force of the snowmobile based on the determined output power of the drivetrain; determining a resultant forward moving force by subtracting at least one of a coast down force and an applied braking force from the determined forward moving force; and dividing the resultant forward moving force by a mass of the snowmobile to determine the predicted vehicle longitudinal acceleration.

In a further still exemplary embodiment of the present disclosure, a method of controlling a damping characteristic of at least one adjustable shock absorber of a vehicle being operated by a driver is provided. The method comprising receiving with an electronic controller a plurality of inputs from a plurality of sensors supported by the vehicle; predictively determining a longitudinal pitch motion of the vehicle; and adjusting the damping characteristic of the at least one adjustable shock absorber of the vehicle based on the predicted longitudinal pitch motion of the vehicle.

In yet still a further exemplary embodiment of the present disclosure, a snowmobile for propelled movement relative to the ground is provided. The snowmobile comprising a plurality of ground engaging members including an endless track positioned along a centerline vertical longitudinal plane of the snowmobile having a lateral width, a left front ski positioned on a left side of the centerline vertical longitudinal plane of the snowmobile, and a right front ski positioned on a right side of the centerline vertical longitudinal plane of the snowmobile; a frame supported by the plurality of ground engaging members; a steering system supported by the frame and operatively coupled to the left front ski and the right front ski to control a direction of travel of the snowmobile; a left ski suspension operatively coupling the left front ski to the frame; a right ski suspension operatively coupling the right front ski to the frame; a track suspension operatively coupling the endless track to the frame, the track suspension including a plurality of shock absorbers, the plurality of shock absorbers including a first adjustable shock absorber, the first adjustable shock absorber having at least one adjustable damping characteristic, the first adjustable shock absorber being laterally positioned within the lateral width of the endless track and being the forwardmost of the plurality of shock absorbers of the track suspension; a plurality of sensors supported by the ground engaging members; and at least one electronic controller operatively coupled to the first adjustable shock absorber, the at least one electronic controller based on inputs from the plurality of sensors alters at least one damping characteristic of the first adjustable shock absorber.

In an example thereof, the plurality of shock absorbers of the track suspension includes a second shock absorber positioned within the lateral width of the endless track. In a variation thereof, the second shock absorber is an adjustable shock absorber and the electronic controller is operatively coupled to the second shock absorber.

In another example thereof, the left ski suspension includes a third adjustable shock absorber and the right ski suspension includes a fourth adjustable shock absorber, the electronic controller is operatively coupled to the third adjustable shock absorber and the fourth adjustable shock absorber.

Additional features of the present disclosure will become apparent to those skilled in the art upon consideration of the following detailed description of illustrative embodiments exemplifying the best mode of carrying out the invention as presently perceived.

### BRIEF DESCRIPTION OF THE DRAWINGS

The foregoing aspects and many additional features of the present system and method will become more readily appreciated and become better understood by reference to the following detailed description when taken in conjunction with the accompanying drawings.

FIG. 1 illustrates a left side view of an exemplary snowmobile;

FIG. 1A illustrates a left front perspective view of the exemplary snowmobile of FIG. 1 illustrating a yaw-axis, a pitch-axis, and a roll-axis for the snowmobile;

FIG. 1B illustrates a right front perspective view of another exemplary snowmobile having another exemplary shock setup relative to the endless track of the snowmobile;

FIG. 1C illustrates a left side view of the exemplary snowmobile of FIG. 1B;

FIG. 2 illustrates a right side view of the exemplary snowmobile of FIG. 1;

FIG. 3 illustrates the track suspension of the exemplary snowmobile of FIG. 1;

FIG. 4 illustrates a representative view of components of the exemplary snowmobile of FIG. 1 including a suspension with a plurality of continuous damping control shock absorbers, an operator interface, and a plurality of sensors integrated with a controller of the snowmobile;

FIG. 5 illustrates a partial left rear perspective view of the exemplary snowmobile of FIG. 1;

FIG. 6 illustrates a representative view of components of the exemplary snowmobile of FIG. 1 including a suspension with a plurality of continuous damping control shock absorbers, an operator interface, and a plurality of sensors integrated with a controller of the snowmobile;

FIG. 7 illustrates a right front perspective view of the exemplary snowmobile of FIG. 1 illustrating a tunnel covering an endless track ground engaging member and a pyramidal frame;

FIG. 8A illustrates a representative view of an exemplary shock damping logic of the electronic controller of FIG. 6;

FIG. 8B illustrates a representative view of another exemplary shock damping logic of the electronic controller of FIG. 6;

FIG. 8C illustrates a representative view of yet another exemplary shock damping logic of the electronic controller of FIG. 6;

FIGS. 9A-C illustrate an exemplary processing sequence of the shock damping logic of the electronic controller of FIG. 6 for a continuous damping control shock absorber provided as part of the suspension of a left front ski of the exemplary snowmobile of FIG. 1;

FIGS. 10A-C illustrate an exemplary processing sequence of the shock damping logic of the electronic controller of FIG. 6 for a continuous damping control shock absorber provided as part of the suspension of a right front ski of the exemplary snowmobile of FIG. 1;

FIGS. 11A and 11B illustrate an exemplary processing sequence of the shock damping logic of the electronic controller of FIG. 6 for a continuous damping control shock absorber provided as part of the suspension for the endless track of the exemplary snowmobile of FIG. 1;

FIGS. 12A and 12B illustrate an exemplary processing sequence of the shock damping logic of the electronic controller of FIG. 6 for a continuous damping control shock absorber provided as part of the suspension for the endless track of the exemplary snowmobile of FIG. 1;

FIG. 13 illustrates an exemplary processing sequence of the shock damping logic of the electronic controller of FIG. 6 for detecting a g-out event or a chatter event;

FIG. 14 illustrates an exemplary processing sequence of the shock damping logic of the electronic controller of FIG. 6 for detecting an exemplary brake event;

FIG. 15 illustrates an exemplary processing sequence of the shock damping logic of the electronic controller of FIG. 6 for detecting an exemplary airborne event;

FIGS. 16A-C illustrates an exemplary processing sequence of the shock damping logic of the electronic controller of FIG. 6 for detecting an exemplary anti-squat event;

FIGS. 17A-D illustrates an exemplary processing sequence of the shock damping logic of the electronic controller of FIG. 6 for detecting an exemplary cornering event;

FIG. 18 illustrates an exemplary processing sequence of the shock damping logic of the electronic controller of FIG. 6 for detecting an exemplary driver actuatable suspension adjust input event;

FIGS. 19A and 19B illustrate an exemplary processing sequence of the shock damping logic of the electronic controller of FIG. 6 for detecting an exemplary launch mode event;

FIG. 20 illustrates an exemplary processing sequence of the shock damping logic of the electronic controller of FIG. 6 for detecting an exemplary one ski event;

FIG. 21 illustrates the exemplary snowmobile of FIG. 1 airborne;

FIG. 22 illustrates a pitch of snowmobile 10 in deep snow without an adjustment of the damping characteristics of the adjustable shock absorbers;

FIG. 23 illustrates a pitch of snowmobile 10 in deep snow with an adjustment of the damping characteristics of the adjustable shock absorbers;

FIG. 24 illustrates a representative view of an exemplary shock damping logic of the electronic controller of FIG. 6;

FIG. 25 illustrates an exemplary processing sequence of the shock damping logic of the electronic controller of FIG. 6;

FIG. 26 illustrates a left, front, perspective view of a side-by-side off-road recreational vehicle;

FIG. 27 illustrates a left side view of the side-by-side off-road recreational vehicle of FIG. 26;

FIG. 28 illustrates a right side view of the side-by-side off-road recreational vehicle of FIG. 26.

FIGS. 29A-C illustrate exemplary arrangements for inputs of exemplary operator interfaces; and

FIG. 30 illustrates an exemplary input screen for adjusting a gain for various damping profiles.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure.

### DETAILED DESCRIPTION OF THE DRAWINGS

For the purposes of promoting an understanding of the principles of the present disclosure, reference will now be made to the embodiments illustrated in the drawings, which are described below. The embodiments disclosed below are not intended to be exhaustive or limited to the precise form disclosed in the following detailed description. Rather, the embodiments are chosen and described so that others skilled in the art may utilize their teachings.

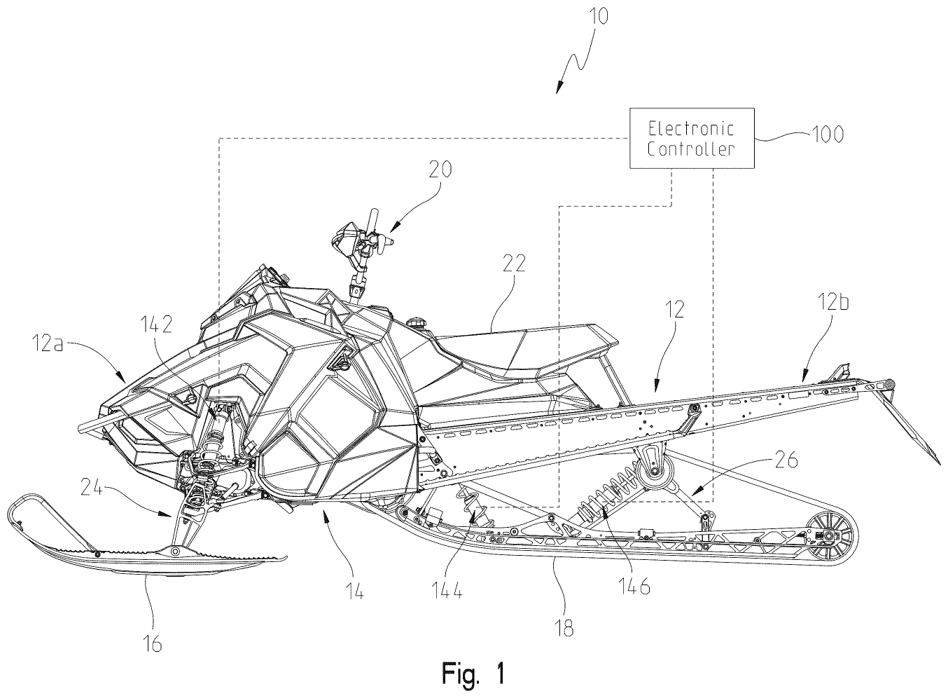

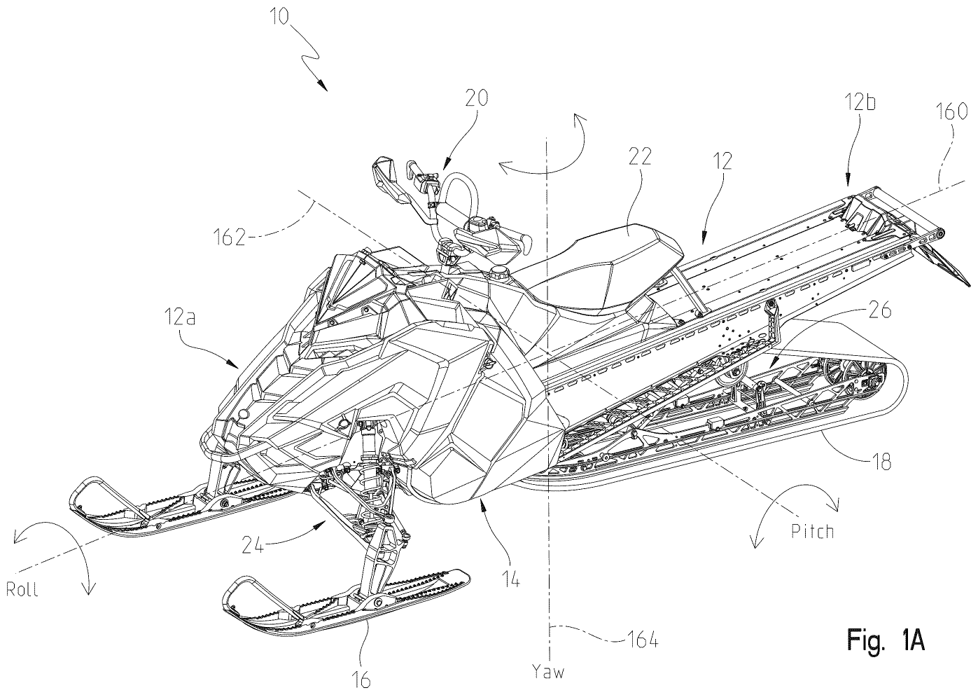

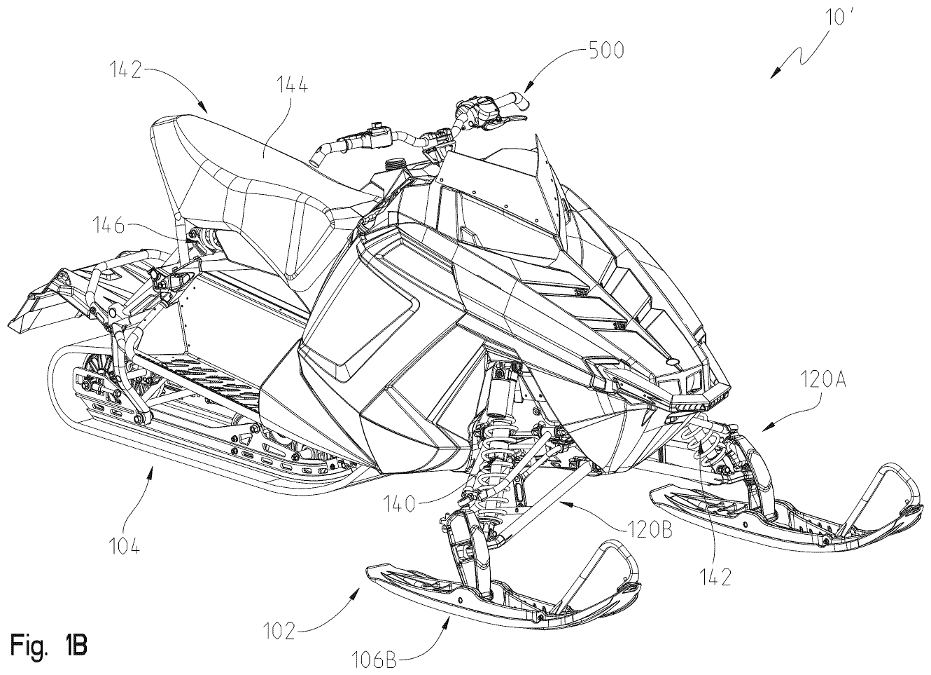

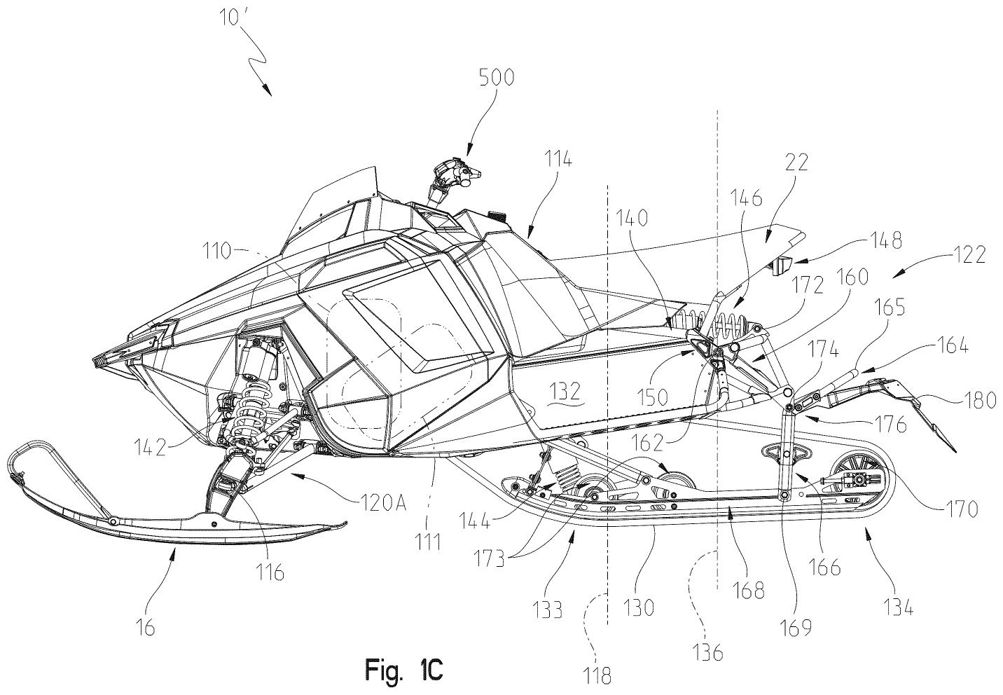

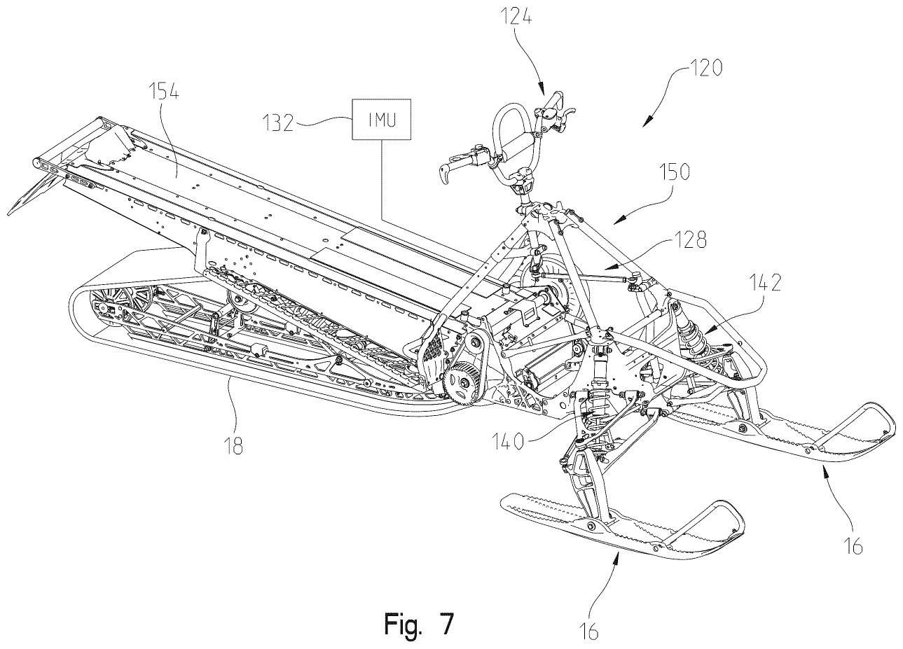

Referring now to FIGS. 1, 1A, 2-4, and 7, an illustrative embodiment of a snowmobile 10 is shown. Snowmobile 10 includes a chassis or frame 12 having a front frame portion 12a and a rear frame portion 12b. A body assembly 14 generally surrounds at least front frame portion 12a of frame 12. Front frame portion 12a is supported by front ground-engaging members, illustratively skis 16, and rear frame portion 12b is supported by a rear ground-engaging member, illustratively an endless track 18. The rider uses a steering assembly 20, which is operably coupled to at least skis 16 through a steering linkage 17 (see FIG. 7), when operating snowmobile 10. A seat assembly 22 is provided generally rearward of steering assembly 20 and is configured to support the rider.

Front skis 16 are operably coupled to a front left suspension assembly 24 and a right front suspension assembly 24, and endless track 18 cooperates with a rear suspension assembly 26. A powertrain assembly is positioned generally intermediate front suspension assembly 24 and rear suspension assembly 26, and provides power to endless track 18 to move snowmobile 10. More particularly, the powertrain assembly 30 includes an engine (see prime mover 110, see FIG. 1C), a transmission, and a drive shaft. In one embodiment, the transmission includes a shiftable transmission and a continuously variable transmission (“CVT”) 111 (see FIG. 1C). In embodiments, the shiftable transmission includes a forward low gear, a forward high gear, a reverse gear, a neutral setting, and a park setting.

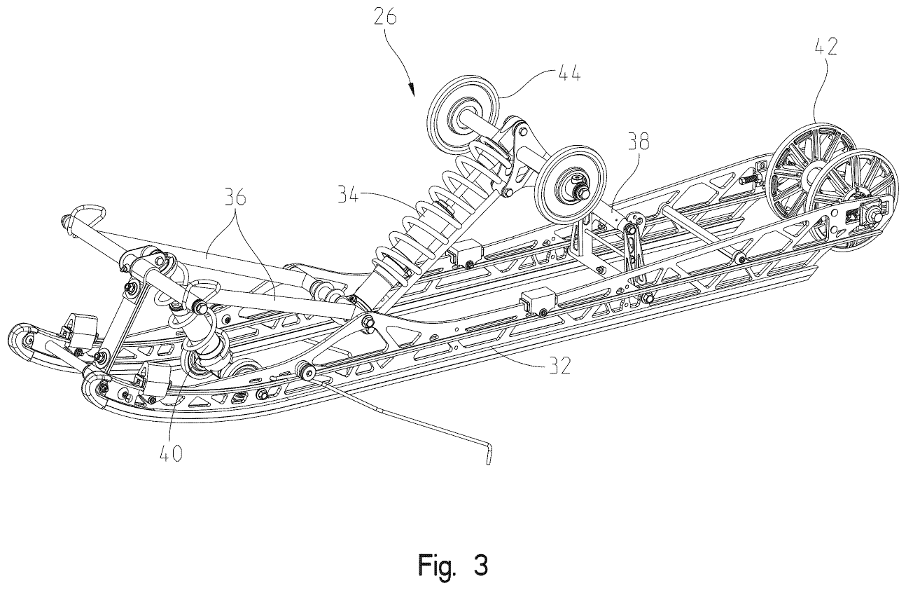

As shown in FIG. 3, rear suspension assembly 26 includes a plurality of slide rails 32, a front track adjustable shock absorber 144 positioned inside of an interior of endless track 18, a rear track adjustable shock absorber 146 positioned inside of the interior of endless track 18, a plurality of torque arms 36 operably coupled to a forward, lower end of rear track adjustable shock absorber 146, and a link assembly 38 operably coupled to a rear, upper end of rear track adjustable shock absorber 146. In one embodiment, torque arms 36 may be comprised of forged aluminum, which may reduce the overall weight of snowmobile 10. Additionally, rear suspension assembly 26 may include front track adjustable shock absorber 144 positioned forward of rear track adjustable shock absorber 146 and operably coupled to torque arms 36 and slide rails 32.

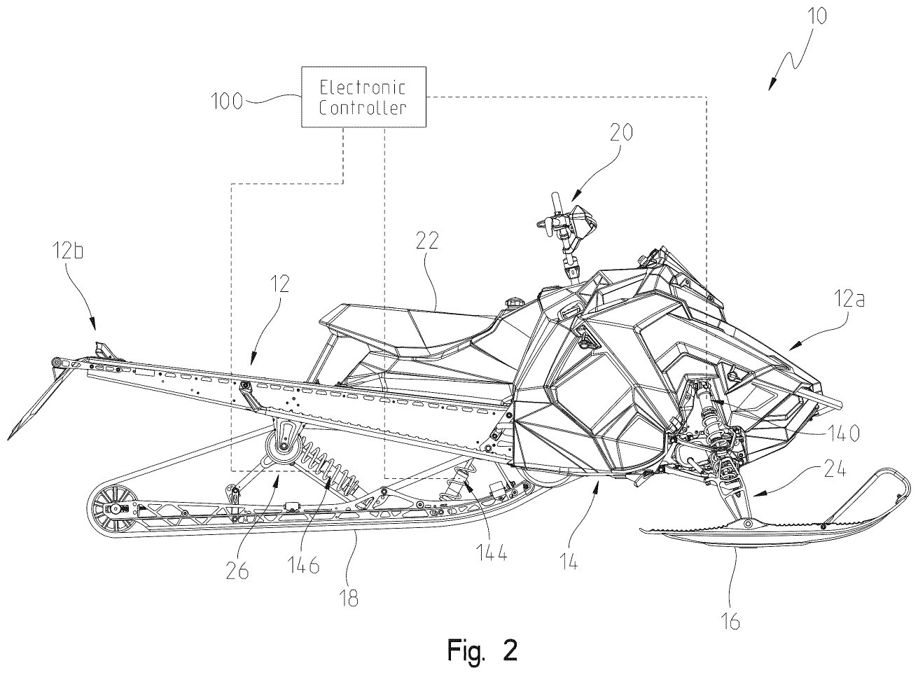

Rear suspension assembly 26 also includes a plurality of rear idler wheels 42 rotatably coupled to the rear end of slide rails 32 and a plurality of carrier wheels 44 laterally adjacent the rear, upper end of rear track adjustable shock absorber 146. Rear idler wheels 42 and carrier wheels 44 are configured to maintain tension in endless track 18. Additionally, the position of rear idler wheels 42 on slide rails 32 may be adjusted to adjust the tension in endless track 18. As shown in FIGS. 1 and 2, endless track 18 generally surrounds rear suspension assembly 26 and is supported on at least slide rails 32, rear idler wheels 42, and carrier wheels 44. Rear suspension assembly 26 is configured to cooperate with endless track 18 when snowmobile 10 is operating. In particular, rear suspension assembly 26 is configured to move longitudinally and vertically during operation of snowmobile 10, and the tension in endless track 18 is maintained throughout the movement of rear suspension assembly 26 by at least rear idler wheels 42.

Referring to FIGS. 1B and 1C, a snowmobile 10′ is shown having a different rear suspension 24′ than snowmobile 10. Rear suspension 24′ positions front track adjustable shock absorber 144 inside the interior of the endless track 18 and rear track adjustable shock absorber 146 outside of the interior of endless track 18 and, in particular, above endless track 18. As shown in FIG. 1A, endless track 18 has a lateral width W. For each of snowmobile 10 and snowmobile 10′, front track adjustable shock absorber 144 and rear track adjustable shock absorber 146 are laterally positioned within the later width W of endless track 18. Throughout the disclosure, snowmobile 10 should be interpreted to read snowmobile 10, 10′ in discussing the damping characteristics of right front adjustable shock absorber 140, left front adjustable shock absorber 142, front track adjustable shock absorber 144, and rear track adjustable shock absorber 146.

Right front adjustable shock absorber 140, left front adjustable shock absorber 142, front track adjustable shock absorber 144, and rear track adjustable shock absorber 146 are adjustable shock absorbers, the damping characteristics of which are continuously controlled by an electronic controller 100. In embodiments, endless track 18 includes one adjustable shock absorbers and a standard shock absorber, such as a manually adjustable shock absorber. In embodiments, electronic controller 100 updates the damping characteristics of right front adjustable shock absorber 140, left front adjustable shock absorber 142, front track adjustable shock absorber 144, and rear track adjustable shock absorber 146 during movement of snowmobile 10, 10′. Electronic controller 100 continuously controls right front adjustable shock absorber 140, left front adjustable shock absorber 142, front track adjustable shock absorber 144, and rear track adjustable shock absorber 146 by updating the desired damping characteristics of right front adjustable shock absorber 140, left front adjustable shock absorber 142, front track adjustable shock absorber 144, and rear track adjustable shock absorber 146 based on monitored sensor values, received operator inputs, and/or other inputs at discrete instances of time. An exemplary time interval is about 1 milli-seconds to about 5 milliseconds. For example, electronic controller 100 updates targets for each of right front adjustable shock absorber 140, f142, front track adjustable shock absorber 144, rear track adjustable shock absorber 146 about every 5 milliseconds and updates the current control loop about every milli-second.

In embodiments, the damping characteristics of front track adjustable shock absorber 144 are controlled by electronic controller 100 while rear track adjustable shock absorber 146 is manually adjustable independent of electronic controller 100. In embodiments, the damping characteristics of rear track adjustable shock absorber 146 are controlled by electronic controller 100 while front track adjustable shock absorber 144 is manually adjustable independent of electronic controller 100. In embodiments, the arrangement and control of one or both of front track adjustable shock absorber 144 and rear track adjustable shock absorber 146 of rear suspension 26 is applicable to single front ski vehicles, such as snowbikes. A snowbike may have one or more shocks associated with the front ski. These one or more shocks may be adjustable shock absorbers controlled by controller 100 is a similar manner as right front adjustable shock absorber 140 and left front adjustable shock absorber 142.

In embodiments, right front adjustable shock absorber 140, left front adjustable shock absorber 142, front track adjustable shock absorber 144, and rear track adjustable shock absorber 146 include solenoid valves mounted at the base of the shock body or internal to a damper piston of the respective right front adjustable shock absorber 140, left front adjustable shock absorber 142, front track adjustable shock absorber 144, and rear track adjustable shock absorber 146. The stiffness of the shock absorber is increased or decreased by introducing additional fluid to the interior of the shock absorber, removing fluid from the interior of the shock absorber, and/or increasing or decreasing the ease with which fluid can pass from a first side of a damping piston of the shock absorber to a second side of the damping piston of the shock absorber. In another embodiments, right front adjustable shock absorber 140, left front adjustable shock absorber 142, front track adjustable shock absorber 144, and rear track adjustable shock absorber 146 include a magnetorheological fluid internal to the respective right front adjustable shock absorber 140, left front adjustable shock absorber 142, front track adjustable shock absorber 144, and rear track adjustable shock absorber 146. The stiffness of the shock is increased or decreased by altering a magnetic field experienced by the magnetorheological fluid. Additional details on exemplary adjustable shocks are provided in US Published Patent Application No. 2016/0059660, filed Nov. 6, 2015, titled VEHICLE HAVING SUSPENSION WITH CONTINUOUS DAMPING CONTROL, assigned to the present assignee, the entire disclosure of which is expressly incorporated by reference herein. In one embodiment, right front adjustable shock absorber 140, left front adjustable shock absorber 142, front track adjustable shock absorber 144, and rear track adjustable shock absorber 146 each include a first controllable proportional valve to adjust compression damping and a second controllable proportional valve to adjust rebound damping. In another embodiment, right front adjustable shock absorber 140, left front adjustable shock absorber 142, front track adjustable shock absorber 144, and rear track adjustable shock absorber 146 each include a combination proportional valve which controls both compression damping and rebound damping.

Additional details of frame 12, body assembly 14, endless track 18, front suspension assembly 24, rear suspension assembly 26, and the powertrain assembly for snowmobile 10, 10′ and other exemplary snowmobiles are disclosed in U.S. Pat. Nos. 7,891,454, 8,590,654, 8,820,458, 8,944,204, 9,428,232, 9,540,072, 9,809,195, and 10,358,187, the complete disclosures of which are expressly incorporated by reference herein

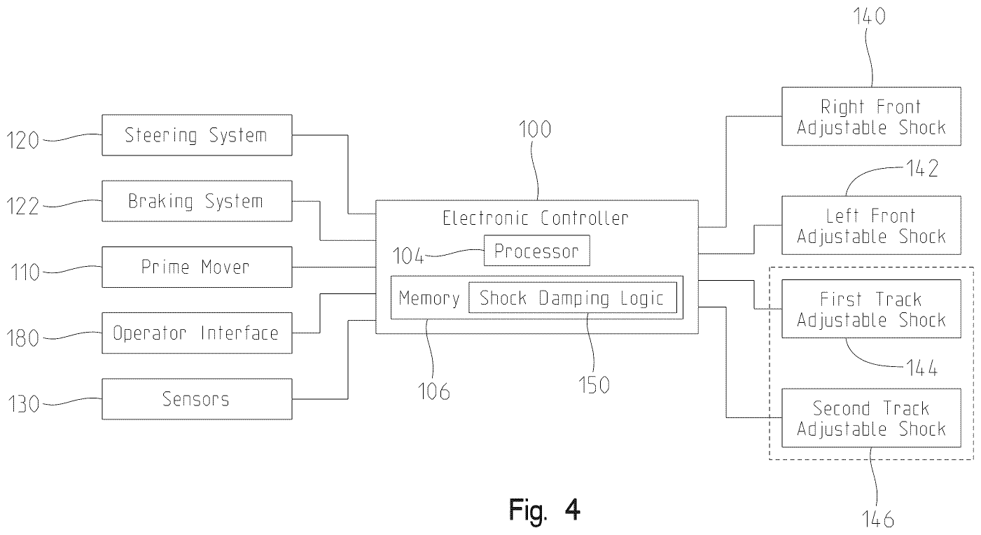

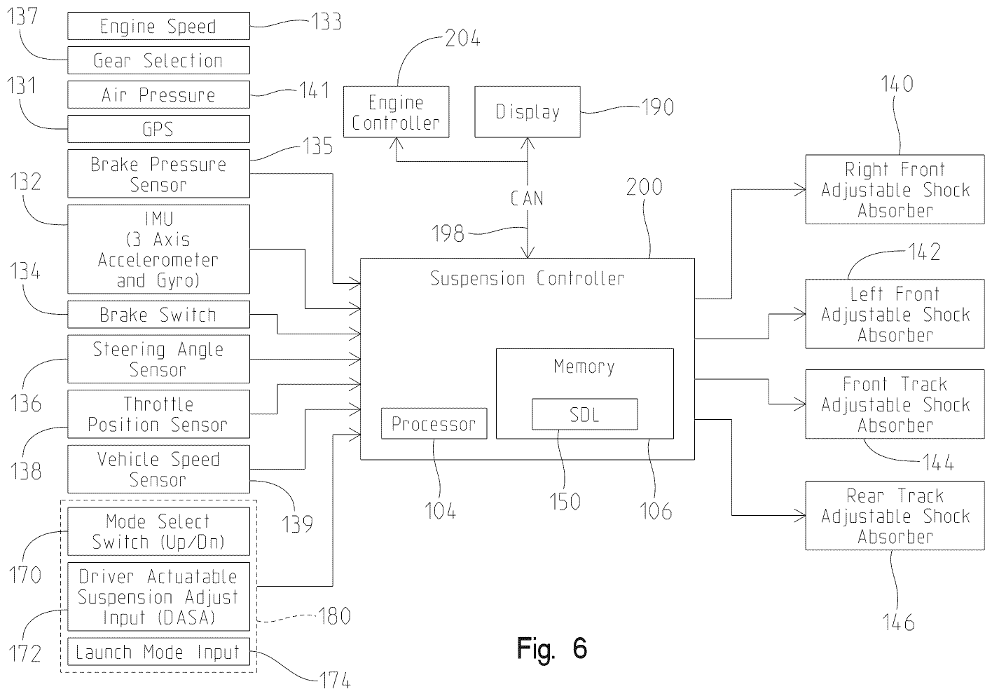

Referring to FIG. 4, electronic controller 100 includes at least one processor 104 and at least one non-transitory computer readable medium, memory 106. In embodiments, electronic controller 100 is a single unit that controls the operation of various systems of snowmobile 10. In embodiments, electronic controller 100 is a distributed system comprised of multiple controllers each of which control one or more systems of snowmobile 10 and may communicate with each other over one or more wired and/or wireless networks. For example, electronic controller 100 may include a suspension controller 200 (see FIG. 6) which controls the damping characteristics of each of right front adjustable shock absorber 140, left front adjustable shock absorber 142, front track adjustable shock absorber 144, and rear track adjustable shock absorber 146 and an engine controller 204 which controls the operator of a prime mover 110 (see FIG. 4) of snowmobile 10.

Electronic controller 100 includes shock damping logic 150 which controls the damping characteristics of right front adjustable shock absorber 140, left front adjustable shock absorber 142, front track adjustable shock absorber 144, and rear track adjustable shock absorber 146. The term “logic” as used herein includes software and/or firmware executing on one or more programmable processors, application-specific integrated circuits, field-programmable gate arrays, digital signal processors, hardwired logic, or combinations thereof. Therefore, in accordance with the embodiments, various logic may be implemented in any appropriate fashion and would remain in accordance with the embodiments herein disclosed. A non-transitory machine-readable medium comprising logic can additionally be considered to be embodied within any tangible form of a computer-readable carrier, such as solid-state memory, magnetic disk, and optical disk containing an appropriate set of computer instructions and data structures that would cause a processor to carry out the techniques described herein. This disclosure contemplates other embodiments in which electronic controller 100 is not microprocessor-based, but rather is configured to control operation of right front adjustable shock absorber 140, left front adjustable shock absorber 142, front track adjustable shock absorber 144, and rear track adjustable shock absorber 146 based on one or more sets of hardwired instructions.

Returning to FIG. 4, electronic controller 100 provides the electronic control of and/or monitors the various components of snowmobile 10, illustratively prime mover 110, a steering system 120, and a braking system 122. Exemplary prime movers include two-cycle combustion engines, four-cycle combustion engines, electric motors, and other suitable motive devices. Prime mover 110 is operatively coupled to endless track 18 through a transmission. Exemplary transmissions include shiftable transmissions, continuously variable transmissions, and combinations thereof. An exemplary steering system 120 is shown in FIG. 7 including handlebars 124 attached to a steering post 126 which in turn is coupled to a steering linkage 128. The steering linkage 128 is coupled to skis 16 to adjust an orientation of skis 16 relative to the ground.

Further, electronic controller 100 is operatively coupled to a plurality of sensors 130 (see FIG. 4) which monitor various parameters of snowmobile 10 or the environment surrounding snowmobile 10. Exemplary sensors 130 include a global positioning sensor (GPS) 131, an inertial measurement unit (“IMU”) 132, an engine speed sensor 133, a brake switch 134, a brake pressure sensor 135, a steering angle sensor 136, a transmission gear selection sensor 137, a throttle position sensor 138, a vehicle speed sensor 139, an air pressure sensor 141.

GPS sensor 131 provides a location of snowmobile 10 on the surface of the earth. IMU 132 includes a three-axis accelerometer and a three-axis gyroscope. Referring to FIG. 1A, the three-axis accelerometer provides acceleration data of snowmobile 10 along axes 160, 162, and 164 and the three-axis gyroscope provides angular information regarding rotation about each of axes 160, 162, and 164. IMU 132 is illustratively supported (see FIG. 7) on the chassis 150 of snowmobile 10 to provide an indication of acceleration forces of the vehicle during operation. In embodiments, IMU 132 is attached to a tunnel 154 of chassis 150 which covers track 18. In embodiments, IMU 132 is attached to an over structure frame 156 of chassis 150. In embodiments, IMU 132 is located within an interior of an over structure frame 156 of chassis 150. In embodiments, IMU 132 is located vertically in line with a steering post 126 (see FIG. 7) of snowmobile 10 within an interior of an over structure frame 156 of chassis 150. In embodiments, IMU 132 is mounted proximate to frame 156, such as on a front side of a fuel tank 114 (see FIG. 1C) or integrated into a wall of the fuel tank. In embodiments, IMU 132 is located longitudinally between a fuel tank and a prime mover 110 of snowmobile 10. In embodiments, IMU 132 is located between a spindle 116 (see FIG. 1C) of the left ski 16 and a rear end 118 of a fuel tank 114 supported by the plurality of ground engaging members. In embodiments, IMU 132 is located along a longitudinal centerline plane snowmobile 10. In embodiments, IMU 132 is located at a center of gravity of snowmobile 10. In embodiments, IMU 132 is offset from the center of gravity of snowmobile 10 and the readings of the three-axis gyroscope are used by electronic controller 100 to determine the acceleration values of snowmobile 10 at the center of gravity of snowmobile 10. In one embodiment, IMU is integrated into electronic controller 100, such as integrated into suspension controller 200. In one embodiment, IMU is spaced apart from electronic controller 100. In embodiments, IMU 132 is isolated from chassis 150 with isolation mounts, such as rubber mounts, to reduce the amount of engine vibration experienced by the IMU 132.

Engine speed sensor 133 monitors a crankshaft speed of the engine. In embodiments, the crankshaft speed is provided to controller 100 by the engine control module (“ECU”).

Brake switch 134 monitors an actuation of an operator brake input, such as a foot actuated input or a hand actuated input. Steering angle sensor 136 monitors a rotation angle of steering post 126 (see FIG. 7). In embodiments, steering system 120 includes an electronic power steering unit. In embodiments, steering system does not include an electronic power steering unit. In the embodiments without an electronic power steering unit, steering angle sensor 136 is supported either in front of the engine below the exhaust ports of the engine or rearward of the engine and above the throttle bodies of the engine.

Throttle position sensor 138 monitors an actuation of a throttle input, such as a foot actuated input or a hand actuated input. Vehicle speed sensor 139 monitors a ground speed of snowmobile 10. In one example, a speed of endless track 18 is monitored by vehicle speed sensor 139 and used as an indication of the speed of snowmobile 10 relative to the ground. In embodiments, snowmobile 10 has a single vehicle speed sensor 139 which monitors a movement of endless track 18.

Brake pressure sensor 135 is a transducer that measures the pressure in applied by the operator in the brake lines of the braking system.

Steering angle sensor 136 monitors a rotational movement of the steering column or monitors other movements of portions of the steering system.

Transmission gear selection sensor 137 monitors an input from the engine control module of the gear selection for a shiftable transmission and/or a rotational direction of the crankshaft for forward and reverse directions.

Vehicle speed sensor 139 measures ground speed by monitoring a rotational speed of the track drive shaft or other measurements of rotational members of the drive line which are indicative of ground speed.

Air pressure sensor 141 monitors one of ambient barometric pressure and/or the manifold air pressure in the engine intake system.

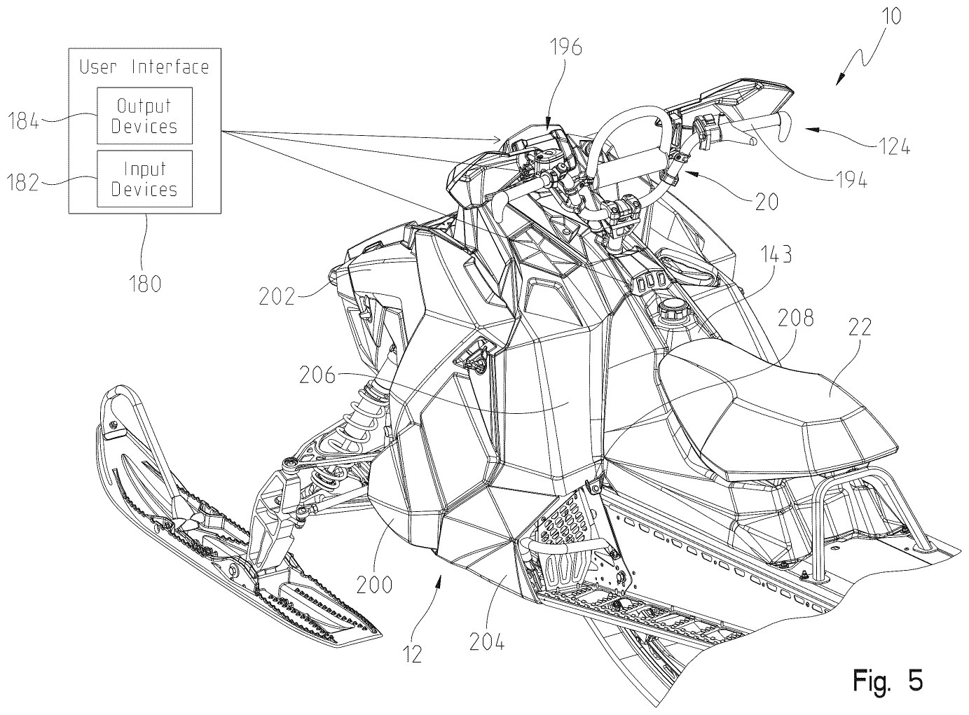

Electronic controller 100 also interacts with an operator interface 180 (see FIGS. 4 and 5) which includes at least one input device 182 and at least one output device 184. Exemplary input devices 182 include levers, buttons, switches, soft keys, and other suitable input devices. Exemplary output devices 184 include lights, displays, audio devices, tactile devices, and other suitable output devices. In embodiments, operator interface 180 includes a display 190, such as a touch screen display, and electronic controller 100 interprets various types of touches to the touch screen display as inputs and controls the content displayed on touch screen display.

Referring to FIG. 5, operator interface 180 may include one or more switches 192, one or more inputs 194 supported by handlebars 124, and one or more parts of an instrument cluster 196 which may include display 190. In embodiments, referring to FIG. 6, operator interface 180 includes a mode select input 170, a driver actuatable suspension adjust input 172, and a launch mode input 174. The mode select input permits an operator to select between at least three setups of snowmobile 10, each having predefined base damping characteristics for right front adjustable shock absorber 140, left front adjustable shock absorber 142, front track adjustable shock absorber 144, and rear track adjustable shock absorber 146.

Exemplary modes selectable with mode select input 170 include a comfort mode, a handling mode, and a rough trail mode. In the comfort mode both compression and rebound damping of each of right front adjustable shock absorber 140, left front adjustable shock absorber 142, front track adjustable shock absorber 144, and rear track adjustable shock absorber 146 are lower than the rough trail mode. In one example, the compression and rebound damping are generally constant for vehicle speed and longitudinal acceleration. In the rough trail mode, the compression damping of each of right front adjustable shock absorber 140, left front adjustable shock absorber 142, front track adjustable shock absorber 144, and rear track adjustable shock absorber 146 are generally higher than the comfort mode and the handling mode based on vehicle speed and longitudinal acceleration. The rebound damping in the rough trail mode will be maintained or lowered the respective shock absorbers will be more prone to extend and therefore have more shock length to absorb compression events. In the handling mode, the compression damping of each of right front adjustable shock absorber 140, left front adjustable shock absorber 142, front track adjustable shock absorber 144, and rear track adjustable shock absorber 146 is lower than the comfort mode and the rough handling mode based on vehicle speed and longitudinal acceleration and the rebound damping is higher than the comfort mode based on vehicle speed and longitudinal acceleration. The dynamic ride height for snowmobile 10 is lowest for the handling mode and highest for the rough trail mode. In embodiments, the selected mode provides base damping characteristics for each of right front adjustable shock absorber 140, left front adjustable shock absorber 142, front track adjustable shock absorber 144, and rear track adjustable shock absorber 146. These base damping characteristics are updated by controller 200 based on the movement or predicted movement of snowmobile 10. Exemplary updates for the damping characteristics are provided herein. In embodiments, for the predicted longitudinal acceleration of the snowmobile 10, controller 200 actively reviews the engine torque and/or throttle position and adjusting the compression and rebound damping to counter predicted motion of snowmobile 10, such as diving or squatting. In an example, snowmobile 10 is traveling 80 MPH and the operator drops the throttle to 0%. In response, controller 200 increases the compression damping in right front adjustable shock absorber 140 and left front adjustable shock absorber 142 to counter a front end dive of snowmobile 10 and increases the rebound damping in front track adjustable shock absorber 144 and rear track adjustable shock absorber 146 to counter the lifting of the rear end.

In embodiments, a longitudinal acceleration of snowmobile 10 is measured based on one or more inputs, such as IMU 132, estimated based on one or more inputs, such as a monitored throttle position and/or a monitored engine rpm, or predicted based on one or more inputs as described herein.

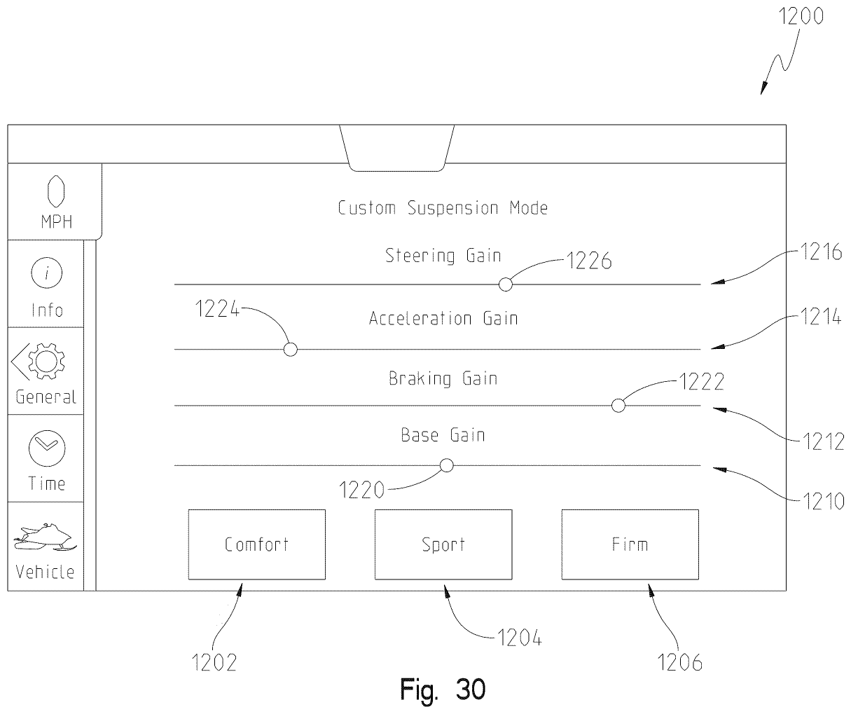

In embodiments, an operator may provide a gain coefficient to one or more damping profiles. Referring to FIG. 30, an exemplary input screen 1200 for display 190 is shown. Input screen 1200 is a custom suspension mode screen. An operator selects which mode to modify, by selecting one of comfort mode input 1202, sport mode input 1204, and firm mode input 1206. Also shown in FIG. 30 are slider inputs, illustratively base gain input 1210, braking gain input 1212, acceleration gain input 1214, and steering or cornering gain input 1216. Each of base gain input 1210, braking gain input 1212, acceleration gain input 1214, and steering post 126 have a respective slider 1220, 1222, 1224, and 1226. When a slider is centered, such as base gain slider 1220 of base gain input 1210, no change is made to the standard base damping profile for the selected mode. Moving a respective slider to the left on input screen 1200 reduces the standard base damping profile for the selected mode while moving a respective slider to the right on steering system 120 increases the standard base damping profile for the selected mode. In embodiments, a first screen is provided for right front adjustable shock absorber 140 and left front adjustable shock absorber 142 and a second screen is provided for front track adjustable shock absorber 144 and rear track adjustable shock absorber 146.

In embodiments, input screen 1200 further includes inputs for selecting one passenger (driver only) or two passengers and for indicating cargo weight. In embodiments, one or more of the damping profiles are adjusted automatically based on an input of the operator, such as the recognition of the operator and their rider profile settings in a rider profile. The rider profile may be stored in the electronic controller of the snowmobile 10, in a personal computing device (such as a mobile phone), a key fob, or retrieval from the cloud or remote computing device.

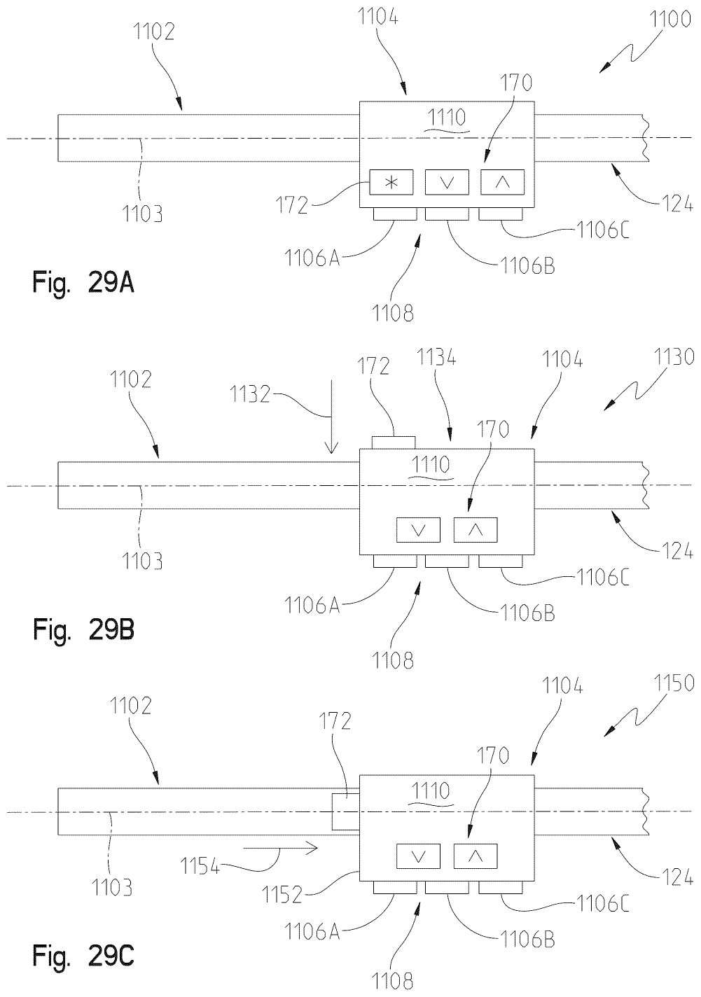

Referring to FIG. 29A, an exemplary embodiment 1100 of operator interface 180 is illustrated. FIG. 29A illustrates a portion of the left handlebar 124 including a hand grip portion 1102 to be grasped by the left hand of the operator and an input housing 1104. Hand grip portion 1102 includes a longitudinal axis 1103. Input housing 1104 includes a plurality of actuatable inputs 1106A-C on a front face 1108 of input housing 1104 facing the seat 22. Exemplary inputs include a light input, heated grips input, and control inputs for display 190. Inputs 1106A-C may be any type of actuatable inputs including buttons, membrane switches, rockers, and other suitable inputs. Additional inputs are provided on a top face 1110 of input housing 1104. In embodiments, mode selection inputs 170 (up and down buttons for cycling through modes) and driver actuatable suspension adjust input 172 are provided on top face 1110 of input housing 1104. Inputs 170 and 172 may be any type of actuatable inputs including buttons, membrane switches, rockers, levers, triggers, and other suitable inputs. In embodiments, input 172 is positioned within a finger's or thumb's touch distance of a hand grip so that it may be actuated without requiring the operator to remove their hand from the grip. In embodiments, one or both of input 170 and input 172 may be positioned on front face 1108 and actuatable therefrom.

Referring to FIG. 29B, an exemplary embodiment 1130 of operator interface 180 is illustrated. FIG. 29B illustrates a portion of the left handlebar 124 including a hand grip portion 1102 to be grasped by the left hand of the operator and an input housing 1104. Hand grip portion 1102 includes a longitudinal axis 1103. Input housing 1104 includes a plurality of actuatable inputs 1106A-C on a front face 1108 of input housing 1104 facing the seat 22. Exemplary inputs include a light input, heated grips input, and control inputs for display 190. Inputs 1106A-C may be any type of actuatable inputs including buttons, membrane switches, rockers, and other suitable inputs. Additional inputs are provided on a top face 1110 of input housing 1104. In embodiments, mode selection inputs 170 (up and down buttons for cycling through modes) is provided on top face 1110 of input housing 1104. Additional inputs are provided on a rear face 1134 of input housing 1104, rear face 1134 being opposite of front face 1108. In embodiments, driver actuatable suspension adjust input 172 is provided on rear face 1134 of input housing 1104. Inputs 170 and 172 may be any type of actuatable inputs including buttons, membrane switches, rockers, levers, triggers, and other suitable inputs. Driver actuatable suspension adjust input 172 is depressed in direction 1132 towards front face 1108 to actuate driver actuatable suspension adjust input 172. In embodiments, input 172 is a lever or trigger which is one of pulled toward the operator in actuation or pushed away from the operator in actuation.

Referring to FIG. 29C, an exemplary embodiment 1150 of operator interface 180 is illustrated. FIG. 29C illustrates a portion of the left handlebar 124 including a hand grip portion 1102 to be grasped by the left hand of the operator and an input housing 1104. Hand grip portion 1102 includes a longitudinal axis 1103. Input housing 1104 includes a plurality of actuatable inputs 1106A-C on a front face 1108 of input housing 1104 facing the seat 22. Exemplary inputs include a light input, heated grips input, and control inputs for display 190. Inputs 1106A-C may be any type of actuatable inputs including buttons, membrane switches, rockers, and other suitable inputs. Additional inputs are provided on a top face 1110 of input housing 1104. In embodiments, mode selection inputs 170 (up and down buttons for cycling through modes) is provided on top face 1110 of input housing 1104. Additional inputs are provided on a hand grip side face 1152 of input housing 1104. In embodiments, driver actuatable suspension adjust input 172 is provided on hand grip side face 1152 of input housing 1104. Inputs 170 and 172 may be any type of actuatable inputs including buttons, membrane switches, rockers, and other suitable inputs. Driver actuatable suspension adjust input 172 is depressed in direction 1154 along 1103 to actuate driver actuatable suspension adjust input 172. In embodiments, the stroke of input 172 in direction 1154 is about 0.25 inches. In embodiments, input 172 includes tactile feedback to the operator of depression. In one example, input 172 and input housing 1104 cooperate to provide a “click” feel at the end of stroke of input 172 in direction 1154. In embodiments an operator interface surface of input 172 is a half-moon shape and can be actuated from hand grip face 1152 or front face 1108.

Although FIGS. 29A-C, illustrate exemplary placements for driver actuatable suspension adjust input 172, other inputs may occupy the respective positions. In embodiments, launch mode input 174 replaces driver actuatable suspension adjust input 172.

In embodiments, input 172 may be provided as one input of a multi-functional input device. For example, the multi-functional input device may provide the functionality of input 172 in response to a first actuation characteristic(s) (such as a sequence) and another functionality, such as mode change, in response to a second actuation characteristic(s) (such as a sequence).

The driver actuatable suspension adjust input 172 permits an operator to request a maximum stiffness for one or more of right front adjustable shock absorber 140, left front adjustable shock absorber 142, front track adjustable shock absorber 144, and rear track adjustable shock absorber 146. Exemplary operation of a driver actuatable suspension adjust input is discussed in U.S. Pat. No. 10,406,884, assigned to the assignee of the present application, the entire disclosure of which is incorporated by reference herein. Electronic controller 100 controls the operation of output devices 184 and monitors the actuation of input devices 182. Referring to FIG. 6, in embodiments, display 190 is operatively coupled to electronic controller 100 (illustratively suspension controller 200) over a network, illustratively a CAN network.

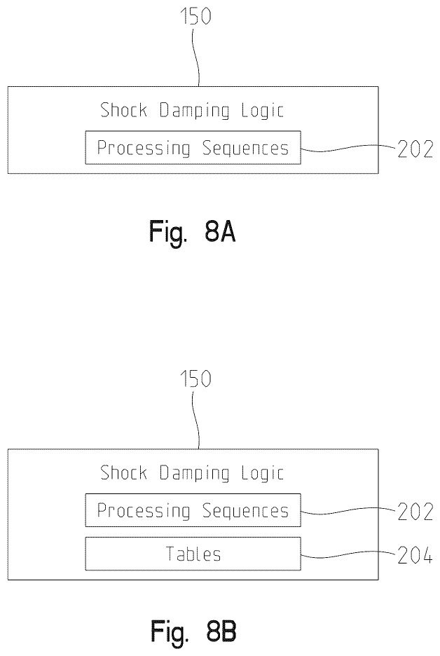

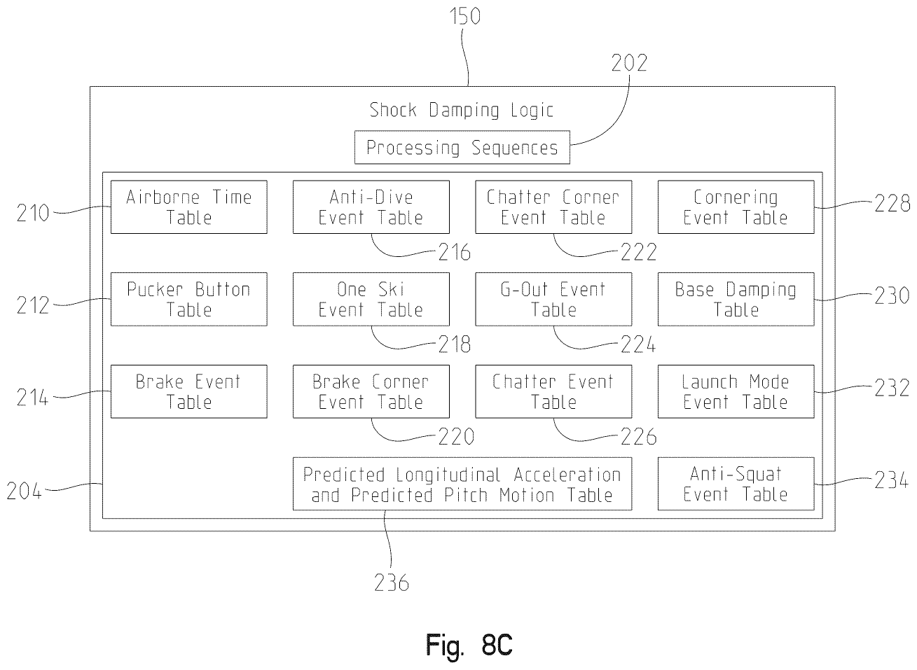

Referring to FIG. 8A, shock damping logic 150 includes one or more processing sequences 202 which control the damping characteristics of one or more of right front adjustable shock absorber 140, left front adjustable shock absorber 142, front track adjustable shock absorber 144, and rear track adjustable shock absorber 146. In embodiments, shock damping logic 150 includes one or more functions which based on one or more inputs output a desired damping characteristic for each of right front adjustable shock absorber 140, left front adjustable shock absorber 142, front track adjustable shock absorber 144, and rear track adjustable shock absorber 146.

Referring to FIG. 8B, shock damping logic 150 includes one or more processing sequences 202 which control the damping characteristics of one or more of right front adjustable shock absorber 140, left front adjustable shock absorber 142, front track adjustable shock absorber 144, and rear track adjustable shock absorber 146 and one or more look-up tables 204 which based on one or more inputs provides damping characteristics for each of right front adjustable shock absorber 140, left front adjustable shock absorber 142, front track adjustable shock absorber 144, and rear track adjustable shock absorber 146.

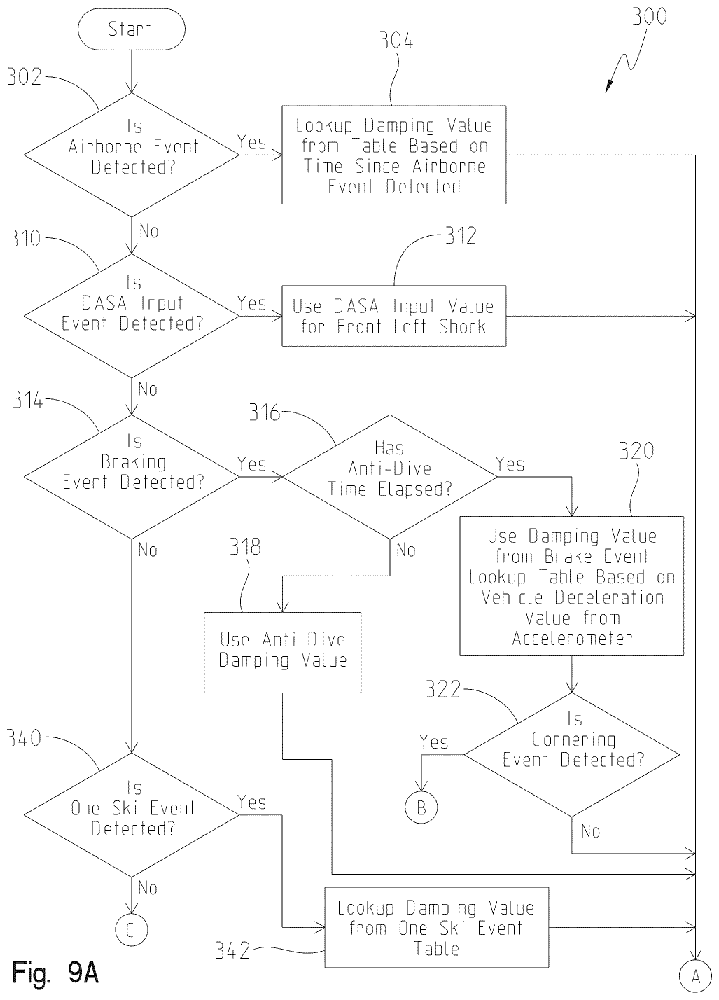

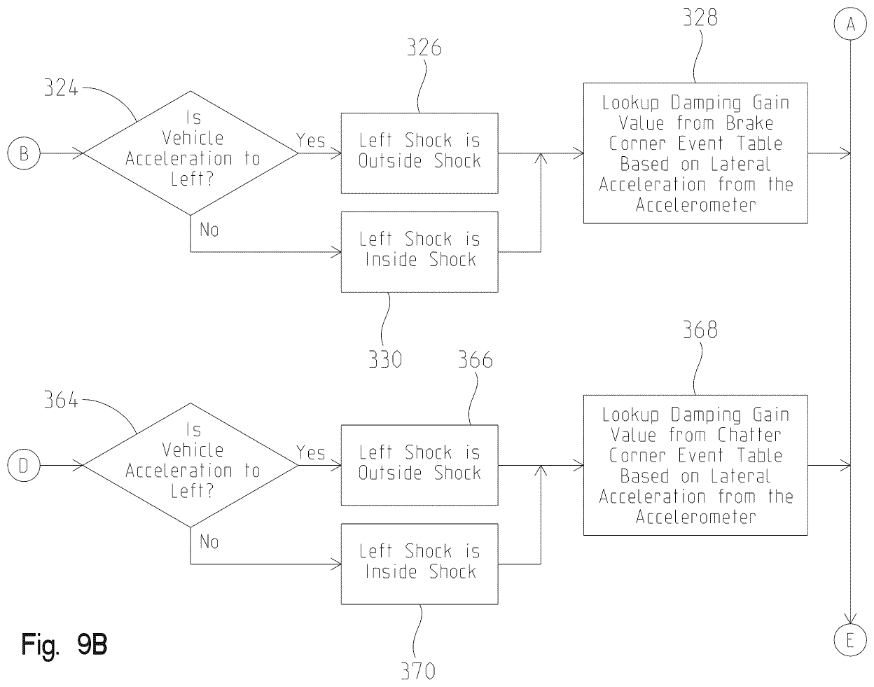

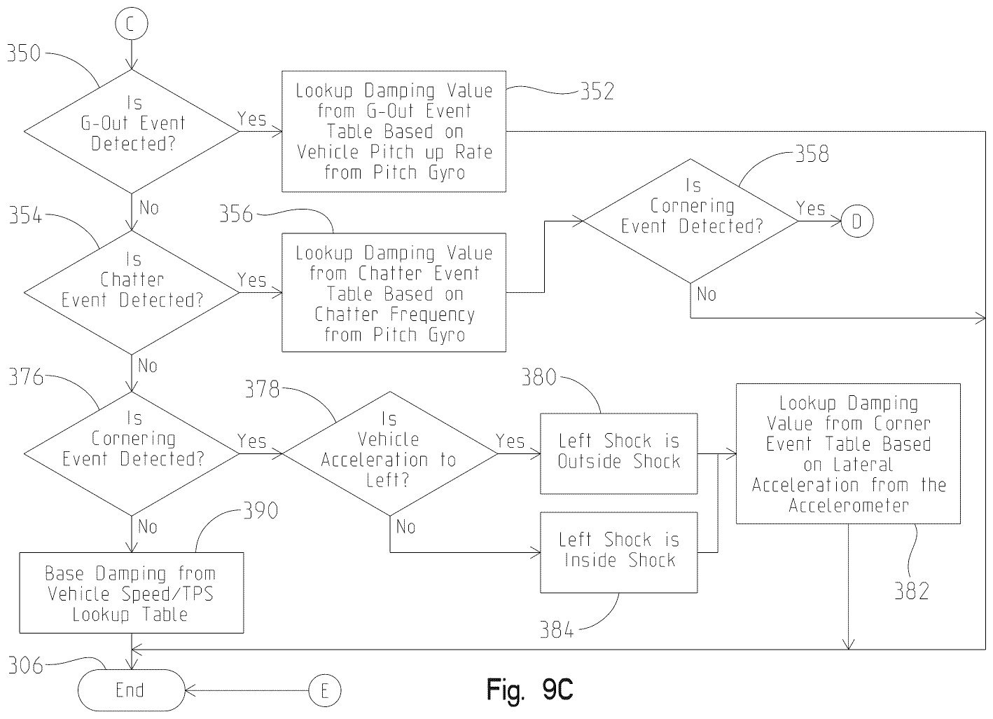

Referring to FIG. 8C, shock damping logic 150 includes one or more processing sequences 202 which control the damping characteristics of one or more of right front adjustable shock absorber 140, left front adjustable shock absorber 142, front track adjustable shock absorber 144, and rear track adjustable shock absorber 146 and one or more look-up tables 204 which based on one or more inputs provides damping characteristics for each of right front adjustable shock absorber 140, left front adjustable shock absorber 142, front track adjustable shock absorber 144, and rear track adjustable shock absorber 146. Exemplary look-up tables include airborne time event table 210, driver actuatable suspension adjust input event table 212, brake event table 214, anti-dive event table 216, one ski event table 218, brake corner event table 220, chatter corner event table 222, g-out event table 224, chatter event table 226, corner event table 228, base damping table 230, launch mode event table 232, anti-squat event table 234, and a predictive longitudinal acceleration and predictive vehicle pitch table 236. The use of look-up tables 204 by processing sequences 202 are illustrated in the exemplary processing sequences of FIGS. 9-20 and 24. In embodiments, electronic controller 200 executes the exemplary processing sequences generally continuously while monitoring for operator inputs and sensor values. In one embodiment, electronic controller 200 updates the damping characteristics for each of right front adjustable shock absorber 140, left front adjustable shock absorber 142, front track adjustable shock absorber 144, and rear track adjustable shock absorber 146 every about 1 to about 5 milliseconds. For example, electronic controller 100 updates targets for each of right front adjustable shock absorber 140, f142, front track adjustable shock absorber 144, rear track adjustable shock absorber 146 about every 5 milliseconds and updates the current control loop about every 1 millisecond.

Electronic controller 200 when executing processing sequences 202 arbitrates which damping characteristics to use for right front adjustable shock absorber 140, left front adjustable shock absorber 142, front track adjustable shock absorber 144, and rear track adjustable shock absorber 146 based on the sensed values from sensors 130 and inputs from operator interface 180. In embodiments, the arbitration of electronic controller 200 for compression damping may be prioritized with airborne detection compression damping having the highest priority, followed by driver actuatable suspension adjust input 172 compression damping having the next highest priority, followed by cornering detection compression damping, followed by braking detection compression damping, followed by the maximum of the base compression damping based on mode selection and acceleration based detection compression damping. In one example, wherein the predictive longitudinal acceleration and predictive vehicle pitch processing sequence is used, the braking detection damping is taken into account with the predictive acceleration and pitch and thus following cornering detection compression damping is the maximum of the base compression damping based on mode selection and the predictive longitudinal acceleration and predictive vehicle pitch based detection compression damping. In embodiments, the arbitration of electronic controller 200 for rebound damping may be prioritized with airborne detection rebound damping having the highest priority including post landing time, followed by cornering detection rebound damping, followed by braking detection rebound damping, followed by the maximum of the base rebound damping based on mode selection and acceleration based detection rebound damping. In one example, wherein the predictive longitudinal acceleration and predictive vehicle pitch processing sequence is used the braking detection rebound damping is taken into account with the predictive acceleration and pitch and thus following cornering detection rebound damping is the maximum of the base rebound damping based on mode selection and the predictive longitudinal acceleration and predictive vehicle pitch based detection rebound damping. The above are exemplary arbitration priorities and different processing sequences may include different arbitration priorities based on the event detection tables provided and the desired performance of the vehicle.

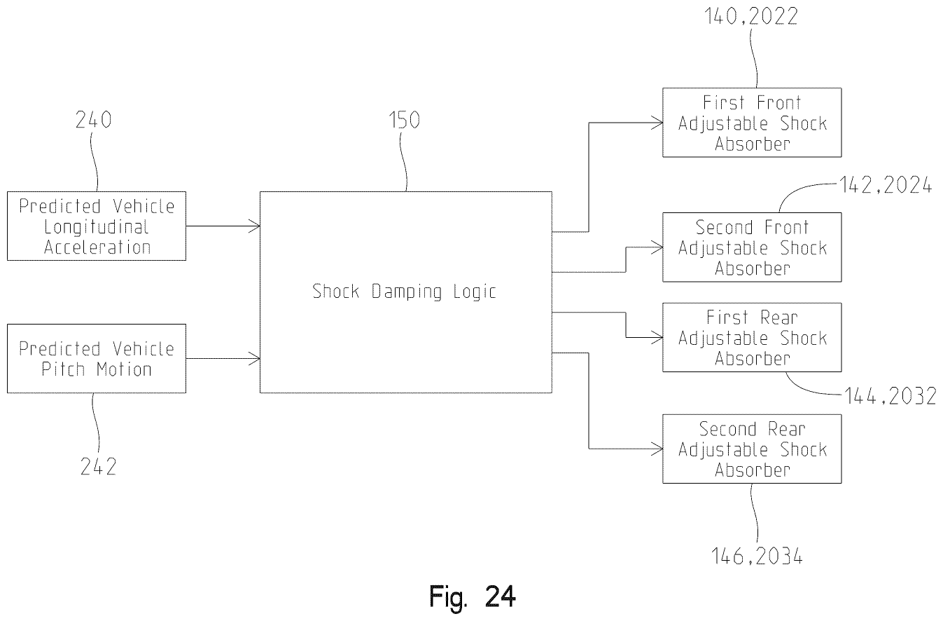

Referring to FIG. 24, predictive longitudinal acceleration and predictive pitch table 236 includes damping characteristics for each of right front adjustable shock absorber 140, left front adjustable shock absorber 142, front track adjustable shock absorber 144, and rear track adjustable shock absorber 146 based on one or both of a predicted longitudinal acceleration of snowmobile 10 and a predicted pitch of snowmobile 10. Shock damping logic 150 based on a predicted vehicle longitudinal acceleration 240 and/or a predicted vehicle pitch 242 alters the damping characteristics of right front adjustable shock absorber 140, left front adjustable shock absorber 142, front track adjustable shock absorber 144, and rear track adjustable shock absorber 146.

When both the predicted longitudinal acceleration 240 and the predicted vehicle pitch 242 are taken into account, shock damping logic 150 is able to adjust right front adjustable shock absorber 140, left front adjustable shock absorber 142, front track adjustable shock absorber 144, and rear track adjustable shock absorber 146 for acceleration of snowmobile 10 including minimizing vehicle squat during acceleration and minimizing vehicle dive during deceleration. In one example, a predicted increase in the longitudinal acceleration results in shock damping logic 150 altering, such as increasing, the compression damping of front track adjustable shock absorber 144 and rear track adjustable shock absorber 146 to reduce the chance of skis 16 being lifted off of the snow and alters, such as increases the rebound damping of right front adjustable shock absorber 140 and left front adjustable shock absorber 142. Further, the rebound damping may be increased on the front track adjustable shock absorber 144. In another example, when the predicted vehicle pitch indicates the rear of snowmobile 10 is predicted to drop and the predicted longitudinal acceleration is increasing, shock damping logic 150 increases the compression damping of right front adjustable shock absorber 140 and left front adjustable shock absorber 142 and decreases the rebound damping of right front adjustable shock absorber 140 and left front adjustable shock absorber 142 to promote a lifting of skis 16 off of the snow. In a further embodiment, when the predicted longitudinal acceleration is decreasing and the predicted vehicle pitch indicates the front of snowmobile 10 is predicted to drop, shock damping logic 150 increases the compression damping of right front adjustable shock absorber 140 and left front adjustable shock absorber 142 to reduce diving of the front of snowmobile 10 and, alter, such as increases or decreases the compression damping of front track adjustable shock absorber 144 to promote track 18 pressure on the snow and to absorb bumps.

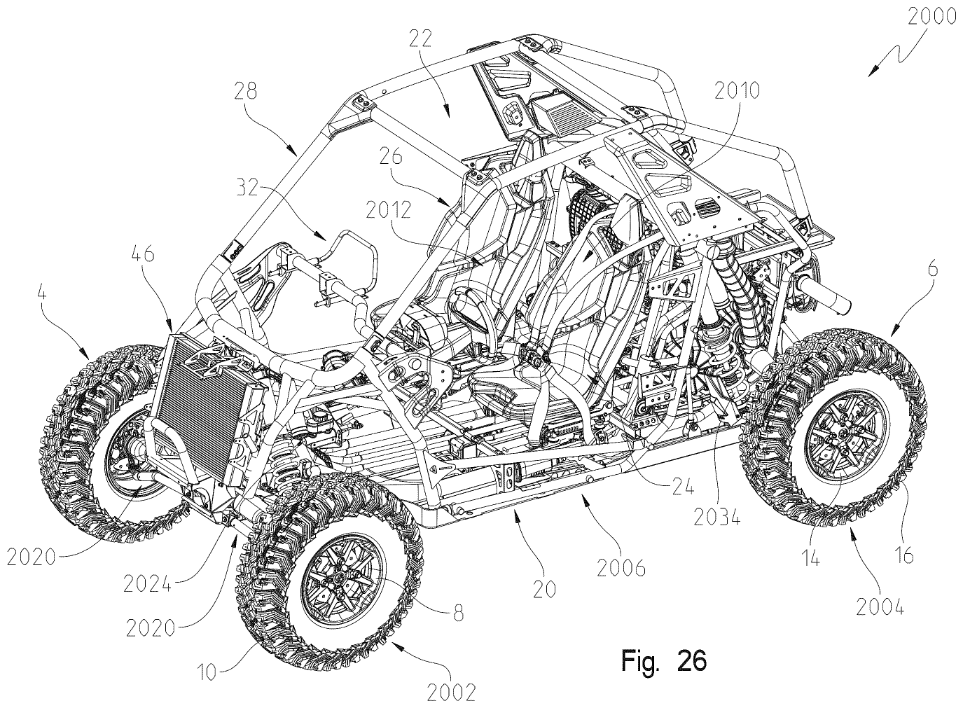

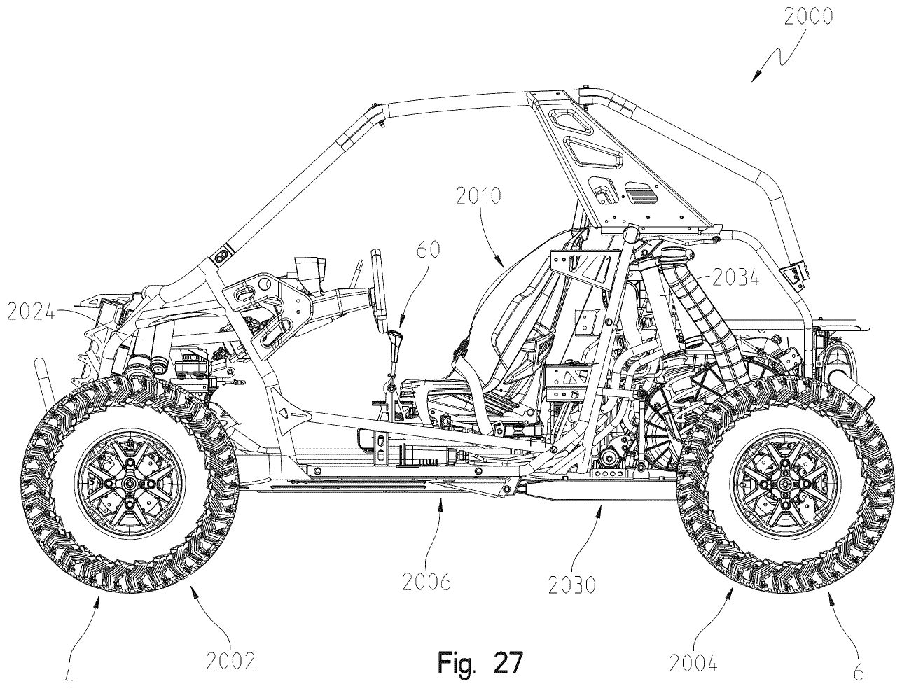

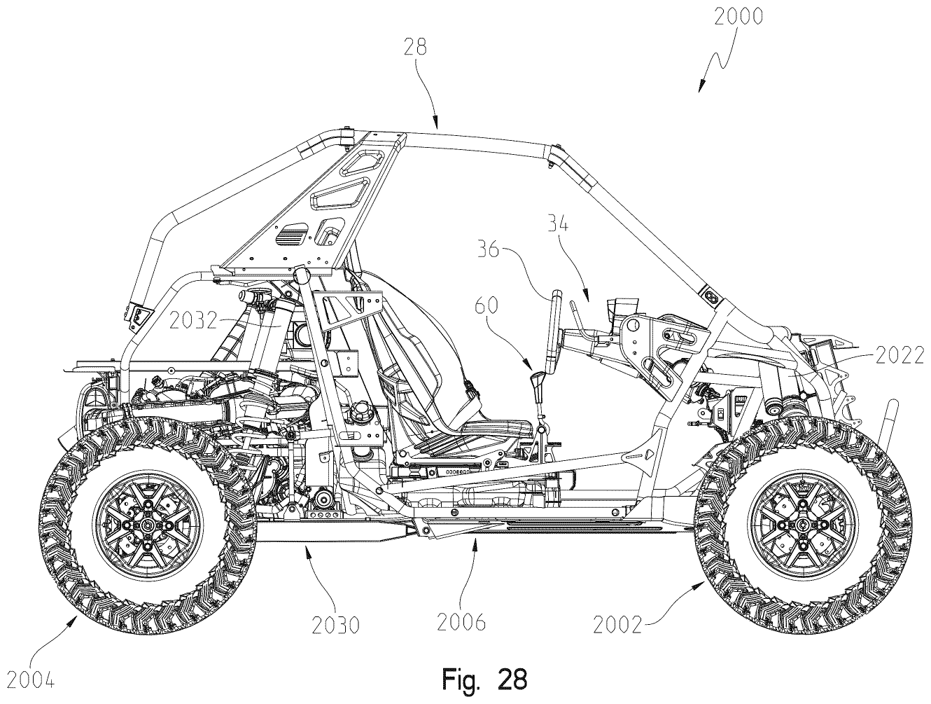

The predicted longitudinal acceleration 240 and the predicted vehicle pitch 242 are also applicable to other off-road recreational vehicles including side-by-side vehicles, such as vehicle 2000 shown in FIGS. 26-28. Vehicle 2000 includes a pair of front wheels 2002 and a pair of rear wheels 2004 supporting a frame 2006. Vehicle 2000 includes a driver seat 2010 and a passenger seat 2012 arranged in a side-by-side arrangement. Each of the front wheels 2002 are coupled to frame 2006 through front suspensions 2020 including shock absorbers 2022, 2024 which may be adjustable shock absorbers as described herein. Each of the rear wheels 2004 are coupled to frame 2006 through rear suspensions 2030 including shock absorbers 2032, 2034 which may be adjustable shock absorbers as described herein. Additional details regarding vehicle 2000 are provided in US Published Patent Application US2019/0210668, filed Jan. 10, 2019, titled VEHICLE, the entire disclosure of which is expressly incorporated by reference herein.

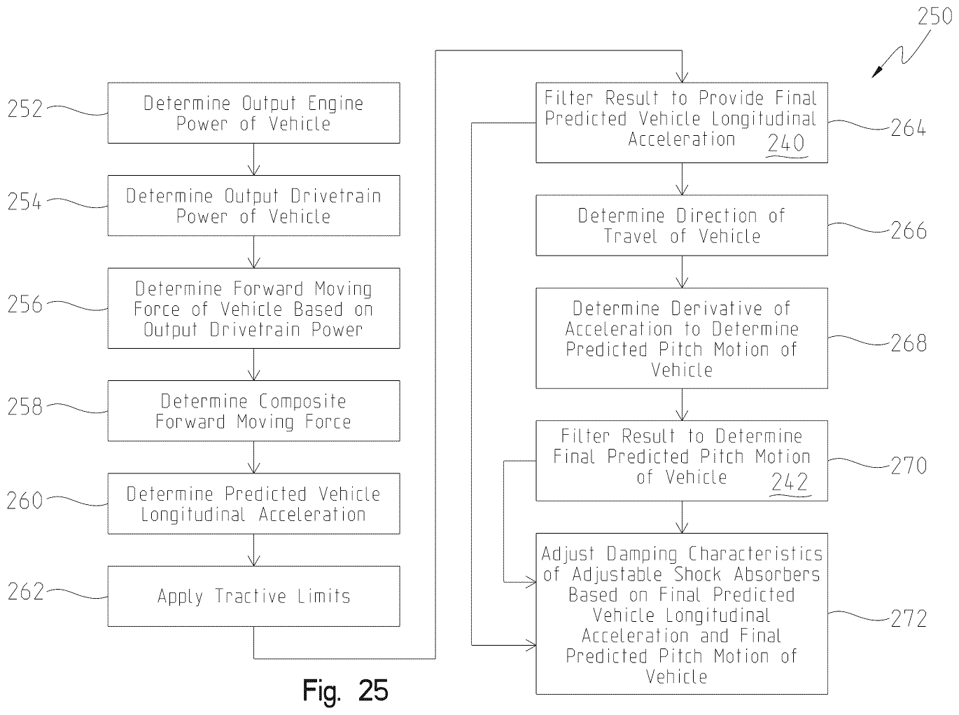

Referring to FIG. 25, an exemplary processing sequence 250 of suspension controller 200 for determining a predicted longitudinal acceleration 240 and a predicted vehicle pitch 242 of snowmobile 10 is illustrated. A predicted power for prime mover 110, for example an internal combustion engine, is determined, as represented by block 252. In one example, an engine torque is provided from an engine controller of the vehicle. The engine torque is multiplied by a measured engine speed measured by engine speed sensor 133 to determine a power output of the engine. In another example, a throttle position is measured and with a look-up table a corresponding engine torque is provided. Again, the engine torque is multiplied by an engine speed to obtain the output power of the engine. In embodiments, a value is measured by air pressure sensor 141 and the look-up table used to determine engine torque is multi-dimensional and includes torque values for different air pressures. In one example, air pressure sensor 141 measures an air pressure associated with an airbox of the snowmobile 10. In another example, air pressure is measured indirectly by GPS sensor 131 which determines a location of snowmobile 10 and based on a look-up table provides an ambient air pressure reading for that elevation either actual from a third party service or typical based on a look-up table.

The determined engine power is then multiplied by an efficiency factor for the transmission of snowmobile 10 to provide an output power for the drivetrain, as represented by block 254. In one example, the efficiency factor accounts for losses associated with the CVT transmission. The output power of the drivetrain is converted to a forward moving force of the vehicle by dividing the output power of the drivetrain by the vehicle speed measured by vehicle speed sensor 139, as represented by block 256.

A resultant or composite forward moving force is determined by subtracting from the determined forward moving force of block 256 a coast down force of the vehicle and a braking force, as represented by block 258. The coast down force of the vehicle is determined through a look-up table as a function of a measured vehicle speed measured by vehicle speed sensor 139. The braking force is determined through a look-up table of braking force as a function of a measured brake pressure measured by brake pressure sensor 135.

A predicted vehicle longitudinal acceleration is determined by dividing the resultant forward moving force by the mass the vehicle, as represented by block 260. In one example, a standard mass of the vehicle is used.

The predicted vehicle longitudinal acceleration is compared to tractive limits and set equal to the respective tractive limit (a negative tractive limit for a deceleration of snowmobile 10 and a positive tractive limit for an acceleration of snowmobile 10) if the predicted longitudinal acceleration exceeds the respective tractive limit, as represented by block 262.

In embodiments, the predicted vehicle acceleration from block 262 is filtered, as represented by block 264, to provide a smoother response. The filtering is helpful to account for the time difference between a determined engine output power and an acceleration of snowmobile 10 and to account for different sampling rates of the various sensors.

The filtered predicted vehicle longitudinal acceleration is used to determine a predicted pitch motion of snowmobile 10. A direction of travel of snowmobile 10 is determined, as represented block 266. Once a direction of travel is known, forward or reverse, the effect of the acceleration or deceleration on the front and rear of the vehicle can be considered. In one example, a gear selection sensor 137 is provided as part of the shiftable transmission of snowmobile 10 and provides an indication of whether the shiftable transmission is in a forward gear or a reverse gear. In another example, the gear selection sensor monitors in an electric reverse input (not shown) has been actuated. Upon actuation of the electric reverse input, the engine of snowmobile 10 is stalled and then fired in a reverse direction to change the rotation of the output shaft of the engine.

The predicted magnitude of the pitch motion is determined by taking the derivative of the filtered predicted vehicle longitudinal acceleration, as represented by block 268. This predicted vehicle pitch motion value is filtered to provide a smother result over time, as represented by block 270. The predicted vehicle pitch motion 242 and/or the predicted vehicle longitudinal acceleration 240 are used by shock damping logic 150 to adjust the damping characteristics of right front adjustable shock absorber 140, left front adjustable shock absorber 142, front track adjustable shock absorber 144, and rear track adjustable shock absorber 146, as represented by block 272.

In embodiments, the predicted vehicle longitudinal acceleration and the predicted vehicle pitch motion are used to alter the base damping of right front adjustable shock absorber 140, left front adjustable shock absorber 142, front track adjustable shock absorber 144, and rear track adjustable shock absorber 146 which may be set by the selected vehicle mode (comfort, handling, and rough trail). The damping characteristic tables for compression of each of right front adjustable shock absorber 140, left front adjustable shock absorber 142, front track adjustable shock absorber 144, and rear track adjustable shock absorber 146 and the damping characteristics tables for rebound of each of right front adjustable shock absorber 140, left front adjustable shock absorber 142, front track adjustable shock absorber 144, and rear track adjustable shock absorber 146 may be two-dimensional (one input, one output damping characteristic), three-dimensional (two inputs, one output damping characteristic), or x dimensional (x−1 inputs, one output damping characteristic).

In embodiments, the base damping tables are two-dimensional map for each of right front adjustable shock absorber 140, left front adjustable shock absorber 142, front track adjustable shock absorber 144, and rear track adjustable shock absorber 146 and each of compression damping characteristic and rebound characteristic (two inputs, one output). The two inputs are vehicle speed and predicted longitudinal vehicle acceleration and the output depending on the table is one of compression damping and rebound damping. In one example, vehicle speed is measured by vehicle speed sensor 139 and the predicted longitudinal vehicle acceleration is determined by processing sequence 250.

Referring to FIG. 8C, predictive longitudinal acceleration and pitch motion table 236 provides damping characteristics for right front adjustable shock absorber 140, left front adjustable shock absorber 142, front track adjustable shock absorber 144, and rear track adjustable shock absorber 146 based on a predicted longitudinal vehicle acceleration and a predicted vehicle pitch motion. Assuming snowmobile 10 is traveling forward, for a predicted constant longitudinal acceleration (no or minimal predicted pitch motion) shock damping logic 150 increases the rebound damping characteristic for right front adjustable shock absorber 140 and left front adjustable shock absorber 142 and, optionally, reduce the compression damping characteristic for right front adjustable shock absorber 140 and left front adjustable shock absorber 142. For a predicted increase in the vehicle pitch motion (a rearward pitch) shock damping logic 150 further increases the rebound damping characteristic of right front adjustable shock absorber 140 and left front adjustable shock absorber 142 and increase the compression damping characteristic for front track adjustable shock absorber 144 and rear track adjustable shock absorber 146 for the duration of the predicted vehicle pitch motion.

Assuming snowmobile 10 is traveling forward, for a predicted constant longitudinal deceleration (no or minimal pitch) shock damping logic 150 increases the rebound damping characteristic and decreases the compression damping characteristic for right front adjustable shock absorber 140 and left front adjustable shock absorber 142 and, optionally, increases the rebound damping characteristic for front track adjustable shock absorber 144 and rear track adjustable shock absorber 146. For a predicted decrease in the vehicle longitudinal pitch motion (a forward pitch) shock damping logic 150 further increases the compression damping characteristic of right front adjustable shock absorber 140 and left front adjustable shock absorber 142 and alters, such as increases, the rebound damping characteristic for front track adjustable shock absorber 144 and alters, such as increases, a rebound damping of the rear track adjustable shock absorber 146 for the duration of the predicted vehicle pitch motion. For a predicted increase in the vehicle longitudinal pitch motion (a rearward pitch) shock damping logic 150 alters, such as increases, the compression damping characteristic front track adjustable shock absorber 144 and alters, such as increases, a compression damping of the rear track adjustable shock absorber 146 for the duration of the predicted vehicle pitch motion. Further, for a predicted increase in the vehicle longitudinal pitch motion (a rearward pitch) shock damping logic 150 alters, such as increases, the rebound damping characteristic of the rear track adjustable shock absorber 146 for the duration of the predicted vehicle pitch motion. Additionally, for a predicted increase in the vehicle longitudinal pitch motion (a rearward pitch) shock damping logic 150 alters, such as increases, the rebound damping characteristic of the right front adjustable shock absorber 140 and the left front adjustable shock absorber 142 for the duration of the predicted vehicle pitch motion

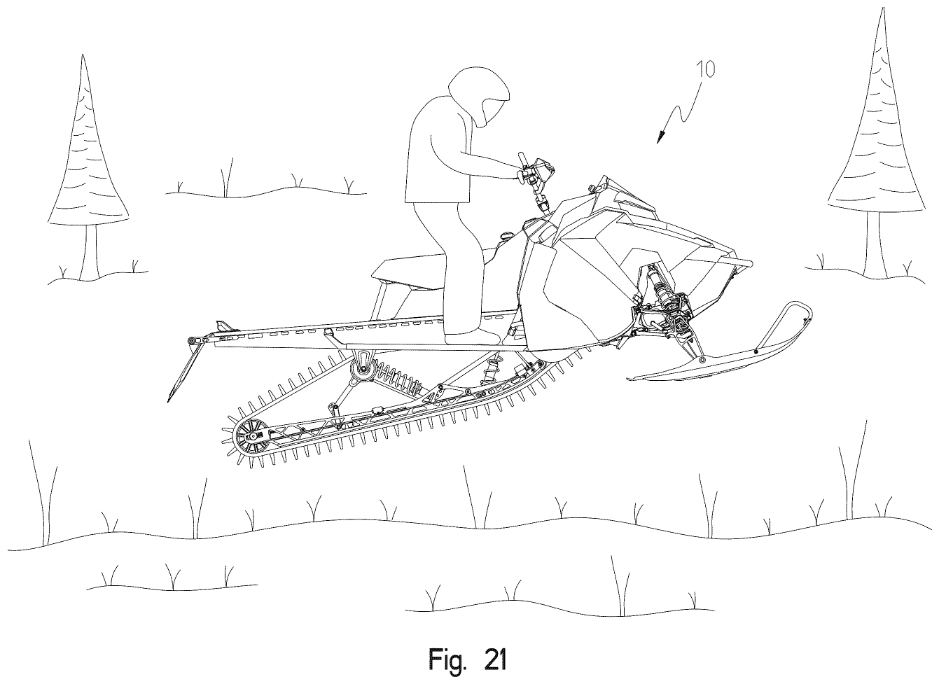

Returning to FIG. 8C, airborne time table 210 includes damping characteristics for each of right front adjustable shock absorber 140, left front adjustable shock absorber 142, front track adjustable shock absorber 144, and rear track adjustable shock absorber 146 based on the elapsed time that snowmobile 10 has been airborne. An example of snowmobile 10 being airborne is illustrated in FIG. 21. In embodiments, airborne time table 210 specifies a percentage of available damping range for compression damping only, for rebound damping only, or for both compression damping and rebound damping for one or more time period ranges of airborne detection. For example, a first percentage for a first time range of airborne elapsed time detection and a second percentage for a second time range of airborne elapsed time detection.

In embodiments, upon detection of an airborne state, the compression damping characteristics for right front adjustable shock absorber 140, left front adjustable shock absorber 142, front track adjustable shock absorber 144, and rear track adjustable shock absorber 146 provide an increased damping percentage over the base damping tables and continue to increase as the detected airborne time continues to increase. The increased compression damping is held after airborne event has concluded to make sure the added compression damping is used through the entire compression stroke of the respective shocks. In one example, the increased compression damping is held for about 300 milliseconds. The increased compression damping is stepped back down to the base damping level for normal operation of snowmobile 10 or is altered to another level if a different event is detected, such as acceleration, braking or cornering.

In embodiments, upon detection of an airborne state, the rebound damping characteristics for right front adjustable shock absorber 140, left front adjustable shock absorber 142, front track adjustable shock absorber 144, and rear track adjustable shock absorber 146 go to a minimal value, such as zero to promote shock extension. Once snowmobile 10 has landed, the rebound damping characteristic increases to stabilize the landing and reduce the occurrence of vehicle hops. The amount of rebound increase is based on airborne time (higher for longer airborne times). This provides different responses between small airborne events, like whoops, and larger airborne events so it can activate differently in whoops (medium size bumps on trail) versus big jumps which have longer air times. Rebound damping is held at the minimal level while snowmobile 10 is airborne and upon initial landing increased and held for a time period generally equal to the first extension stroke of the respective shock after compression. An advantage among others is that this keeps the track and skis in contact with the snow more for increased traction and stability.

In embodiments, IMU 132 is used to detect when snowmobile 10 is airborne by monitoring acceleration along axis 164 (see FIG. 1A). Exemplary detection of an airborne event is described in US Published Patent Application No. 2016/0059660, filed Nov. 6, 2015, titled VEHICLE HAVING SUSPENSION WITH CONTINUOUS DAMPING CONTROL, assigned to the present assignee, the entire disclosure of which is expressly incorporated by reference herein. Additional exemplary detection methodologies for an airborne event are described in U.S. Pat. No. 9,381,810, filed Jun. 3, 2011, titled ELECTRONIC THROTTLE CONTROL, assigned to the present assignee, the entire disclosure of which is expressly incorporated by reference herein.

Driver actuatable suspension adjust input event table 212 includes damping characteristics for each of right front adjustable shock absorber 140, left front adjustable shock absorber 142, front track adjustable shock absorber 144, and rear track adjustable shock absorber 146 in response to an actuation of driver actuatable suspension adjust input event table 212 of snowmobile 10. In embodiments, driver actuatable suspension adjust input event table 212 specifies a percentage of available damping range for compression damping only, for rebound damping only, or for both compression damping and rebound damping for an actuation of driver actuatable suspension adjust input event table 212. In embodiments, actuation of driver actuatable suspension adjust input event table 212 results in the compression damping for each of right front adjustable shock absorber 140, left front adjustable shock absorber 142, front track adjustable shock absorber 144, and rear track adjustable shock absorber 146 is set at an increased level. In one example, the compression damping for each of right front adjustable shock absorber 140, left front adjustable shock absorber 142, front track adjustable shock absorber 144, and rear track adjustable shock absorber 146 are set at 100 percent. The driver actuatable suspension adjust input 172 is actuatable by an operator to increase the compression damping to absorb rough terrain that the operator views as upcoming.

In embodiments, a second actuation of driver actuatable suspension adjust input 172 within a given time period is interpreted by electronic controller 100 to reduce compression damping for right front adjustable shock absorber 140, left front adjustable shock absorber 142, front track adjustable shock absorber 144, and rear track adjustable shock absorber 146 to absorb chatter bumps (small bumps on trail).

In embodiments, a second actuation of driver actuatable suspension adjust input 172 within a given time period is interpreted by electronic controller 100 to hold compression damping for right front adjustable shock absorber 140, left front adjustable shock absorber 142, front track adjustable shock absorber 144, and rear track adjustable shock absorber 146 until a third actuation of driver actuatable suspension adjust input 172 is received or a driver mode (comfort, handling, rough trail) is changed.

In embodiments, a continued actuation of driver actuatable suspension adjust input 172, such as holding a button down, for a given time period is interpreted by electronic controller 100 to hold compression damping for right front adjustable shock absorber 140, left front adjustable shock absorber 142, front track adjustable shock absorber 144, and rear track adjustable shock absorber 146 until a subsequent actuation of driver actuatable suspension adjust input 172 is received or a driver mode (comfort, handling, rough trail) is changed.

In embodiments, driver actuatable suspension adjust input 172 is not a separate input, but is recognized as a characteristic of another driver input. In one example, a quick partial actuation of a brake lever for a short duration of time that is detected by brake switch 134 is interpreted by controller 100 as an input from driver actuatable suspension adjust input 172 while a longer actuation and/or a more complete actuation of the brake lever is interpreted by controller 100 as an actuation of the brakes of snowmobile 10.

Brake event table 214 includes damping characteristics for each of right front adjustable shock absorber 140, left front adjustable shock absorber 142, front track adjustable shock absorber 144, and rear track adjustable shock absorber 146 based on an actuation of a brake input of snowmobile 10 as monitored by brake switch 134 on the brake lever or based on a pressure value from brake pressure sensor 135 (actual pressure reading or pressure switch).

In embodiments, upon detection of braking while snowmobile 10 is traveling forward, the compression damping characteristics for right front adjustable shock absorber 140 and left front adjustable shock absorber 142 are increased to minimize forward pitch of snowmobile 10 and bottoming out of right front adjustable shock absorber 140 and left front adjustable shock absorber 142. For front track adjustable shock absorber 144, the compression damping characteristic is decreased to increase the ability of snowmobile 10 to absorb trail bumps and to collect snow in front of endless track 18 to assist slowing snowmobile 10. For rear track adjustable shock absorber 146, the compression damping either remains at a current level or is decreased to keep more weight of snowmobile 10 on endless track 18.

In embodiments, upon detection of braking while snowmobile 10 is traveling forward, the rebound damping characteristics for right front adjustable shock absorber 140 and left front adjustable shock absorber 142 either remains the same or is decreased to keep right front adjustable shock absorber 140 and left front adjustable shock absorber 142 extended as much as possible and thereby keep the front of snowmobile 10 higher. For front track adjustable shock absorber 144, the rebound damping characteristic is increased to collect snow in front of endless track 18 to assist slowing snowmobile 10 and keep track weight. For rear track adjustable shock absorber 146, the rebound damping is increased to reduce pitch motion of snowmobile 10 and keep more weight transferred to the rear of snowmobile 10.

In embodiments, a separate brake event table 214 is not provided due to the braking response being accounted for in predictive vehicle pitch table 236 when looking at a predicted deceleration of snowmobile 10.

Anti-dive event table 216 includes damping characteristics for each of right front adjustable shock absorber 140 and left front adjustable shock absorber 142 based on a deceleration rate of the vehicle from the accelerometer input or the vehicle speed input. In embodiments, anti-dive event table 216 specifies a percentage of available damping range for compression damping only, for rebound damping only, or for both compression damping and rebound damping based on an actuation of a brake input of snowmobile 10 as monitored by brake switch 134 or based on a pressure value from brake pressure sensor 135. In embodiments, the compression damping characteristics for right front adjustable shock absorber 140 and left front adjustable shock absorber 142 are increased to minimize forward pitch of snowmobile 10 and bottoming out of right front adjustable shock absorber 140 and left front adjustable shock absorber 142. For front track adjustable shock absorber 144, the compression damping characteristic is decreased to increase the ability of snowmobile 10 to absorb trail bumps and to collect snow in front of endless track 18 to assist slowing snowmobile 10. For rear track adjustable shock absorber 146, the compression damping either remains at a current level or is decreased to keep more weight of snowmobile 10 on endless track 18.

In embodiments, upon detection of braking while snowmobile 10 is traveling forward, the rebound damping characteristics for right front adjustable shock absorber 140 and left front adjustable shock absorber 142 either remains the same or is decreased to keep right front adjustable shock absorber 140 and left front adjustable shock absorber 142 extended as much as possible and thereby keep the front of snowmobile 10 higher. For front track adjustable shock absorber 144, the rebound damping characteristic is increased to collect snow in front of endless track 18 to assist slowing snowmobile 10 and keep track weight. For rear track adjustable shock absorber 146, the rebound damping is increased to reduce pitch motion of snowmobile 10 and keep more weight transferred to the rear of snowmobile 10.

In embodiments, the compression damping characteristics for right front adjustable shock absorber 140 and left front adjustable shock absorber 142 are increased over level for a braking event 214. Based on a level of the brake pressure applied, shock damping logic 150 selects between brake event table 214 and anti-dive event table 216 with anti-dive event table 216 being for higher levels of brake pressure. In one example, anti-dive event table 216 is used for an initial timeframe and then brake event table 214 thereafter because the vehicle speed has slowed.

In embodiments, a separate anti-dive event table 216 is not provided. In embodiments, the braking and anti-dive response are accounted for in the predictive vehicle pitch table 236 when looking at a predicted deceleration of snowmobile 10 and at a predicted pitch forward of snowmobile 10. In embodiments, the braking and anti-dive response is accounted for based on the degree of actuation of the brake level or on the level or monitored brake pressure.

One ski event table 218 includes damping characteristics for each of right front adjustable shock absorber 140, left front adjustable shock absorber 142, front track adjustable shock absorber 144, and rear track adjustable shock absorber 146 based on a steering angle of the steering system and one or more outputs of IMU 132, such as a lateral acceleration, a roll axis angle, and a roll rate. In embodiments, one ski event table 218 specifies a percentage of available damping range for compression damping only, for rebound damping only, or for both compression damping and rebound damping based on a roll angle detected by IMU 132.

In embodiments, if snowmobile 10 is rolling towards the right side the compression damping for left front adjustable shock absorber 142 is increased to counteract the roll and the rebound damping for right front adjustable shock absorber 140 is decreased to extend right front adjustable shock absorber 140 to increase contact with the snow. If snowmobile 10 is rolling towards the left side the compression damping for right front adjustable shock absorber 140 is increased to counteract the roll and the rebound damping for left front adjustable shock absorber 142 is decreased to extend left front adjustable shock absorber 142 to increase contact with the snow. In embodiments, if snowmobile 10 is rolling towards the right then increase compression damping for the right shock and decrease rebound damping for the right shock. In embodiments, if snowmobile 10 is rolling towards left then increase compression damping for left shock and decrease compression damping for left shock.

G-out event table 224 includes damping characteristics for each of right front adjustable shock absorber 140, left front adjustable shock absorber 142, front track adjustable shock absorber 144, and rear track adjustable shock absorber 146 based on a pitch motion of snowmobile 10. In embodiments, G-out event table 224 specifies a percentage of available damping range for compression damping only, for rebound damping only, or for both compression damping and rebound damping. In embodiments, the compression damping characteristic for right front adjustable shock absorber 140, left front adjustable shock absorber 142, and rear track adjustable shock absorber 146 is increased.

Chatter event table 226 includes damping characteristics for each of right front adjustable shock absorber 140, left front adjustable shock absorber 142, front track adjustable shock absorber 144, and rear track adjustable shock absorber 146 based on based on a pitch motion of snowmobile 10. In embodiments, chatter event table 226 specifies a percentage of available damping range for compression damping only, for rebound damping only, or for both compression damping and rebound damping. In embodiments, both the compression and rebound damping are decreased for all shock absorbers. In embodiments, chatter events are distinguished from whoops events based on a frequency analysis of the IMU output.

Cornering event table 228 includes damping characteristics for each of right front adjustable shock absorber 140, left front adjustable shock absorber 142, and front track adjustable shock absorber 144 based longitudinal acceleration of snowmobile 10 and at least one of steering angle sensor 136 or acceleration along axis 162 (lateral acceleration) for cornering. In embodiments, cornering event table 228 specifies a percentage of available damping range for compression damping only, for rebound damping only, or for both compression damping and rebound damping.

In embodiments, upon detection of cornering while snowmobile 10 is traveling forward, the compression damping characteristics for the front outside shock (fp140 if turning to left or left front adjustable shock absorber 142 if turning to the right) is increased minimize roll of snowmobile 10 and for the front inside shock (fp142 if turning to left or right front adjustable shock absorber 140 if turning to the right) is decreased to absorb trail bumps more smoothly. The level of increase and decrease is dependent on the longitudinal acceleration of snowmobile 10 (larger increases and decreases for higher speeds) to control pitch motion for snowmobile 10. Regardless of the direction of the turn, the compression damping characteristic for front track adjustable shock absorber 144 is decreased to add ski traction for improved cornering and for rear track adjustable shock absorber 146 the compression damping characteristic is updated to control longitudinal pitch motion and weight transfer throughout the cornering event. For example, at corner entry, the compression damping characteristic of rear track adjustable shock absorber 146 may remain unchanged or be decreased based on longitudinal acceleration, but at mid corner or at corner exit when the throttle is applied the compression damping characteristic of rear track adjustable shock absorber 146 may be increased to prevent lifting of the skis and losing traction on the front of snowmobile 10.

In embodiments, upon detection of cornering while snowmobile 10 is traveling forward, the rebound damping characteristics for the front inside shock (fp142 if turning to left or right front adjustable shock absorber 140 if turning to the right) is increased to reduce roll of snowmobile 10. The level of increase and decrease is dependent on the longitudinal acceleration of snowmobile 10. In one example, the level of increase and decrease is also dependent on a lateral acceleration of snowmobile 10. Regardless of the direction of the turn, the rebound damping characteristic for front track adjustable shock absorber 144 is increased to add ski traction for improved cornering and for rear track adjustable shock absorber 146 the rebound damping characteristic remains unchanged or is increased to control longitudinal pitch motion, hold the rear end down, and control vehicle body motion throughout the cornering event.

Brake corner event table 220 includes damping characteristics for each of right front adjustable shock absorber 140, left front adjustable shock absorber 142, front track adjustable shock absorber 144, and rear track adjustable shock absorber 146 based on snowmobile 10 both cornering and braking. In embodiments, shock damping logic 150 follows whichever of brake event table 214 and corner event table 228 has a higher priority. In one example, the cornering event has a higher priority than the braking event.

Chatter corner event table 222 includes damping characteristics for each of right front adjustable shock absorber 140, left front adjustable shock absorber 142, front track adjustable shock absorber 144, and rear track adjustable shock absorber 146 based on snowmobile 10 both cornering and airborne detection. In embodiments, airborne events override cornering events. Further, a steering angle could be used to modify the airborne damping value increasing the damping of the outside front and/or rear shock. In embodiments, a separate chatter corner event table 222 is not provided, but rather shock damping logic 150 follows whichever of airborne time event table 210 and corner event table 228 has a higher priority.

Base damping table 230 includes damping characteristics for each of right front adjustable shock absorber 140, left front adjustable shock absorber 142, front track adjustable shock absorber 144, and rear track adjustable shock absorber 146 in the absence of detecting one or more of airborne time event table 210, driver actuatable suspension adjust input event table 212, brake event table 214, anti-dive event table 216, one ski event table 218, brake corner event table 220, chatter corner event table 222, g-out event table 224, chatter event table 226, corner event table 228, launch mode event table 232, anti-squat event table 234, and predictive vehicle pitch table 236. In embodiments, base damping table 230 specifies a percentage of available damping range for compression damping only, for rebound damping only, or for both compression damping and rebound damping for detected vehicle speeds and/or throttle positions. As mentioned herein, each of the selectable modes (comfort, handling, and rough trail) have their own base damping table.

Launch mode event table 232 includes damping characteristics for each of front track adjustable shock absorber 144 and rear track adjustable shock absorber 146 based on an actuation of the launch mode input 174 or based on one or more sensor readings (such as vehicle speed is zero and throttle actuation above a first level). In embodiments, launch mode event table 232 specifies a percentage of available damping range for compression damping only, for rebound damping only, or for both compression damping and rebound damping. In response to an actuation of the launch mode input, different actions are taken based on the selected mode (Comfort, Handling, Rough Trail) of snowmobile 10 for the expected high acceleration of snowmobile 10. For the Comfort and Handling modes, it is desired to keep skis 16 on the snow. To achieve this outcome, the compression damping characteristics for front track adjustable shock absorber 144 is maintained or decreased, the rebound damping characteristic for front track adjustable shock absorber 144 is increased, the compression damping characteristic for rear track adjustable shock absorber 146 is increased, and the rebound damping characteristic for rear track adjustable shock absorber 146 is maintained or decreased. These changes both promotes keeping the skis 16 on the snow and minimizing a rearward pitch motion. For the Rough Trail mode, it may be desirable to raise skis 16 off of the snow. To achieve this outcome, the compression damping characteristics for front track adjustable shock absorber 144 is increased, the rebound damping characteristic for front track adjustable shock absorber 144 is decreased, the compression damping characteristic for rear track adjustable shock absorber 146 is maintained or decreased, and the rebound damping characteristic for rear track adjustable shock absorber 146 is maintained or increased. These changes both promotes lifting the skis 16 and promoting a rearward pitch motion. Further, when starting from a stop or low speed, the changes to front track adjustable shock absorber 144 and rear track adjustable shock absorber 146 may be further modified to promote snowmobile 10 raising the skis further off the ground to perform a wheelie.

Anti-squat event table 234 includes damping characteristics for each of right front adjustable shock absorber 140, left front adjustable shock absorber 142, front track adjustable shock absorber 144, and rear track adjustable shock absorber 146 based longitudinal acceleration of snowmobile 10 measured by IMU 132, a pitch rate, and/or a pitch angle measured by IMU 132. In embodiments, anti-squat event table 234 specifies a percentage of available damping range for compression damping only, for rebound damping only, or for both compression damping and rebound damping for one or more time period ranges of detection. For a measured pitch angle, shock damping logic 150 increases the rebound damping characteristic of right front adjustable shock absorber 140 and left front adjustable shock absorber 142 and increases the compression damping characteristic for front track adjustable shock absorber 144 and rear track adjustable shock absorber 146 for the duration of the predicted vehicle pitch motion.

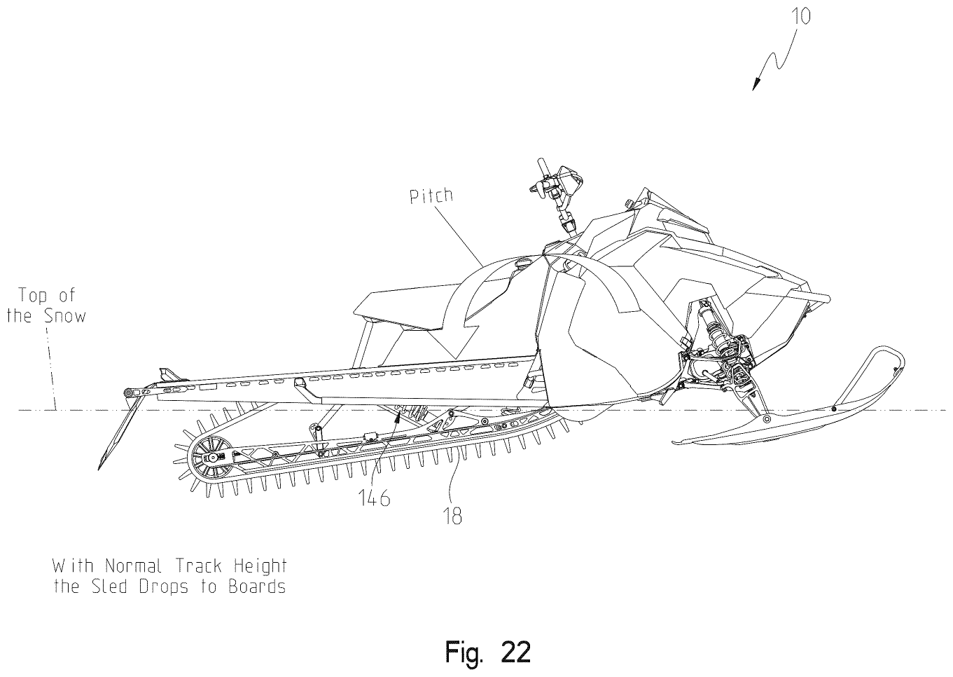

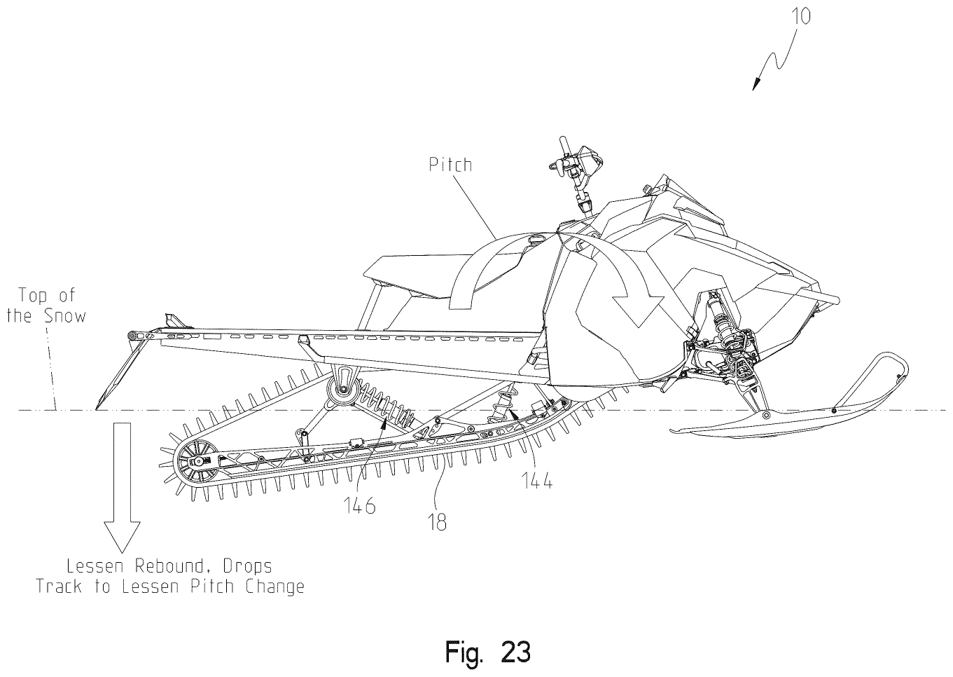

Having right front adjustable shock absorber 140, left front adjustable shock absorber 142, front track adjustable shock absorber 144, and rear track adjustable shock absorber 146 being adjustable is helpful for orienting snowmobile 10 in various environmental situations. Referring to FIG. 22, snowmobile 10 is shown in deep snow. When the shock absorbers 144 and 146 are not adjustable, the rear of snowmobile 10 sinks in the snow up to the running boards of snowmobile 10. By sensing the rearward pitch of snowmobile 10 with IMU 132, the rebound damping characteristic of front track adjustable shock absorber 144 and rear track adjustable shock absorber 146 can be automatically increased to promote extension of front track adjustable shock absorber 144 and rear track adjustable shock absorber 146 and the compression damping characteristic of front track adjustable shock absorber 144 and rear track adjustable shock absorber 146 can be decreased. This results in the rear end of the rear suspension to drop and keeps snowmobile 10 more level in the snow.

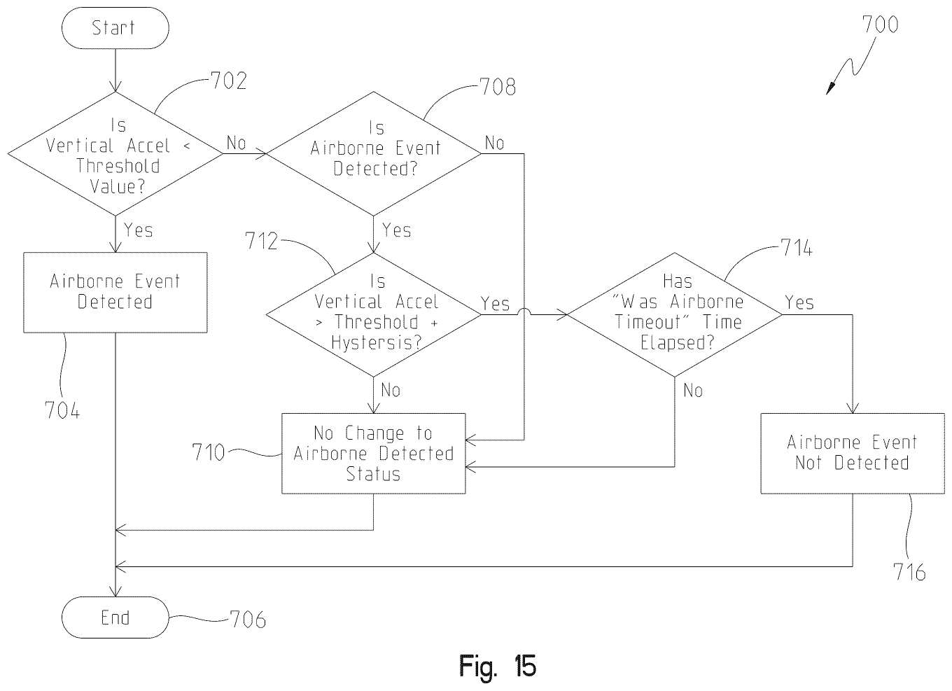

Referring to FIGS. 9A-C, an exemplary processing sequence 300 of the shock damping logic 150 of the electronic controller 200 of FIG. 6 for left front adjustable shock absorber 142 provided as part of the suspension 24 of a left front ski 16 of the exemplary snowmobile 10 of FIG. 1. Referring to FIG. 9A, processing sequence 300 determines if an airborne event is detected, as represented by block 302. An exemplary process 700 for detecting an airborne event is illustrated in FIG. 15. If an airborne event is detected, the damping characteristics for left front adjustable shock absorber 142 is set based on the damping value provided in airborne time table 210 of shock damping logic 150, as represented by block 304 and processing sequence 300 is completed, as represented by block 306.

If an airborne event is not detected, shock damping logic 150 determines if a driver actuatable suspension adjust input event is detected, as represented by block 310. If a driver actuatable suspension adjust input event is detected, the damping characteristics for left front adjustable shock absorber 142 is set based on the damping value provided in driver actuatable suspension adjust input table 212 of shock damping logic 150, as represented by block 312 and processing sequence 300 is completed, as represented by block 306.

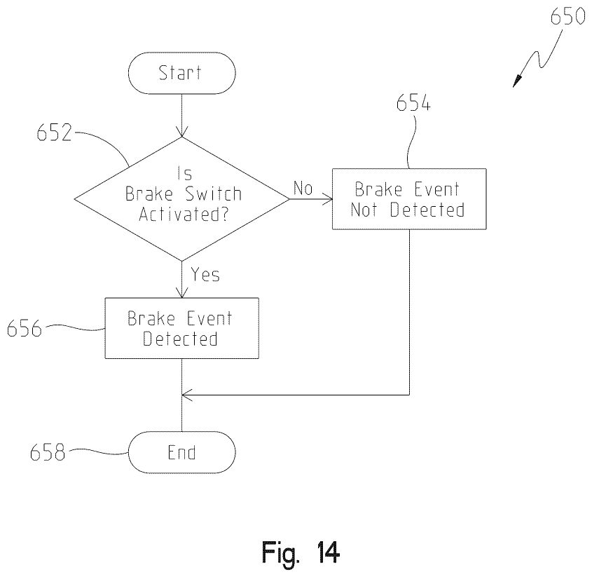

If a driver actuatable suspension adjust input event is not detected, shock damping logic 150 determines if a braking event is detected, as represented by block 314. An exemplary process 650 for detecting a braking event is illustrated in FIG. 14. If a braking event is detected, shock damping logic 150 determines if an anti-dive time threshold has elapsed, as represented by block 316. If the anti-dive threshold has not elapsed, the damping characteristics for left front adjustable shock absorber 142 is set based on the damping value provided in anti-dive table 216 of shock damping logic 150, as represented by block 318 and processing sequence 300 is completed, as represented by block 306.

If the anti-dive threshold has elapsed, the damping characteristics for left front adjustable shock absorber 142 is set based on the damping value provided in brake event table 214 of shock damping logic 150 based on a value of vehicle deceleration from IMU 132. Shock damping logic 150 next determines if a cornering event is detected, as represented by block 322. If a cornering event is not detected processing sequence 300 is completed, as represented by block 306. If a cornering event is detected, shock damping logic 150 determines if the vehicle acceleration is to the left side of snowmobile 10, as represented by block 324. If the vehicle acceleration is to the left, left front adjustable shock absorber 142 is designated the outside shock, as represented by block 326, and the damping characteristics for left front adjustable shock absorber 142 is set based on the damping value provided in brake corner event table 220 for the outside shock, as represented by block 328, and processing sequence 300 is completed, as represented by block 306. If the vehicle acceleration is not to the left, left front adjustable shock absorber 142 is designated the inside shock, as represented by block 330, and the damping characteristics for left front adjustable shock absorber 142 is set based on the damping value provided in brake corner event table for the inside shock, as represented by block 328, and processing sequence 300 is completed, as represented by block 306.

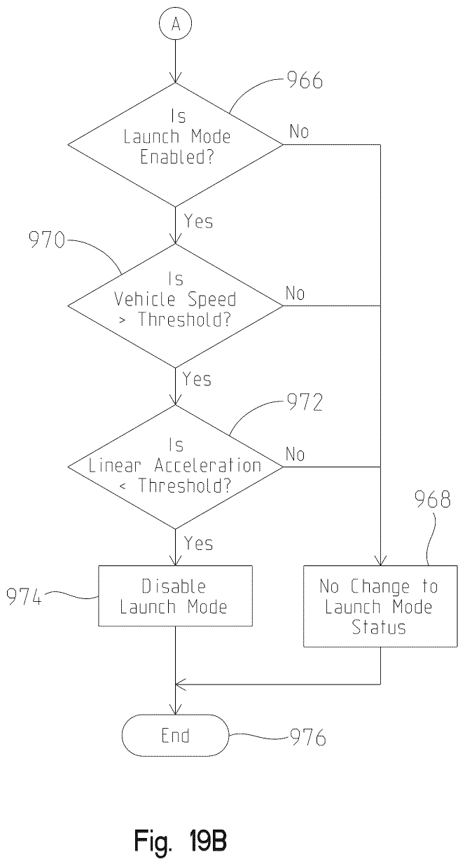

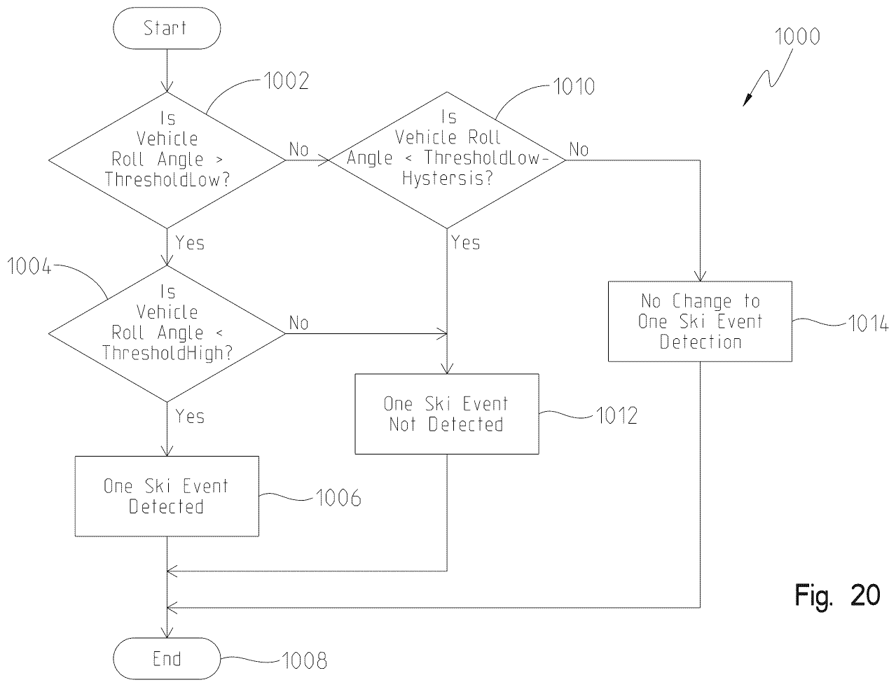

If a braking event is not detected, shock damping logic 150 determines if a one ski event is detected, as represented by block 340. An exemplary process 1000 for detecting a one ski event is illustrated in FIG. 20. If a one ski event is detected, shock damping logic 150 determines the damping characteristics for left front adjustable shock absorber 142 is set based on the damping value provided in one ski event table 218 of shock damping logic 150, as represented by block 342 and processing sequence 300 is completed, as represented by block 306.

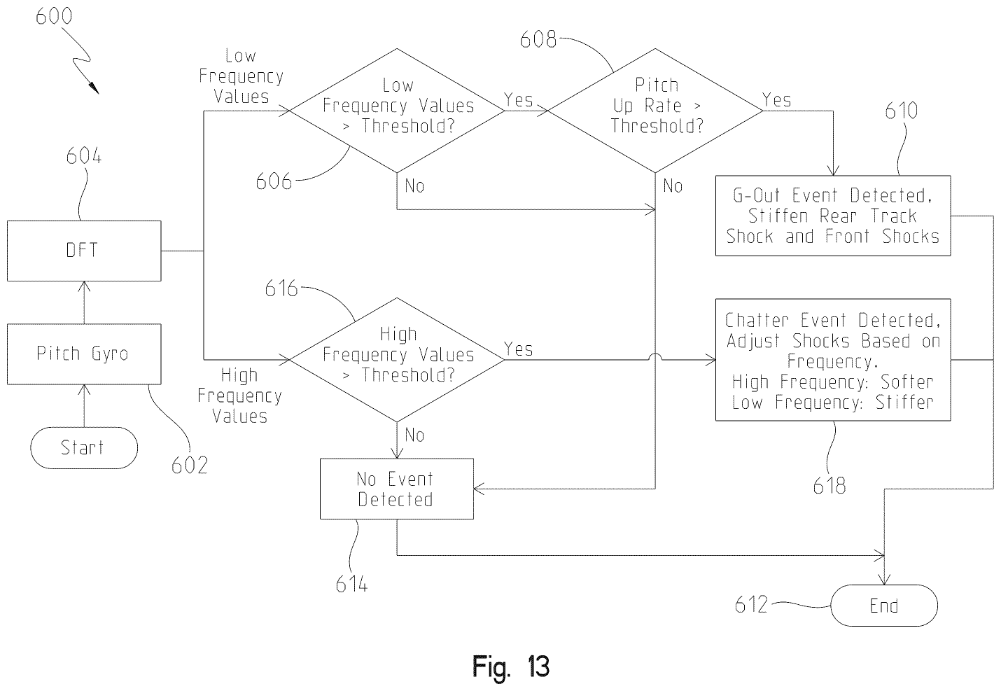

If a one ski event is not detected, shock damping logic 150 determines if a G-out event is detected, as represented by block 350. An exemplary process 600 for detecting a G-out event is illustrated in FIG. 13. If a G-out event is detected, shock damping logic 150 determines the damping characteristics for left front adjustable shock absorber 142 is set based on the damping value provided in G-out event table 224 of shock damping logic 150, as represented by block 352 and processing sequence 300 is completed, as represented by block 306.

If a G-out event is not detected, shock damping logic 150 determines if a chatter event is detected, as represented by block 354. An exemplary process 600 for detecting a chatter event is illustrated in FIG. 13. If a chatter event is detected, shock damping logic 150 determines the damping characteristics for left front adjustable shock absorber 142 is set based on the damping value provided in chatter event table 226 of shock damping logic 150, as represented by block 356. Shock damping logic 150 then determines if a cornering event is detected, as represented by block 358. If a cornering event is not detected, processing sequence 300 is completed, as represented by block 306. If a cornering event is detected, shock damping logic 150 determines if the vehicle acceleration is to the left side of snowmobile 10, as represented by block 364. If the vehicle acceleration is to the left, left front adjustable shock absorber 142 is designated the outside shock, as represented by block 366, and the damping characteristics for left front adjustable shock absorber 142 is set based on the damping value provided in chatter corner event table 222 for the outside shock, as represented by block 368, and processing sequence 300 is completed, as represented by block 306. If the vehicle acceleration is not to the left, left front adjustable shock absorber 142 is designated the inside shock, as represented by block 370, and the damping characteristics for left front adjustable shock absorber 142 is set based on the damping value provided in chatter corner event table 222 for the inside shock, as represented by block 368, and processing sequence 300 is completed, as represented by block 306.

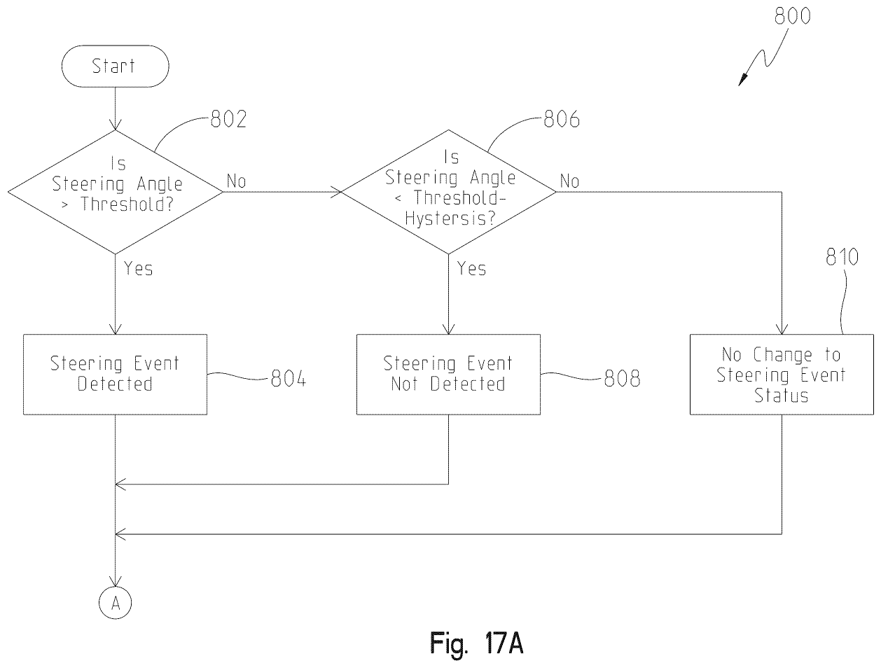

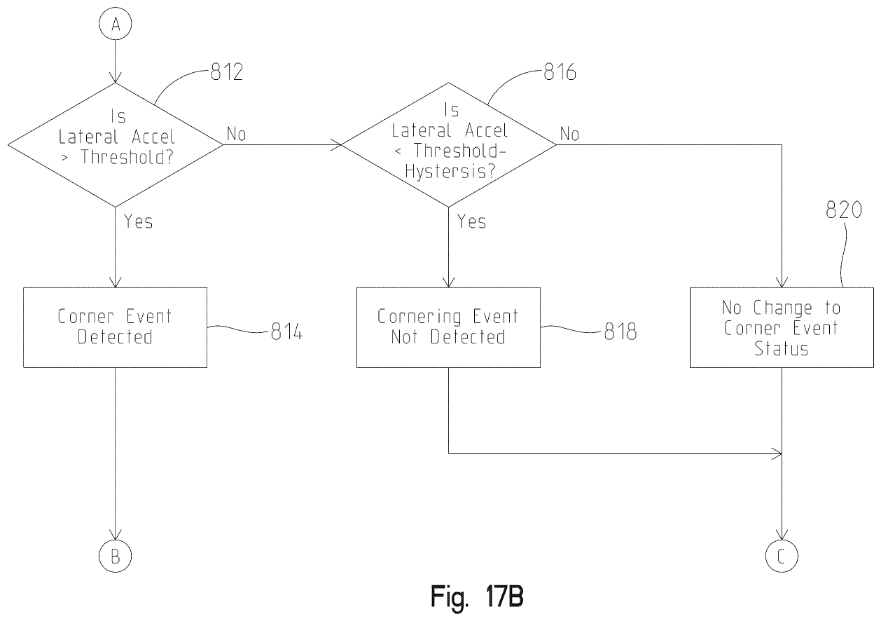

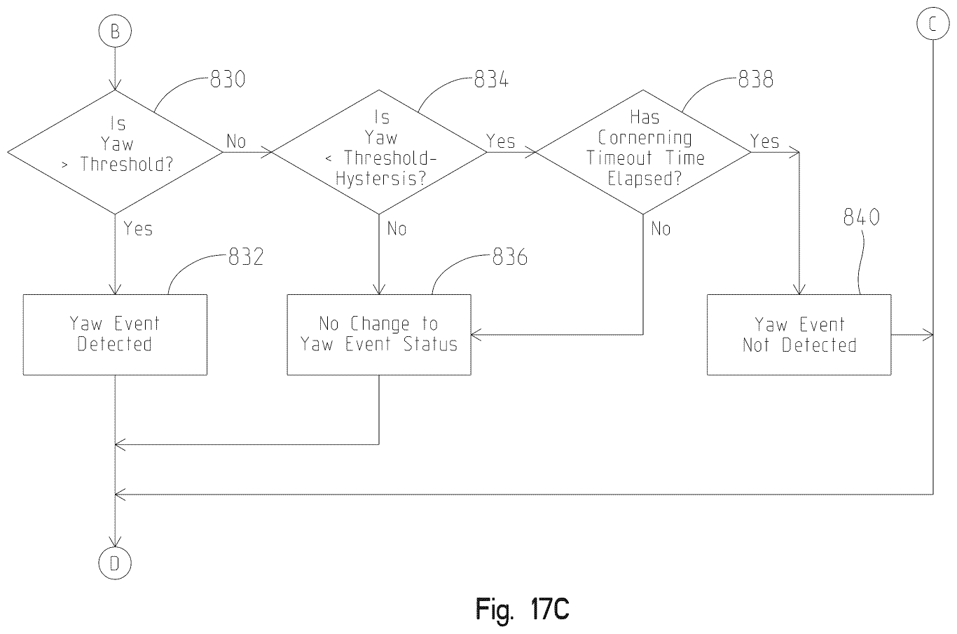

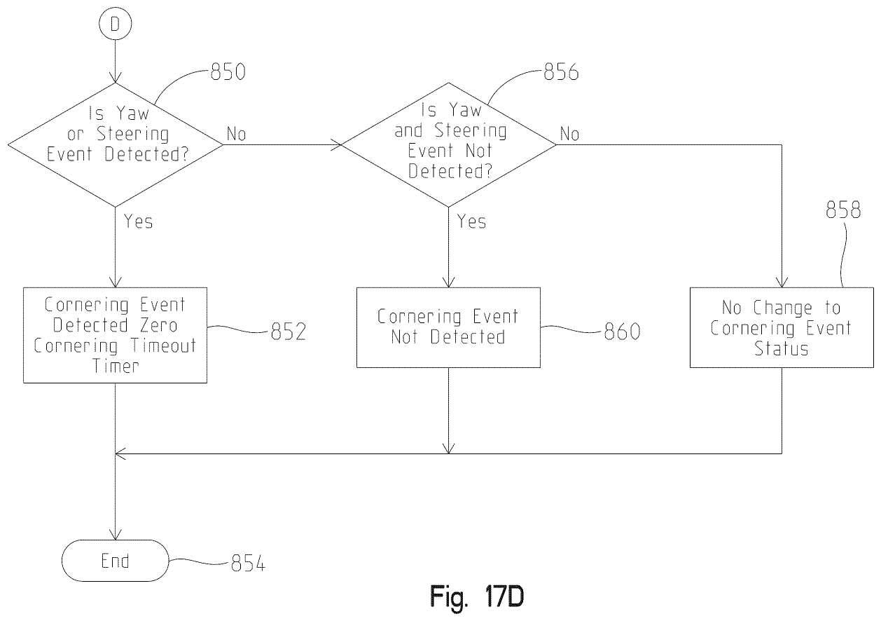

If a chatter event is not detected, shock damping logic 150 determines if a cornering event is detected, as represented by block 376. An exemplary process 800 for detecting a cornering event is illustrated in FIGS. 17A-D. If a cornering event is detected, shock damping logic 150 determines if the vehicle acceleration is to the left side of snowmobile 10, as represented by block 378. If the vehicle acceleration is to the left, left front adjustable shock absorber 142 is designated the outside shock, as represented by block 380, and the damping characteristics for left front adjustable shock absorber 142 is set based on the damping value provided in the corner event table 228 for the outside shock, as represented by block 382, and processing sequence 300 is completed, as represented by block 306. If the vehicle acceleration is not to the left, left front adjustable shock absorber 142 is designated the inside shock, as represented by block 384, and the damping characteristics for left front adjustable shock absorber 142 is set based on the damping value provided in the corner event table 228 for the inside shock, as represented by block 382, and processing sequence 300 is completed, as represented by block 306. In embodiments, shock damping logic 150 also monitors vehicle acceleration/deceleration along axis 160 and this acceleration/deceleration value is a further input to corner event table. By taking into account the vehicle acceleration/deceleration along axis 160, shock damping logic 150 is able to adjust the damping characteristics for left front adjustable shock absorber 142 differently for when snowmobile 10 is entering a corner (deceleration) and when snowmobile 10 is exiting a corner (acceleration).

If a cornering event is not detected, shock damping logic 150 determines a damping characteristic for left front adjustable shock absorber 142 based on the damping value provided in the base damping table 230, as represented by block 390 and processing sequence 300 is completed, as represented by block 306.

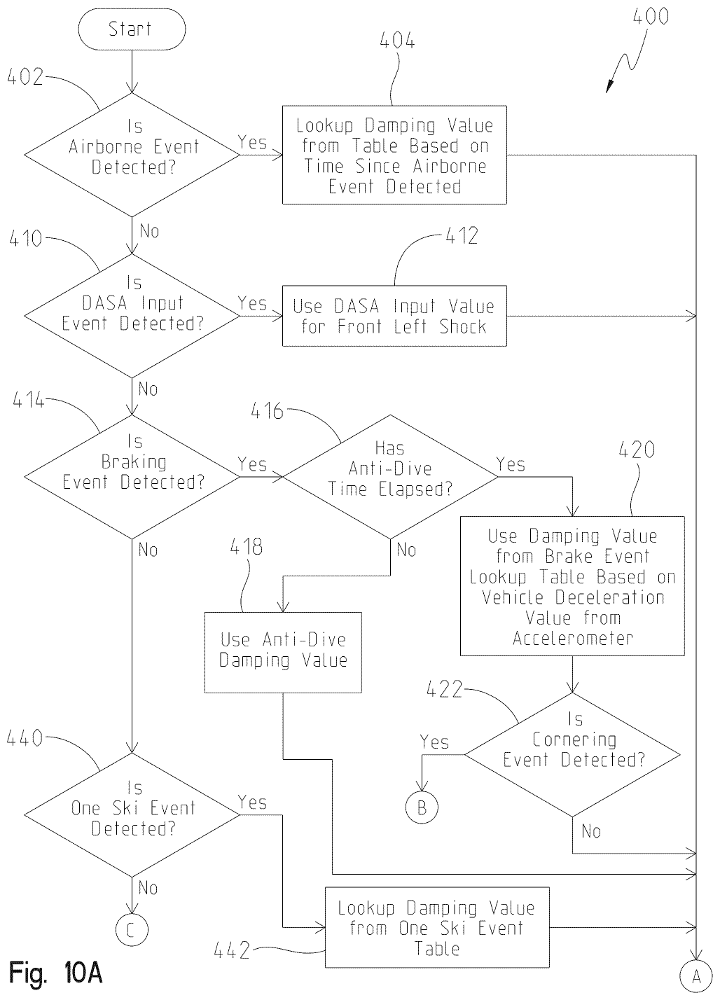

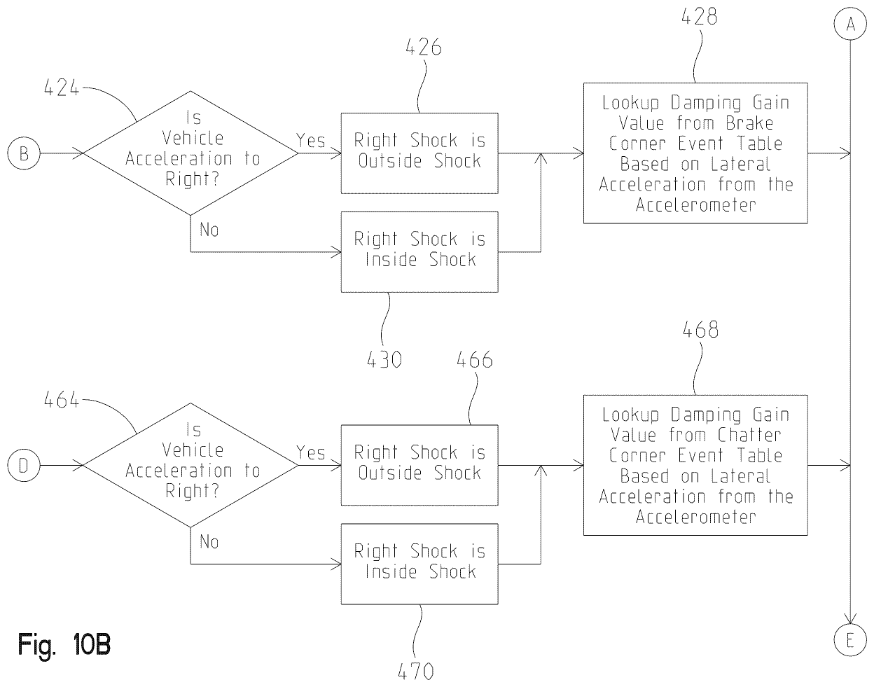

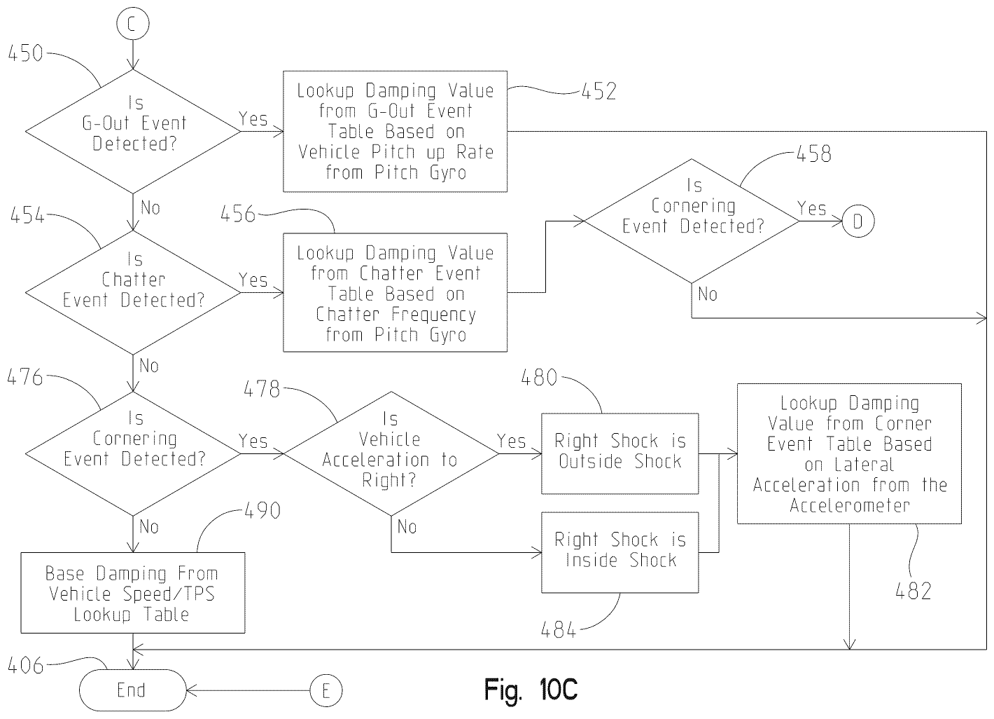

Referring to FIGS. 10A-C, an exemplary processing sequence 400 of the shock damping logic 150 of the electronic controller 200 of FIG. 6 for right front continuous damping control shock absorber 142 provided as part of the suspension 24 of a left front ski 16 of the exemplary snowmobile 10 of FIG. 1. Referring to FIG. 9A, processing sequence 400 determines if an airborne event is detected, as represented by block 402. An exemplary process 700 for detecting an airborne event is illustrated in FIG. 15. If an airborne event is detected, the damping characteristics for right front adjustable shock absorber 140 is set based on the damping value provided in airborne time table 210 of shock damping logic 150, as represented by block 404 and processing sequence 400 is completed, as represented by block 406.

If an airborne event is not detected, shock damping logic 150 determines if a driver actuatable suspension adjust input event is detected, as represented by block 410. If a driver actuatable suspension adjust input event is detected, the damping characteristics for right front adjustable shock absorber 140 is set based on the damping value provided in driver actuatable suspension adjust input table 212 of shock damping logic 150, as represented by block 412 and processing sequence 400 is completed, as represented by block 406.

If a driver actuatable suspension adjust input event is not detected, shock damping logic 150 determines if a braking event is detected, as represented by block 414. An exemplary process 650 for detecting a braking event is illustrated in FIG. 14. If a braking event is detected, shock damping logic 150 determines if an anti-dive time threshold has elapsed, as represented by block 416. If the anti-time threshold has not elapsed, the damping characteristics for right front adjustable shock absorber 140 is set based on the damping value provided in anti-dive table 216 of shock damping logic 150, as represented by block 418 and processing sequence 400 is completed, as represented by block 406.

If the anti-dive time threshold has elapsed, the damping characteristics for right front adjustable shock absorber 140 is set based on the damping value provided in brake event table 214 of shock damping logic 150 based on a value of vehicle deceleration from IMU 132. Shock damping logic 150 next determines if a cornering event is detected, as represented by block 422. If a cornering event is not detected processing sequence 400 is completed, as represented by block 406. If a cornering event is detected, shock damping logic 150 determines if the vehicle acceleration is to the right side of snowmobile 10, as represented by block 424. If the vehicle acceleration is to the right, right front adjustable shock absorber 140 is designated the outside shock, as represented by block 426, and the damping characteristics for right front adjustable shock absorber 140 is set based on the damping value provided in brake corner event table 220 for the outside shock, as represented by block 428, and processing sequence 400 is completed, as represented by block 406. If the vehicle acceleration is not to the left, right front adjustable shock absorber 140 is designated the inside shock, as represented by block 430, and the damping characteristics for right front adjustable shock absorber 140 is set based on the damping value provided in brake corner event table for the inside shock, as represented by block 428, and processing sequence 400 is completed, as represented by block 406.

If a braking event is not detected, shock damping logic 150 determines if a one ski event is detected, as represented by block 440. An exemplary process 1000 for detecting a one ski event is illustrated in FIG. 20. If a one ski event is detected, shock damping logic 150 determines the damping characteristics for right front adjustable shock absorber 140 is set based on the damping value provided in one ski event table 218 of shock damping logic 150, as represented by block 442 and processing sequence 400 is completed, as represented by block 406.

If a one ski event is not detected, shock damping logic 150 determines if a G-out event is detected, as represented by block 450. An exemplary process 600 for detecting a G-out event is illustrated in FIG. 13. If a G-out event is detected, shock damping logic 150 determines the damping characteristics for right front adjustable shock absorber 140 is set based on the damping value provided in G-out event table 224 of shock damping logic 150, as represented by block 452 and processing sequence 400 is completed, as represented by block 406.

If a G-out event is not detected, shock damping logic 150 determines if a chatter event is detected, as represented by block 454. An exemplary process 600 for detecting a chatter event is illustrated in FIG. 13. If a chatter event is detected, shock damping logic 150 determines the damping characteristics for right front adjustable shock absorber 140 is set based on the damping value provided in chatter event table 226 of shock damping logic 150, as represented by block 456. shock damping logic 150 then determines if a cornering event is detected, as represented by block 458. If a cornering event is not detected, processing sequence 400 is completed, as represented by block 406. If a cornering event is detected, shock damping logic 150 determines if the vehicle acceleration is to the right side of snowmobile 10, as represented by block 464. If the vehicle acceleration is to the right, right front adjustable shock absorber 140 is designated the outside shock, as represented by block 466, and the damping characteristics for right front adjustable shock absorber 140 is set based on the damping value provided in chatter corner event table 222 for the outside shock, as represented by block 468, and processing sequence 400 is completed, as represented by block 406. If the vehicle acceleration is not to the left, right front adjustable shock absorber 140 is designated the inside shock, as represented by block 470, and the damping characteristics for right front adjustable shock absorber 140 is set based on the damping value provided in chatter corner event table 222 for the inside shock, as represented by block 468, and processing sequence 400 is completed, as represented by block 406.

If a chatter event is not detected, shock damping logic 150 determines if a cornering event is detected, as represented by block 476. An exemplary process 800 for detecting a cornering event is illustrated in FIGS. 17A-D. If a cornering event is detected, shock damping logic 150 determines if the vehicle acceleration is to the right side of snowmobile 10, as represented by block 478. If the vehicle acceleration is to the right, right front adjustable shock absorber 140 is designated the outside shock, as represented by block 480, and the damping characteristics for right front adjustable shock absorber 140 is set based on the damping value provided in the corner event table 228 for the outside shock, as represented by block 482, and processing sequence 400 is completed, as represented by block 406. If the vehicle acceleration is not to the left, right front adjustable shock absorber 140 is designated the inside shock, as represented by block 484, and the damping characteristics for right front adjustable shock absorber 140 is set based on the damping value provided in the corner event table 228 for the inside shock, as represented by block 482, and processing sequence 400 is completed, as represented by block 406. In embodiments, shock damping logic 150 also monitors vehicle acceleration/deceleration along axis 160 and this acceleration/deceleration value is a further input to corner event table. By taking into account the vehicle acceleration/deceleration along axis 160, shock damping logic 150 is able to adjust the damping characteristics for right front adjustable shock absorber 140 differently for when snowmobile 10 is entering a corner (deceleration) and when snowmobile 10 is exiting a corner (acceleration).

If a cornering event is not detected, shock damping logic 150 determines a damping characteristic for right front adjustable shock absorber 140 based on the damping value provided in the base damping table 230, as represented by block 490 and processing sequence 400 is completed, as represented by block 406.

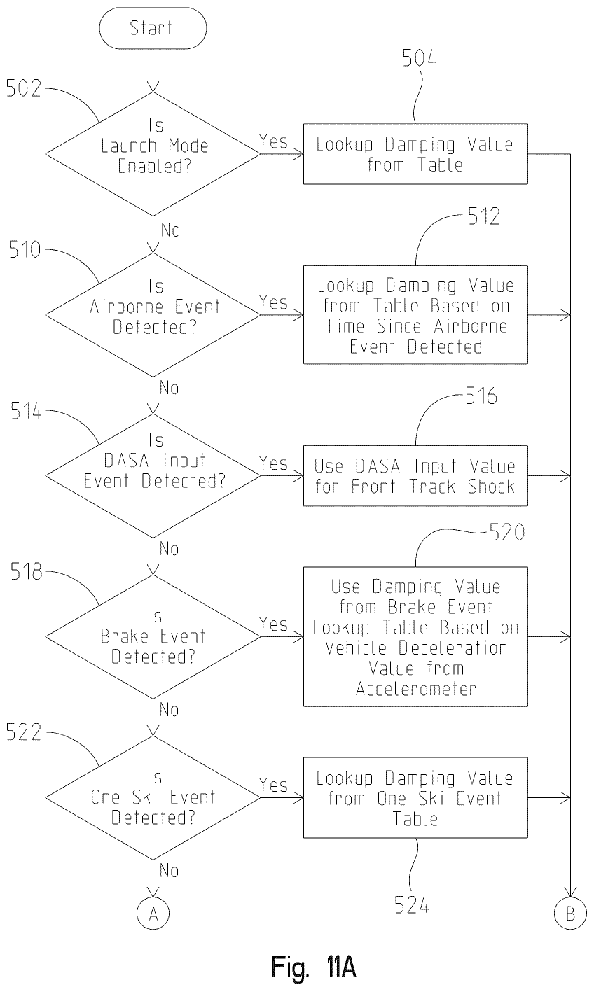

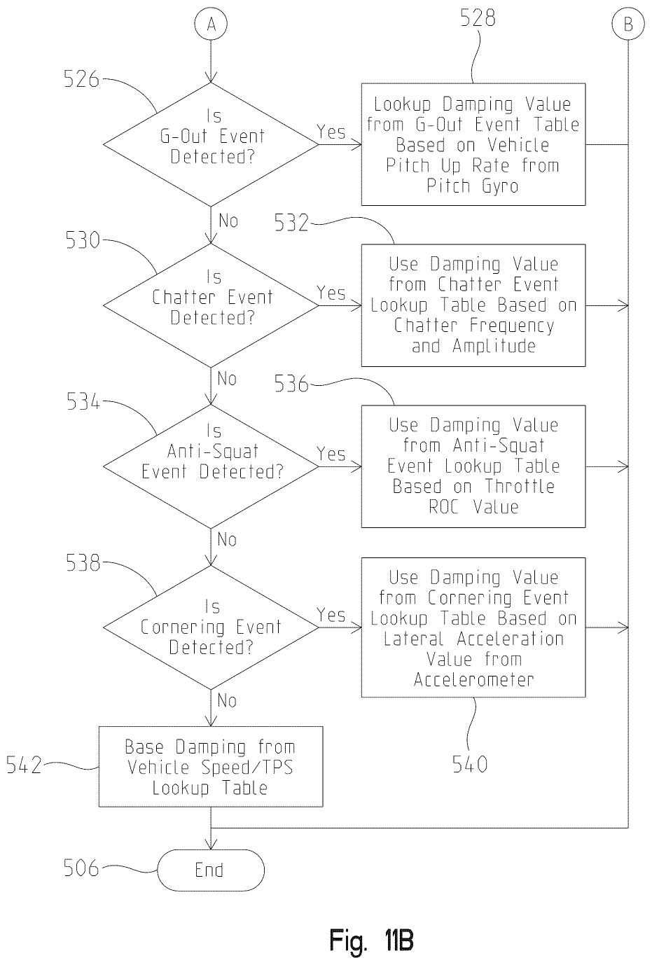

Referring to FIGS. 11A and 11B an exemplary processing sequence 500 of the shock damping logic 150 of the electronic controller 200 of FIG. 6 for first track continuous damping control shock absorber 144 provided as part of the suspension 26 of the exemplary snowmobile 10 of FIG. 1.

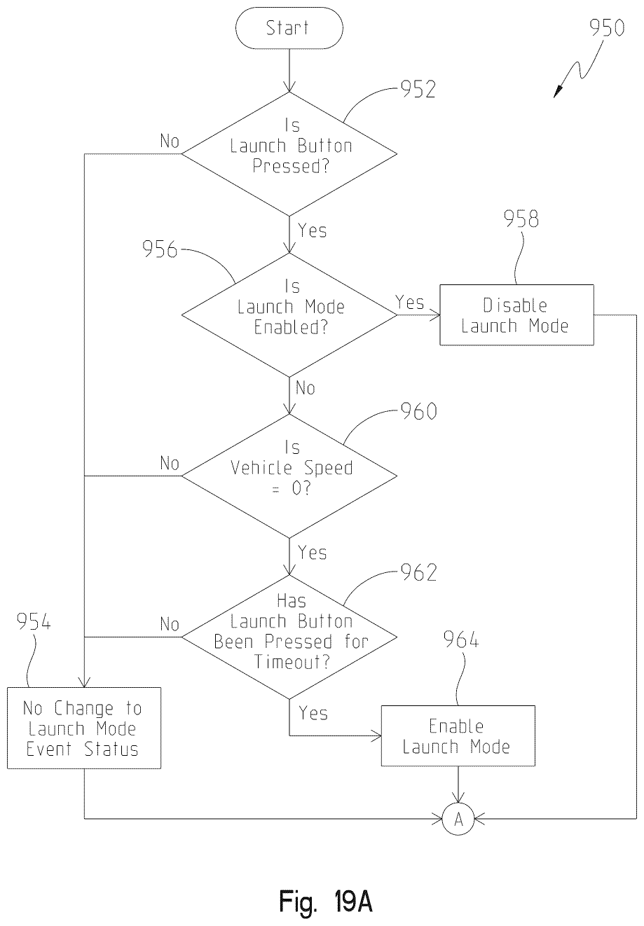

Shock damping logic 150 determines if a launch mode has been enabled, as represented by block 502. An exemplary processing sequence 950 for determining if a launch mode has been enabled is provided in FIGS. 19A and 19B. If a launch mode has been enabled, shock damping logic 150 determines a damping characteristic for first track continuous damping control shock absorber 144 based on the damping value provided in the launch mode event table 232, as represented by block 504 and processing sequence 500 is completed, as represented by block 506.

If a launch mode is not detected, shock damping logic 150 determines if an airborne event is detected, as represented by block 510. If an airborne event is detected, shock damping logic 150 determines a damping characteristic for first track continuous damping control shock absorber 144 based on the damping value provided in the airborne event table 210, as represented by block 512 and processing sequence 500 is completed, as represented by block 506.

If an airborne event is not detected, shock damping logic 150 determines if a driver actuatable suspension adjust input event is detected, as represented by block 514. If a driver actuatable suspension adjust input event is detected, shock damping logic 150 determines a damping characteristic for first track continuous damping control shock absorber 144 based on the damping value provided in the driver actuatable suspension adjust input event table 212, as represented by block 516 and processing sequence 500 is completed, as represented by block 506.

If a driver actuatable suspension adjust input event is not detected, shock damping logic 150 determines if a brake event is detected, as represented by block 518. If a brake event is detected, shock damping logic 150 determines a damping characteristic for first track continuous damping control shock absorber 144 based on the damping value provided in the brake event table 214, as represented by block 520 and processing sequence 500 is completed, as represented by block 506.

If a brake event is not detected, shock damping logic 150 determines if a one ski event is detected, as represented by block 522. If a one ski event is detected, shock damping logic 150 determines a damping characteristic for first track continuous damping control shock absorber 144 based on the damping value provided in the one ski event table 218, as represented by block 524 and processing sequence 500 is completed, as represented by block 506.

If a one ski event is not detected, shock damping logic 150 determines if a g-out event is detected, as represented by block 526. If a g-out event is detected, shock damping logic 150 determines a damping characteristic for first track continuous damping control shock absorber 144 based on the damping value provided in the g-out event table 224, as represented by block 528 and processing sequence 500 is completed, as represented by block 506.

If a G-out event is not detected, shock damping logic 150 determines if a chatter event is detected, as represented by block 530. If a chatter event is detected, shock damping logic 150 determines a damping characteristic for first track continuous damping control shock absorber 144 based on the damping value provided in the chatter event table 226, as represented by block 532 and processing sequence 500 is completed, as represented by block 506.

If a chatter event is not detected, shock damping logic 150 determines if an anti-squat event is detected, as represented by block 534. If an anti-squat event is detected, shock damping logic 150 determines a damping characteristic for first track continuous damping control shock absorber 144 based on the damping value provided in the anti-squat event table 234, as represented by block 536 and processing sequence 500 is completed, as represented by block 506.

If an anti-squat event is not detected, shock damping logic 150 determines if a cornering event is detected, as represented by block 538. If a cornering event is detected, shock damping logic 150 determines a damping characteristic for first track continuous damping control shock absorber 144 based on the damping value provided in the cornering event table 228, as represented by block 540 and processing sequence 500 is completed, as represented by block 506. In embodiments, shock damping logic 150 also monitors vehicle acceleration/deceleration along axis 160 and this acceleration/deceleration value is a further input to corner event table. By taking into account the vehicle acceleration/deceleration along axis 160, shock damping logic 150 is able to adjust the damping characteristics for front track adjustable shock absorber 144 differently for when snowmobile 10 is entering a corner (deceleration) and when snowmobile 10 is exiting a corner (acceleration).

If a cornering event is not detected, shock damping logic 150 determines a damping characteristic for first track continuous damping control shock absorber 144 based on the damping value provided in the base damping table 230, as represented by block 542 and processing sequence 500 is completed, as represented by block 506.

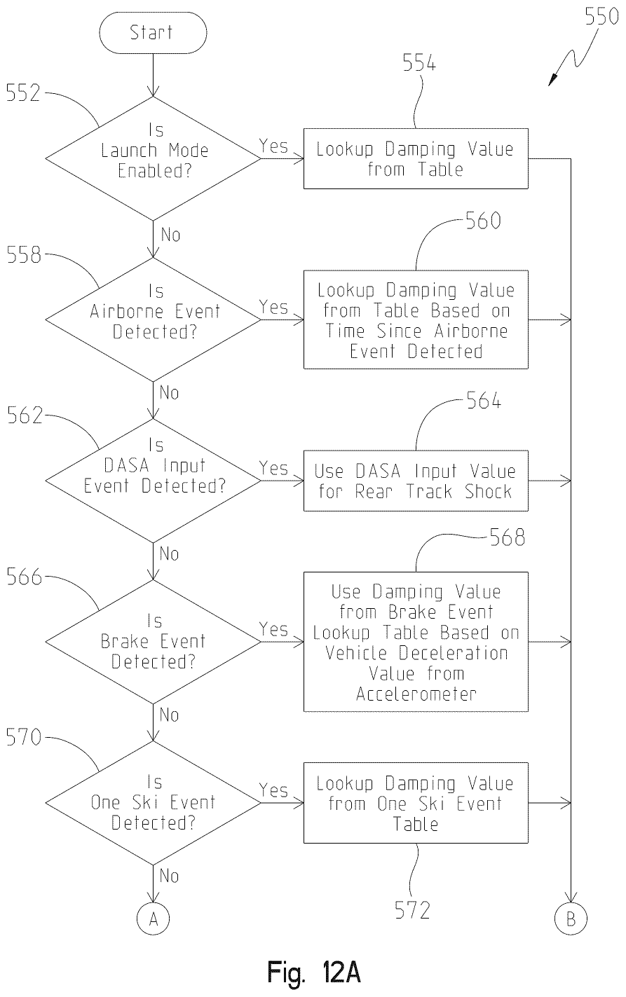

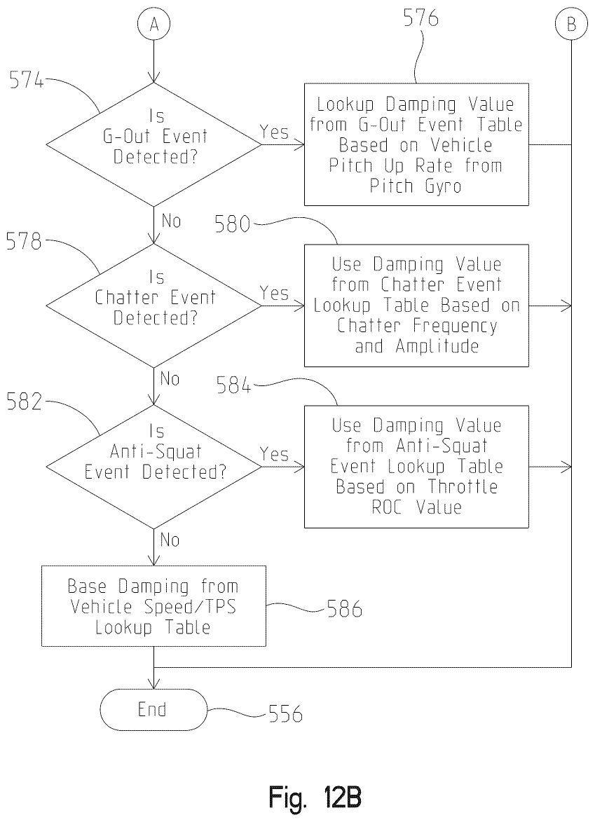

Referring to FIGS. 12A and 12B an exemplary processing sequence 550 of the shock damping logic 150 of the electronic controller 200 of FIG. 6 for second track continuous damping control shock absorber 146 provided as part of the suspension 26 of the exemplary snowmobile 10 of FIG. 1.

Shock damping logic 150 determines if a launch mode has been enabled, as represented by block 552. An exemplary processing sequence for determining if a launch mode has been enabled is provided in FIGS. 19A and 19B. If a launch mode has been enabled, shock damping logic 150 determines a damping characteristic for second track continuous damping control shock absorber 146 based on the damping value provided in the launch mode event table 232, as represented by block 554 and processing sequence 550 is completed, as represented by block 556.

If a launch mode is not detected, shock damping logic 150 determines if an airborne event is detected, as represented by block 558. If an airborne event is detected, shock damping logic 150 determines a damping characteristic for second track continuous damping control shock absorber 146 based on the damping value provided in the airborne event table 210, as represented by block 560 and processing sequence 550 is completed, as represented by block 556.

If an airborne event is not detected, shock damping logic 150 determines if a driver actuatable suspension adjust input event is detected, as represented by block 562. If a driver actuatable suspension adjust input event is detected, shock damping logic 150 determines a damping characteristic for second track continuous damping control shock absorber 146 based on the damping value provided in the driver actuatable suspension adjust input event table 212, as represented by block 564 and processing sequence 550 is completed, as represented by block 556.

If a driver actuatable suspension adjust input event is not detected, shock damping logic 150 determines if a brake event is detected, as represented by block 566. If a brake event is detected, shock damping logic 150 determines a damping characteristic for second track continuous damping control shock absorber 146 based on the damping value provided in the brake event table 214, as represented by block 568 and processing sequence 550 is completed, as represented by block 556.

If a brake event is not detected, shock damping logic 150 determines if a one ski event is detected, as represented by block 570. If a one ski event is detected, shock damping logic 150 determines a damping characteristic for second track continuous damping control shock absorber 146 based on the damping value provided in the one ski event table 218, as represented by block 572 and processing sequence 550 is completed, as represented by block 556.

If a one ski event is not detected, shock damping logic 150 determines if a g-out event is detected, as represented by block 574. If a g-out event is detected, shock damping logic 150 determines a damping characteristic for second track continuous damping control shock absorber 146 based on the damping value provided in the g-out event table 224, as represented by block 576 and processing sequence 550 is completed, as represented by block 556.

If a g-out event is not detected, shock damping logic 150 determines if a chatter event is detected, as represented by block 578. If a chatter event is detected, shock damping logic 150 determines a damping characteristic for second track continuous damping control shock absorber 146 based on the damping value provided in the chatter event table 226, as represented by block 580 and processing sequence 550 is completed, as represented by block 556.

If a chatter event is not detected, shock damping logic 150 determines if an anti-squat event is detected, as represented by block 582. If an anti-squat event is detected, shock damping logic 150 determines a damping characteristic for second track continuous damping control shock absorber 146 based on the damping value provided in the anti-squat event table 234, as represented by block 584 and processing sequence 550 is completed, as represented by block 556.

If an anti-squat event is not detected, shock damping logic 150 determines a damping characteristic for second track continuous damping control shock absorber 146 based on the damping value provided in the base damping table 230, as represented by block 586 and processing sequence 550 is completed, as represented by block 556.

Referring to FIG. 13, an exemplary processing sequence 600 of the shock damping logic 150 of the electronic controller 200 of FIG. 6 for detecting a g-out event or a chatter event is illustrated. suspension controller 200 samples from IMU 132 a pitch of snowmobile 10 about axis 162 over a window of time, as represented by block 602. The sampled values are input to a discrete Fourier transform (“DFT”), as represented by block 604, to provide a frequency map of the changes in pitch of snowmobile 10.

The magnitude of the low frequency values, such as from 0 Hz to 3 Hz, are compared a low frequency threshold, as represented by block 606. If the magnitude of the low frequency values do not satisfy the low frequency threshold, then no event is detected and the low frequency portion of processing sequence 600 ends, as represented by blocks 614 and 612. If the magnitude of the low frequency values satisfy the low frequency threshold, then processing sequence 600 compares a pitch up rate from a gyroscope input from the IMU 132 to another threshold, as represented by block 608. If the pitch-up rate does not satisfy the threshold, then no event is detected and the low frequency portion of processing sequence 600 ends, as represented by blocks 614 and 612. If the pitch-up rate satisfies the threshold, then a g-out event is detected, as represented by block 610. The detection of a g-out event as explained herein results in the damping characteristics for one or more of right front adjustable shock absorber 140, left front adjustable shock absorber 142, front track adjustable shock absorber 144, and rear track adjustable shock absorber 146 being selected based on g-out event table 224. In general, the damping characteristics are increased stiffness of right front adjustable shock absorber 140, left front adjustable shock absorber 142, and rear track adjustable shock absorber 146.

The magnitude of the high frequency values, such as from 3 Hz to 10 Hz, are compared a high frequency threshold, as represented by block 616. If the magnitude of the high frequency values does not satisfy the high frequency threshold, then no event is detected and the high frequency portion of processing sequence 600 ends, as represented by blocks 614 and 612. If the magnitude of the high frequency values satisfies the high frequency threshold, then a chatter event is detected, as represented by block 618. The detection of a chatter event as explained herein results in the damping characteristics for one or more of right front adjustable shock absorber 140, left front adjustable shock absorber 142, front track adjustable shock absorber 144, and rear track adjustable shock absorber 146 being selected based on chatter event table 226.

Referring to FIG. 14, an exemplary processing sequence 650 of the shock damping logic 150 of the electronic controller 200 of FIG. 6 for detecting an exemplary brake event is illustrated. shock damping logic 150 determines if a brake switch is activated, as represented by block 652. In embodiments, a switch is closed when a brake input is actuated. If the brake switch is not activated, no brake event is detected, as represented by block 654, and processing sequence 650 is completed. If the brake switch is activated, a brake event is detected, as represented by block 656, and processing sequence 650 is completed.

FIG. 15 illustrates an exemplary processing sequence 700 of the shock damping logic 150 of the electronic controller 200 of FIG. 6 for detecting an exemplary airborne event. shock damping logic 150 if an acceleration of snowmobile 10 along axis 164 detected by IMU 132 is below a threshold value, as represented by block 702. If the detected acceleration is below the threshold value, an airborne event is detected, as represented by block 704 and processing sequence 700 is completed. If the detected acceleration is greater than the threshold, then shock damping logic 150 checks to see if the current status of snowmobile 10 is that an airborne event is active for snowmobile 10 meaning that snowmobile 10 was recently determined to be in and is still in an airborne event, as represented by block 708. If an airborne event is not active, no change is made meaning snowmobile 10 is not found to now be in an airborne event, as represented by block 710, and processing sequence 700 is completed. If an airborne event is active, shock damping logic 150 determines if the detected vertical acceleration exceeds the threshold value plus a hysteresis value of IMU 132, as represented by block 712. If not, no change is made meaning snowmobile 10 remains in an airborne event, as represented by block 710, and processing sequence 700 is completed, as represented by block 706. If the detected vertical acceleration does exceed the threshold value plus the hysteresis value of IMU 132, shock damping logic 150 determines if the elapsed time from the determination that snowmobile 10 is in an airborne event exceeds a timeout value, as represented by block 714. If the elapsed time does not exceed the timeout value, no change is made meaning snowmobile 10 remains in an airborne event, as represented by block 710, and processing sequence 700 is completed, as represented by block 706. If the elapsed time does exceed the timeout value, the status of snowmobile 10 is changed to airborne event not detected, as represented by block 716, and processing sequence 700 is completed, as represented by block 706.

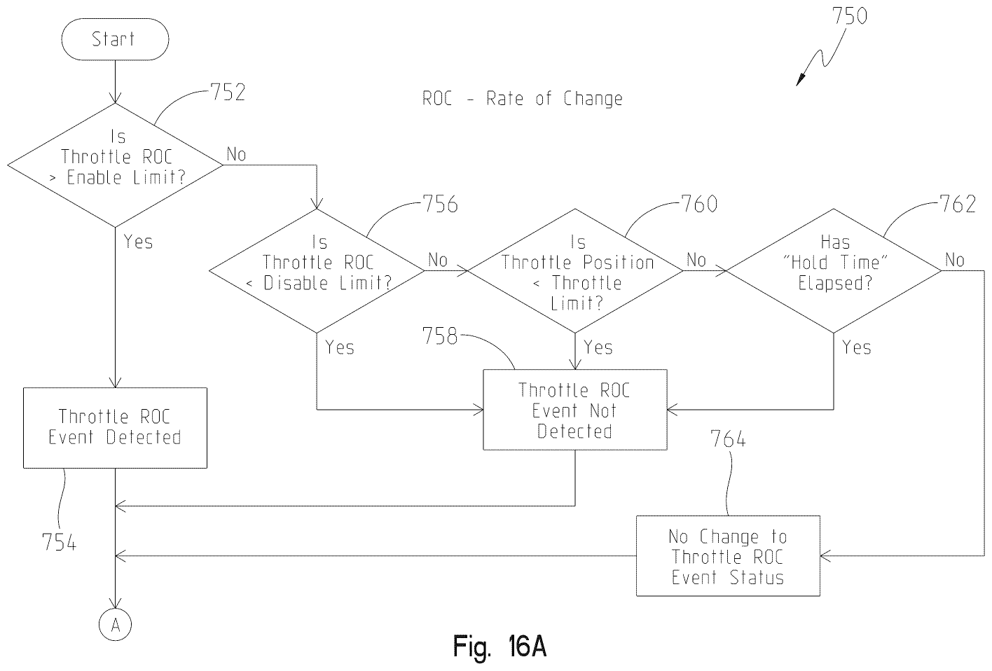

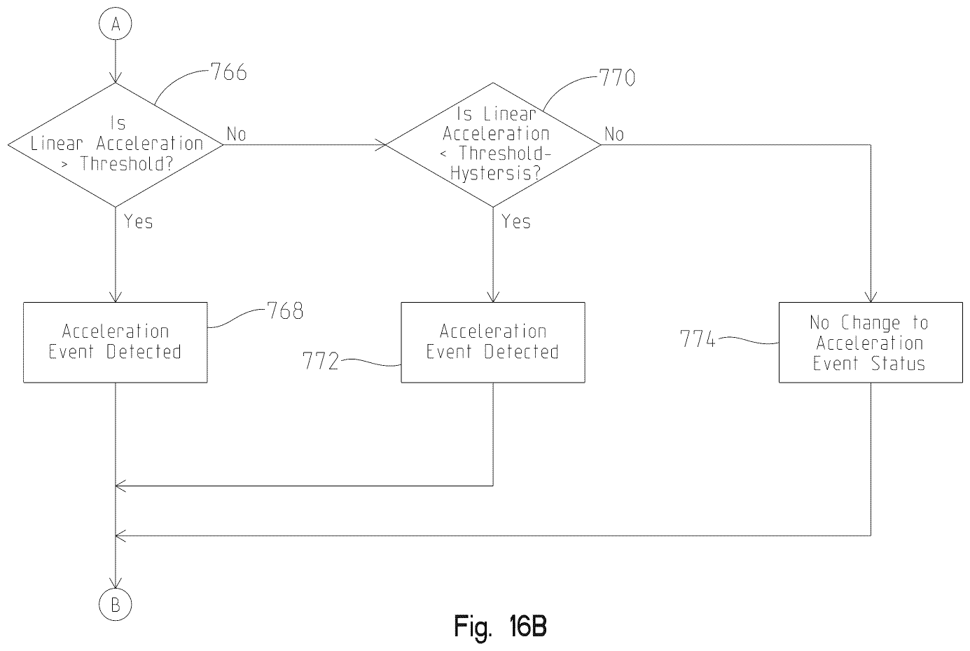

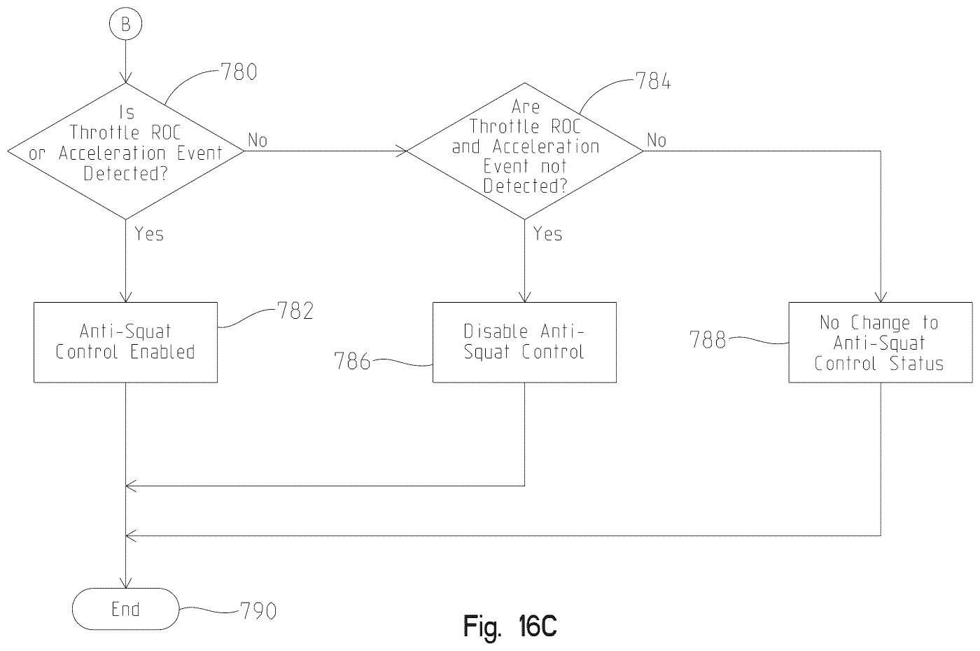

FIGS. 16A-C illustrates an exemplary processing sequence 750 of the shock damping logic 150 of the electronic controller 200 of FIG. 6 for detecting an exemplary anti-squat event. shock damping logic 150 determines if a rate of change of the throttle input detected by throttle position sensor 138 exceeds an enable limit, as represented by block 752. If so, then shock damping logic 150 determines that a throttle rate of change event is detected, as represented by block 754. If not, shock damping logic 150 determines if a rate of change of the throttle input is less than a disable limit, as represented by block 756. If the rate of change of the throttle input is less than the disable limit, shock damping logic 150 determines that a throttle rate of change event is not detected, as represented by block 758. If the rate of change of the throttle input is not less than the disable limit, shock damping logic 150 determines if the detected throttle position is less than a throttle limit meaning that the operator has backed off on the throttle, as represented by block 760. If the detected throttle position is less than the throttle limit, shock damping logic 150 determines that a throttle rate of change event is not detected, as represented by block 758. If the detected throttle position is greater than the throttle limit, shock damping logic 150 determines if the elapsed time since a throttle rate of change event was detected exceeds a hold time threshold, as represented by block 762. If the elapsed time since the throttle rate of change event was detected does not exceed the hold time threshold, no change is made to whether a throttle rate of change event is active or not, as represented by block 764. If the elapsed time since the throttle rate of change event was detected does exceed the hold time threshold, shock damping logic 150 determines that a throttle rate of change event is not detected, as represented by block 758.

Turning to FIG. 16B, shock damping logic 150 next determines if a linear acceleration of snowmobile 10 along axis 160 exceeds a threshold, as represented by block 766. If the linear acceleration of snowmobile 10 along axis 160 exceeds the threshold, then an acceleration event is detected, as represented by block 768. If the linear acceleration of snowmobile 10 along axis 160 does not exceed the threshold, shock damping logic 150 determines if the linear acceleration of snowmobile 10 is less than the threshold minus a hysteresis of IMU 132, as represented by block 770. If so, an acceleration event is not detected, as represented by block 772. If not, no change is made to the current status of whether an acceleration event is active or not for snowmobile 10, as represented by block 774.

Turning to FIG. 16C, shock damping logic 150 determines if one of a throttle rate of change event or an acceleration event is active for snowmobile 10, as represented by block 780. If either is active, an anti-squat event is determined, as represented by block 782, and processing sequence 750 is completed, as represented by block 790. If not, then shock damping logic 150 checks to verify both the throttle rate of change event and the acceleration event are not active, as represented by block 784. If both are inactive, shock damping logic 150 disables an anti-squat event, as represented by block 786, and processing sequence 750 is completed, as represented by block 790. If one of the throttle rate of change event and the acceleration event are active, no change is made to the anti-squat status of snowmobile 10, as represented by block 788, and processing sequence 750 is completed, as represented by block 790.

FIGS. 17A-D illustrates an exemplary processing sequence 800 of the shock damping logic 150 of the electronic controller 200 of FIG. 6 for detecting an exemplary cornering event. shock damping logic 150 determines if an absolute value of a detected steering angle detected by steering angle sensor 136 exceeds a threshold (a zero steering angle corresponds with the skis pointing directly forward along axis 160), as represented by block 802. If the absolute value of the detected steering angle detected by steering angle sensor 136 exceeds the threshold, a steering event is detected, as represented by block 804. If not, the absolute value of the detected steering angle detected by steering angle sensor 136 is compared to the threshold minus a hysteresis value of the steering angle sensor 136, as represented by block 806. If the absolute value of the detected steering angle detected by steering angle sensor 136 is less than the threshold minus the hysteresis value of the steering angle sensor 136, shock damping logic 150 determines that a steering event is not detected, as represented by block 808. If the absolute value of the detected steering angle detected by steering angle sensor 136 is not less than the threshold minus the hysteresis value of the steering angle sensor 136, shock damping logic 150 makes no change to the steering event status of snowmobile 10, as represented by block 810.

Turning to FIG. 17B, shock damping logic 150 determines if a lateral acceleration of snowmobile 10 along axis 162 exceeds a threshold value, as represented by block 812. If the lateral acceleration of snowmobile 10 along axis 162 exceeds the threshold value, then a corner event is detected, as represented by block 814. If not, the absolute value of the detected lateral acceleration of snowmobile 10 is compared to the threshold minus a hysteresis value of IMU 132, as represented by block 816. If the absolute value of the detected lateral acceleration of snowmobile 10 is less than the threshold minus the hysteresis value of IMU 132, shock damping logic 150 determines that a cornering event is not detected, as represented by block 818. If the absolute value of the detected lateral acceleration of snowmobile 10 is not less than the threshold minus the hysteresis value of IMU 132, shock damping logic 150 makes no change to the corner event status of snowmobile 10, as represented by block 820.

Turning to FIG. 17C, shock damping logic 150 determines if an absolute value of yaw rate and/or angle about axis 164 exceeds a threshold value, as represented by block 830. If the absolute value of yaw rate and/or angle about axis 164 exceeds the threshold value, then a yaw event is detected, as represented by block 832. If not, the absolute value of yaw rate and/or angle about axis 164 is compared to the threshold minus a hysteresis value of IMU 132, as represented by block 834. If the absolute value of the absolute value of yaw rate and/or angle about axis 164 is not less than the threshold minus the hysteresis value of IMU 132, shock damping logic 150 makes no change to the yaw status of snowmobile 10, as represented by block 836. If the absolute value of absolute value of yaw rate and/or angle about axis 164 is less than the threshold minus the hysteresis value of IMU 132, shock damping logic 150 determines if a cornering event timeout time has elapsed, as represented by block 838. If the cornering timeout time has not elapsed, shock damping logic 150 makes no change to the yaw status of snowmobile 10, as represented by block 836. If the cornering timeout time has elapsed, then a yaw event is detected, as represented by block 840.

Turning to FIG. 17D, shock damping logic 150 determines if a yaw event or a steering event was detected in processing sequence 800, as represented by block 850. If one of the yaw event and steering event was detected then a cornering event is detected and the cornering timeout timer is set to zero, as represented by block 852, and processing sequence 800 is completed, as represented by block 854. If one of the yaw event and steering event was not detected then shock damping logic 150 determines if both the yaw event and steering event not detected, as represented by block 856. If not, then there is no change to the cornering event status as represented by block 858, and processing sequence 800 exits, as represented by block 854. If so, then shock damping logic 150 determines a cornering event is not detected as represented by block 860, and processing sequence 800 exits, as represented by block 854.

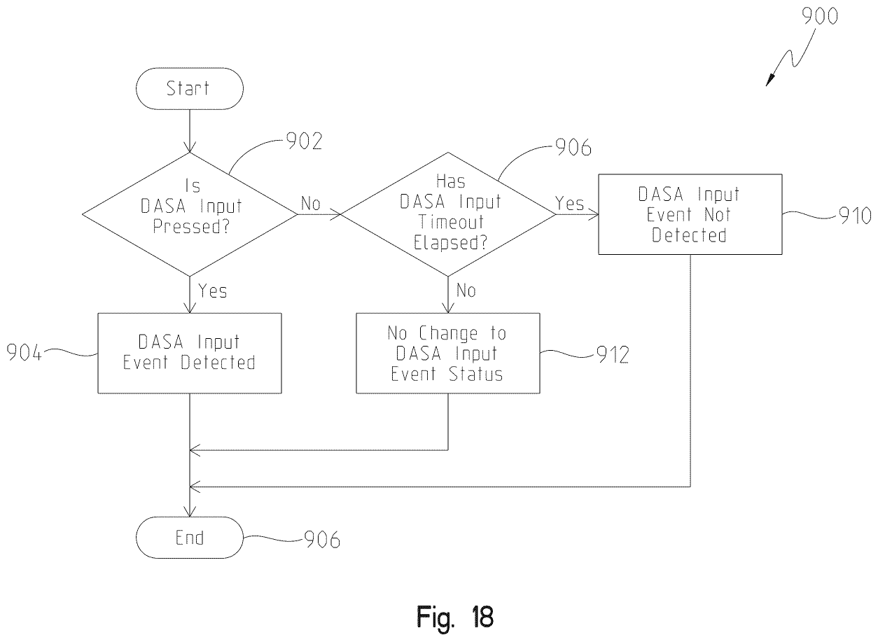

FIG. 18 illustrates an exemplary processing sequence 900 of the shock damping logic 150 of the electronic controller 200 of FIG. 6 for detecting an exemplary driver actuatable suspension adjust input event. shock damping logic 150 monitors whether driver actuatable suspension adjust input 172 has been actuated, as represented by block 902. If driver actuatable suspension adjust input 172 has been actuated, a driver actuatable suspension adjust input event is detected, as represented by block 904 and processing sequence 900 is completed. If driver actuatable suspension adjust input 172 has not been actuated, shock damping logic 150 checks to see of a driver actuatable suspension adjust input timeout counter is active and, if so, has it elapsed, as represented by block 908. If the driver actuatable suspension adjust input timeout has elapsed, shock damping logic 150 determines that a driver actuatable suspension adjust input event has not been detected, as represented by block 910 and processing sequence 900 is complete. If the driver actuatable suspension adjust input timeout has not elapsed, shock damping logic 150 keeps the current state of the driver actuatable suspension adjust input event status, as represented by block 912, and processing sequence 900 is complete.

FIGS. 19A and 19B illustrate an exemplary processing sequence 950 of the shock damping logic 150 of the electronic controller 200 of FIG. 6 for detecting an exemplary launch mode event. Referring to FIG. 19A, shock damping logic 150 monitors to determine if a launch mode input 174 has been actuated, as represented by block 952. If launch mode input 174 has not been actuated then no change is made to the launch mode event status, as represented by block 954. If launch mode input 174 has been actuated, shock damping logic 150 determines if a launch mode is currently active, as represented by block 956. If a launch mode is currently active, then the actuation of launch mode input 174 causes the launch mode to be disabled, as represented by block 958. If a launch mode is not currently enabled, shock damping logic 150 based on vehicle speed sensor 139 determines if the speed of snowmobile 10 is zero, as represented by block 960. If the vehicle speed is not zero, no change is made to the launch mode status, as represented by block 954. If the vehicle speed is zero, shock damping logic 150 determines if the launch button 174 has been actuated for timeout, as represented by block 962. If not, no change is made to the launch mode status, as represented by block 954. If so, shock damping logic 150 enables the launch mode, as represented by block 964.

Referring to FIG. 19B, shock damping logic 150 determines if the launch mode is enabled, as represented by block 966. If not, no change is made to the launch mode status, as represented by block 968. If the launch mode is enabled, shock damping logic 150 determines based on vehicle speed sensor 139 if the vehicle speed is above a threshold, as represented by block 970. If not, no change is made to the launch mode status, as represented by block 968. If the vehicle speed is above the threshold then shock damping logic 150 determines if the linear acceleration of snowmobile 10 along axis 160 is less than a threshold, as represented by block 972. If not, no change is made to the launch mode status, as represented by block 968. If the linear acceleration of snowmobile 10 along axis 160 is less than the threshold, shock damping logic 150 disables the launch mode because snowmobile 10 is traveling closer to a constant speed than quickly accelerating, as represented by block 974.

FIG. 20 illustrates an exemplary processing sequence 1000 of the shock damping logic 150 of the electronic controller 200 of FIG. 6 for detecting an exemplary one ski event. shock damping logic 150 based on IMU 132 monitors if a roll rate and/or angle of snowmobile 10 about axis 160 is greater than a low threshold, as represented by block 1002. If so, shock damping logic 150 then checks to see if the monitored roll rate and/or angle is less than a high roll rate and/or angle threshold, as represented by block 1004. If the vehicle roll rate and/or angle is in the range between the low threshold and the high threshold, a one ski event is detected, as represented by block 1006, and processing sequence 1000 is completed, as represented by block 1008. Returning back to block 1002, if the vehicle roll rate and/or angle is not greater than the low threshold, shock damping logic 150 determines if the vehicle roll rate and/or angle is less than the low threshold minus the hysteresis of the IMU 132, as represented by block 1010. If not, no change is made by shock damping logic 150 to the one ski event status, as represented by block 1014. If so, shock damping logic 150 determines that a one ski event is not detected, as represented by block 1012 and processing sequence 1000 is completed, as represented by block 1008. Returning to block 1004, if the vehicle roll rate and/or angle is not less than the high threshold, shock damping logic 150 determines that a one ski event is not detected, as represented by block 1012 and processing sequence 1000 is completed, as represented by block 1008.

In embodiments, power is provided to front track adjustable shock absorber 144 and/or rear track adjustable shock absorber 146 through a wired connection routed through the suspension components or entering an interior of the track from a lateral side. In embodiments, communication signals are provided to and/or sent by front track adjustable shock absorber 144 and/or rear track adjustable shock absorber 146 through a wired connection routed through the suspension components or entering an interior of the track from a lateral side. In embodiments, both communication signals and power are provided to/from front track adjustable shock absorber 144 and/or rear track adjustable shock absorber 146 through a wired connection routed through the suspension components or entering an interior of the track from a lateral side. In embodiments, at least one of front track adjustable shock absorber 144 and rear track adjustable shock absorber 146 include a power source and/or receive/transmit communication signals to controller 100 wirelessly.

In embodiments, snowmobile 10 includes a demo mode to illustrate the functionality of right front adjustable shock absorber 140, left front adjustable shock absorber 142, front track adjustable shock absorber 144, and rear track adjustable shock absorber 146. In one embodiment, snowmobile 10 includes a battery and an operator input is provided to activate accessory power on snowmobile 10. In this example, an operator is able to select different operating modes (comfort, handling, rough trail) and/or input adjustments to right front adjustable shock absorber 140, left front adjustable shock absorber 142, front track adjustable shock absorber 144, and rear track adjustable shock absorber 146. In one example, an operator can select a left turn option and experience the change in the damping characteristics for right front adjustable shock absorber 140, left front adjustable shock absorber 142, front track adjustable shock absorber 144, and rear track adjustable shock absorber 146 for a left turn. In another embodiment, snowmobile 10 does not include a battery. In this example, a power connection is provided on snowmobile 10 which allows for an external power source to be plugged into snowmobile 10 to power snowmobile 10 to operate in the demo mode.

In embodiments, during operation of vehicle 10 or 10′, the damping characteristics of at least one of front track adjustable shock absorber 144 and rear track adjustable shock absorber 146 may be further adjusted to alter handling. In examples, the base damping profile for a given mode (such as comfort or sport), predicted acceleration damping profile (longitudinal or lateral), braking damping profile, and cornering damping profile include adjustments to damping characteristics of at least one of front track adjustable shock absorber 144 and rear track adjustable shock absorber 146.

During normal straight line driving (no appreciable cornering or change in acceleration), the base damping characteristics of front track adjustable shock absorber 144 may be different from rear track adjustable shock absorber 146 or the same as rear track adjustable shock absorber 146. Changes in driving, such as cornering or changes in acceleration may result in adjustments to the base damping profile.

For example, in the comfort mode, during normal straight line driving, front track adjustable shock absorber 144 has a first setup relative to rear track adjustable shock absorber 146 in compression damping (stiffer or the same). This setup biases snowmobile 10 balance to have less ski pressure on the ground for skis 16 and generally less positive tracking of skis 16. The compression damping of front track adjustable shock absorber 144 is still soft enough to not sacrifice ride comfort. When snowmobile 10 brakes, decelerates or corners or is predicted to do so; the compression damping of front track adjustable shock absorber 144 is increased relative to its previous state. This adjustment prevents weight transfer to skis 16 and makes the turning effort of snowmobile 10 less with sacrificed traction on skis 16.

In another example, in sport mode, during normal driving, front track adjustable shock absorber 144 has a first setup relative to rear track adjustable shock absorber 146 in compression damping (softer or the same). This setup biases snowmobile 10 balance to have more ski pressure on the ground for skis 16 and generally more positive tracking of skis 16. When snowmobile 10 brakes, decelerates or corners or is predicted to do so; the compression damping of front track adjustable shock absorber 144 is decreased relative to its previous state. This adjustment adds weight transfer to skis 16 and creates increased traction on skis 16 at the sacrifice of increased steering effort.

In embodiments, electronic controller 100 monitors the outputs of IMU 132 (a three-axis accelerometer and a three-axis gyroscope) to evaluate terrain and/or driver aggressiveness. Driver aggressiveness may be monitored by the longitudinal acceleration and lateral acceleration experienced by vehicle 10. Further, throttle position, brake pressure, and steering angle, and steering velocity may provide indicators. Electronic controller 100 may monitor these factors and adjust the damping characteristics of one or more of right front adjustable shock absorber 140, left front adjustable shock absorber 142, front track adjustable shock absorber 144, and rear track adjustable shock absorber 146 based thereon. Terrain type may be monitored by longitudinal acceleration, lateral acceleration, vertical acceleration, and all three angular rates of IMU 132. In embodiments, the outputs are analyzed to determine the frequency response of each. The frequency responses may be determined through one or more bandpass filters, fast Fourier transform, or other methods. For example, the roll angular frequency response may be monitored with a bandpass filter for frequencies in a first range, such as 8-15 Hertz, to provide an indication of chatter. The monitored frequency response for one or more of the outputs are compared to stored ranges for different terrain types and the damping characteristics of one or more of right front adjustable shock absorber 140, left front adjustable shock absorber 142, front track adjustable shock absorber 144, and rear track adjustable shock absorber 146 are adjusted based thereon.

In embodiments, electronic controller 100 also monitors GPS sensor 131. A given location might indicate a first terrain type based on the frequency responses of the IMU 132 on a first day, such as fresh snow, and a second terrain type based on the frequency responses of the IMU 132 on a second day, such as hard snow. Based on those different terrain types and the historical data of the location, electronic controller may adjust the damping characteristics of one or more of right front adjustable shock absorber 140, left front adjustable shock absorber 142, front track adjustable shock absorber 144, and rear track adjustable shock absorber 146 to make the hard snow of the second day feel more like the fresh snow of the first day. This provides the ability for snowmobile 10 to have the same feel for the same location on different days even if the terrain characteristics have changed.

In embodiments, sensors 130 includes a sensor which monitors if rear suspension assembly 26 is in a coupled state or uncoupled state. An exemplary sensor is a position sensor, an angular sensor, a pressure sensor, or a contact sensor which monitors when the suspension arm contacts a coupling block of rear suspension assembly 26. In embodiments, the damping characteristics (compression and/or rebound) of front track adjustable shock absorber 144 and/or rear track adjustable shock absorber 146 are adjusted based on whether rear suspension assembly 26 is in a coupled state or uncoupled state.

While embodiments of the present disclosure have been described as having exemplary designs, the present invention may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this invention pertains.

1.-20. (canceled)

21.-177. (canceled)

178. A suspension system for a snowmobile with a track, comprising:
a front adjustable track shock operable according to a front adjustable track shock first damping characteristic;
a rear adjustable track shock operable according to a rear adjustable track shock first damping characteristic; and
an operator input operable to adjust an operating mode of the suspension system between a first configuration and a second configuration,
wherein in response to the operator input being actuated to the first configuration, the front adjustable track shock first damping characteristic is increased and the rear adjustable track shock first damping characteristic is decreased, and
wherein in response to the operator input being actuated to the second configuration, the front adjustable track shock first damping characteristic is decreased and the rear adjustable track shock first damping characteristic is increased.

179. The suspension system of claim 178, wherein each of the front adjustable track shock and the rear adjustable track shock include a solenoid valve operable to adjust the respective front adjustable track shock damping characteristic and the rear adjustable track shock damping characteristic.

180. The suspension system of claim 178, wherein each of the front adjustable track shock damping characteristic and the rear adjustable track shock damping characteristic are compression damping characteristics.

181. The suspension system of claim 178, wherein the front adjustable track shock first damping characteristic of the front adjustable track shock is a compression damping characteristic and the rear adjustable track shock first damping characteristic of the second adjustable track shock is a compression damping characteristic.

182. The suspension system of claim 181, wherein in the first configuration a front adjustable track shock second damping characteristic of the front adjustable track shock is decreased and a rear adjustable track shock second damping characteristic of the rear adjustable track shock is increased.

183. The suspension system of claim 182, wherein the front adjustable track shock second damping characteristic of the front adjustable track shock is a rebound damping characteristic and the rear adjustable track shock second damping characteristic of the rear adjustable track shock is a rebound damping characteristic.

184. The suspension system of claim 181, wherein in the second configuration a front adjustable track shock second damping characteristic of the front adjustable track shock is increased and a rear adjustable track shock second damping characteristic of the rear adjustable track shock is decreased.

185. The suspension system of claim 184, wherein the front adjustable track shock second damping characteristic of the front adjustable track shock is a rebound damping characteristic and the rear adjustable track shock second damping characteristic of the rear adjustable track shock is a rebound damping characteristic.

186. A snowmobile, comprising:
a plurality of ground engaging members comprising a front left ski, a front right ski, and
a track assembly;
a frame supported by the plurality of ground engaging members;
a seat supported by the frame; and
wherein the track assembly comprises the suspension system of claim 178.

187. The snowmobile of claim 186, wherein each of the front adjustable track shock and the rear adjustable track shock are positioned within a track of the track assembly.

188. The snowmobile of claim 187, wherein the track assembly includes a plurality of suspension arms, and each of the front adjustable track shock and the rear adjustable track shock are coupled to respective suspension arms of the plurality of suspension arms.

189. The snowmobile of claim 188, further comprising a front left shock absorber operably coupled to the front left ski and a front right shock absorber operably coupled to the front right ski.

190. The snowmobile of claim 189, wherein the front left shock absorber is a front left adjustable shock absorber operable according to a front left shock absorber damping characteristic and the front right shock absorber is a front right adjustable shock absorber operable according to a front right shock absorber damping characteristic.
